(19) United States
(12) Patent Application Publication
(10) Pub. No.: US 2006/0199117 A1
(43) Pub. Date: Sep. 7, 2006

(54) Photothermographic material

(75) Inventor: Yasuyuki Izumi, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/366,418

(22) Filed: Mar. 3, 2006

(30) Foreign Application Priority Data
Mar. 7, 2005 (JP) 2005-62618

(51) Int. Cl. G03C 1/00

(52) U.S. Cl. 430/619

(57) ABSTRACT

The invention provides a photothermographic material having, on a surface of a substrate, an image forming layer and a non-photosensitive layer. The image forming layer has a photosensitive silver halide, a non-photosensitive organic silver salt, a reducing agent and a binder. At least one of the image forming layer and the non-photosensitive layer has at least one selected from the group consisting of: modified polyvinyl alcohol A, which is a polyvinyl alcohol including an α-olefin having 1 to 4 carbon atoms as a copolymerized constituent thereof; modified polyvinyl alcohol B, which is a polyvinyl alcohol including, as a copolymerized constituent thereof, an ethylenic unsaturated carboxylic acid; and modified polyvinyl alcohol C, which is a polyvinyl alcohol including, as a copolymerized constituent thereof, an ethylenic unsaturated monomer having a primary amino group or a secondary amino group.

### CROSS-REFERENCE TO RELATED APPLICATION

This application claims priority under 35 USC 119 from Japanese Patent Application No. 2005-062618, the disclosure of which is incorporated by reference herein.

### BACKGROUND OF THE INVENTION

1. Field of Invention

The present invention relates to a photothermographic material that is preferably used in the fields of the medical diagnosis, printing plate-making and the like.

2. Description of the Related Art

In recent years, there has been a strongly desire in the medical diagnosis field and in the printing plate-making field to reduce waste solutions used in photographic development processing in consideration of environmental conservation and space saving. For this reason, there has been a strongly desire for a photosensitive material capable of being efficiently exposed by a laser image setter or a laser imager and capable of forming a sharp black image with high resolution and sharpness so as to be used as films for medical diagnosis or printing plate-making. With these photothermographic materials, it is possible to provide customers a heat development treatment system which eliminates the necessity of using solvent processing chemicals, and is simpler and does not impair the environment.

Similar requirements also exist in the field of general image forming materials. However, images for medical diagnosis are required to have high image quality excellent in sharpness and granularity, because fine details of the images are required. In addition, medical images exhibiting a blue-black image tone are preferred from the viewpoint of ease of medical diagnosis. Various hard copy systems utilizing pigments or dyes, such as an ink jet system and an electrophotographic system, are currently available as ordinary image forming systems, but no such system is yet satisfactory in image quality as an output system for use in medical imaging.

On the other hand, thermal image forming systems utilizing organic silver salts are described in, for example, U.S. Pat. Nos. 3,152,904 and 3,457,075, and in “Thermally Processed Silver Systems” (Imaging Processes and Materials), Neblette, 8th edition, Chapter 9, page 279, 1989, written by D. Klosterboer and edited by J. Sturge, V. Warlworth, and A. Shepp. In particular, photothermographic materials generally have an image-forming layer in which a catalytically active amount of photocatalyst (for example, a silver halide), a reducing agent, a reducible silver salt (for example, an organic silver salt) and, optionally, a color tone adjusting agent for controlling the tone of a developed silver image are dispersed in a binder matrix. When the photothermographic material is imagewise exposed to light and then heated to a high temperature (for example, 80° C. or higher), a redox reaction between the reducible silver salt (functioning as an oxidizer) and the reducing agent occurs to form a black-toned silver image. The redox reaction is promoted by the catalytic activity of a latent image of silver halide formed by exposure. Accordingly, the black-toned silver image is formed in an exposed region.

Such photothermographic materials have been conventionally known. However, in many of these recording materials, the image-forming layer is formed using an organic solvent such as toluene, methyl ethyl ketone, or methanol. It is not advantageous to use an organic solvent since the organic solvent may be harmful to the human body during the production process of the recording materials, and since it is costly to collect the solvent and to conduct other related processes.

There has been disclosed a method of producing an image-forming layer with an aqueous medium coating liquid (hereinafter also referred to as an “aqueous photosensitive layer”) that is free from the above problem. For example, there has been disclosed a technique using gelatin as a binder (for example, see Japanese Patent Application Laid-Open (JP-A) Nos. 49-52626 and 53-116144) and a technique using polyvinyl alcohol as a binder (for example, see JP-A No. 50-151138). There is also known a technique using polymer latex as a binder (for example, see JP-A No. 10-10670). There is also disclosed a technique that uses a specific polymer latex as a binder for an image-forming layer and a protective layer to produce low Dₘᵢₙ and high Dₘₐₓ (for example, see JP-A No. 11-84573).

Photothermographic materials are mainly characterized in that they can form a coating film by preliminarily containing all the chemicals necessary for image formation and thus can form images only by heating after image exposure. However, photothermographic materials have a problem in that the film may have a reduced physical strength and be brittle so that surface cracking or breaking or a reduction in frictional strength or scratch strength may occur and a problem in that their water or chemical resistance may be reduced.

Photothermographic materials also have a manufacturing problem in that their coating liquid can lose their setting properties so that it may be difficult to obtain a uniform coating surface state.

These problems cannot be satisfactorily solved using the above various types of binders, and thus a further improvement has been demanded.

### SUMMARY OF THE INVENTION

The present invention provides a photothermographic material having improved coated surface condition and change in color tone resulted when it is subjected to a continuous processing.

Namely, the present invention provides a photothermographic material comprising, on a surface of a substrate, an image forming layer and a non-photosensitive layer, wherein: the image forming layer comprises a photosensitive silver halide, a non-photosensitive organic silver salt, a reducing agent and a binder; and at least one of the image forming layer and the non-photosensitive layer comprises at least one selected from: modified polyvinyl alcohol A, which is a polyvinyl alcohol comprising an α-olefin having 1 to 4 carbon atoms as a copolymerized constituent thereof; modified polyvinyl alcohol B, which is a polyvinyl alcohol comprising, as a copolymerized constituent thereof, an ethylenic unsaturated carboxylic acid; and modified polyvinyl alcohol C, which is a polyvinyl alcohol comprising, as a copolymerized constituent thereof, an ethylenic unsaturated monomer having a primary amino group or a secondary amino group.

### DETAILED DESCRIPTION OF THE INVENTION

The photothermographic material of the present invention is hereinafter described in detail.

The photothermographic material of the invention comprises, on a surface of a substrate, an image forming layer and a non-photosensitive layer, wherein the image forming layer comprises a photosensitive silver halide, a non-photosensitive organic silver salt, a reducing agent and a binder. The non-photosensitive layer can be provided either over (on or above) a side of the substrate on which the image forming layer is provided or a side of the substrate which is opposite to another side on which the image forming layer is provided.

When the non-photosensitive layer is provided over a side of the substrate on which the image forming layer is provided, the non-photosensitive layer can be either an outermost layer or an intermediate layer provided between an outermost layer and the image forming layer. The intermediate layer may include prulal layers.

Modified Polyvinyl Alcohol

In the photothermographic material of the invention, at least one of the image-forming layer and the non-photosensitive layer contains at least one selected from modified polyvinyl alcohols A, B and C described below.

The modified polyvinyl alcohol A is a modified polyvinyl alcohol that includes, as a copolymerized component, an α-olefin having 1 to 4 carbon atoms.

The modified polyvinyl alcohol B is a polyvinyl alcohol that includes, as a copolymerized component, an ethylenic unsaturated carboxylic acid. The modified polyvinyl alcohol C is a polyvinyl alcohol that includes, as a copolymerized component, an ethylenic unsaturated monomer having a primary or secondary amino group.

Each of the modified polyvinyl alcohols is described in detail below.

(1) Modified Polyvinyl Alcohol A

In the invention, the modified polyvinyl alcohol A is a modified polyvinyl alcohol including, as a copolymerized component, an α-olefin of 1 to 4 carbon atoms and preferably contains 1% by mole or more and 10% by mole or less of the α-olefin unit, more preferably 2% by mole or more and 8% by mole or less of the α-olefin unit.

In the invention, the modified polyvinyl alcohol A may be obtained by saponifying a copolymer of a vinyl ester and and α-olefin. Examples of the vinyl ester include vinyl formate, vinyl acetate, vinyl propionate, and vinyl pivalate. Among these, vinyl acetate is economically preferred. The α-olefin for use in the invention has four or less of carbon atoms and examples thereof include ethylene, propylene, n-butene, and isobutene. Ethylene is preferred because of its good water resistance. If the content of the α-olefin is less than 1% by mole, the above remarkable effect cannot be produced. If the content is more than 10% by mole, the water-solubility can be reduced, coating liquids with good coating properties cannot be obtained, and the above effect cannot be produced.

In the invention, the modified polyvinyl alcohol A may be copolymerized with a copolymerizable ethylenic unsaturated monomer as long as the advantage of the invention is not reduced. Examples of such an ethylenic unsaturated monomer include acrylic acid, methacrylic acid, phthalic acid (anhydride), maleic acid (anhydride), itaconic acid (anhydride), acrylonitrile, methacrylonitrile, acrylamide, methacrylamide, trimethyl-(3-acrylamido-3-dimethylpropyl)-ammonium chloride, acrylamido-2-methylpropanesulfonic acid and a sodium salt thereof, ethyl vinyl ether, butyl vinyl ether, N-vinylpyrrolidone, vinyl chloride, vinyl bromide, vinyl fluoride, vinylidene chloride, vinylidene fluoride, tetrafluoroethylene, sodium vinyl sulfonate, and sodium allyl sulfonate. It is also possible to use a terminal-modified copolymer produced by copolymerizing a vinyl ester monomer such as vinyl acetate with an α-olefin having 4 or less carbon atoms in the presence of a thiol compound such as thiol acetate or mercaptopropionate and saponifying the resulting copolymer.

In the invention, a saponification degree of the modified polyvinyl alcohol A is preferably 50% by mole or more, more preferably 90% by mole or more, still more preferably 95% by mole or more, though it depends on the content of the α-olefin in the modified polyvinyl alcohol. In the invention, the modified polyvinyl alcohol A preferably has a degree of polymerization in the range from 100 to 8,000, more preferably from 300 to 2,000.

Specific examples of the modified polyvinyl alcohol A according to the invention include: a modified polyvinyl alcohol having a saponification degree of 90.0% by mole, an ethylene content of 7.2% by mole and a degree of polymerization of 1,200; a modified polyvinyl alcohol having a saponification degree of 85.0% by mole, an ethylene content of 10.0% by mole and a degree of polymerization of 500; and a modified polyvinyl alcohol having a saponification degree of 94.0% by mole, an ethylene content of 4.0% by mole and a degree of polymerization of 1,700.

In the invention, the modified polyvinyl alcohol A may be synthesized by conventional polymerization methods and conventional saponification methods, and examples thereof include the method described in JP-A No. 8-81664.

(2) Modified Polyvinyl Alcohol B

In the invention, the modified polyvinyl alcohol B is a carboxyl-modified polyvinyl alcohol, which may be produced by saponifying a copolymer of a vinyl ester and an ethylenic unsaturated carboxylic acid.

In the invention, the modified polyvinyl alcohol B may be any modified polyvinyl alcohol having a carboxyl group in its molecule. In general, the modified polyvinyl alcohol B is preferably a product (a random copolymer) prepared by copolymerizing a vinyl ester monomer such as vinyl acetate with an ethylenic unsaturated carboxylic acid such as acrylic acid, methacrylic acid, phthalic acid (anhydride), maleic acid (anhydride), or itaconic acid (anhydride) and then saponifying the resulting copolymer, or a product (a block copolymer) prepared by radical-polymerizing the ethylenic unsaturated carboxylic acid in the presence of a polyvinyl alcohol polymer having a thiol group at a terminal thereof. Besides vinyl acetate, the vinyl ester monomer may be vinyl formate, vinyl propionate, vinyl versatate, or vinyl pivalate.

In the invention, the degree of polymerization of the carboxyl-modified polyvinyl alcohol is preferably, but not limited to, in the range from 50 to 3,000, more preferably from 100 to 2,000. The saponification degree of the carboxyl-modified polyvinyl alcohol is preferably, but not limited to, in the range from 70 to 100% by mole, more preferably from 80 to 98% by mole. The amount of the carboxyl is preferably, but not limited to, in the range from 0.1 to 50% by mole, more preferably from 0.5 to 10% by mole, particularly preferably from 0.5 to 5% by mole. If the amount of the carboxyl is less than 0.1% by mole, insufficient crosslink density may be obtained so that water resistance cannot be improved. If the amount of the carboxyl is more than 50% by mole, the coating liquid may become unstable and water resistance thereof may be degraded.

In the invention, the carboxyl-modified polyvinyl alcohol may be copolymerized with a copolymerizable ethylenic unsaturated monomer as long as the advantage of the invention is not reduced. Examples of such an ethylenic unsaturated monomer include ethylene, isobutylene, acrylonitrile, methacrylonitrile, acrylamide, methacrylamide, trimethyl-(3-acrylamido-3-dimethylpropyl)-ammonium chloride, ethyl vinyl ether, butyl vinyl ether, N-vinylpyrrolidone, vinyl chloride, vinyl bromide, vinyl fluoride, vinylidene chloride, vinylidene fluoride, tetrafluoroethylene, sodium vinyl sulfonate, and sodium allyl sulfonate. It is also possible to use a terminal-modified copolymer produced by copolymerizing a vinyl ester monomer such as vinyl acetate with an ethylenic unsaturated carboxylic acid in the presence of a thiol compound such as thiol acetate or mercaptopropionate and saponifying the resulting copolymer.

Specific examples of the modified polyvinyl alcohol B according to the invention include: a modified polyvinyl alcohol that is produced by random copolymerization and modification and has a degree of polymerization of 1,750, a saponification degree of 87.5% by mole and an itaconic acid unit content of 1% by mole;

a modified polyvinyl alcohol that is produced by random copolymerization and modification and has a degree of polymerization of 1,700, a saponification degree of 83.0% by mole and an itaconic acid unit content of 2% by mole; and

a modified polyvinyl alcohol that is produced by random copolymerization and modification and has a degree of polymerization of 550, a saponification degree of 71% by mole and an itaconic acid unit content of 6% by mole.

In the invention, the modified polyvinyl alcohol B may be synthesized by conventional polymerization methods and conventional saponification methods, and examples thereof include the method described in JP-A No. 6-128495.

In the invention, the carboxyl-modified polyvinyl alcohol is preferably used in combination with a polyamide compound. The polyamide compound for use in the invention preferably has a functional group capable of reacting with the carboxyl group of the carboxyl-modified polyvinyl alcohol. Specifically, such a polyamide compound is preferably a reaction product of a polyamide with an epoxy group-containing compound, more preferably a reaction product of a polyamide with a glycidyl group-containing compound, particularly preferably a polyamide-epichlorohydrin, which is a reaction product of a polyamide with epichlorohydrin.

Herein, the polyamide-epichlorohydrin is a water-soluble resin produced by allowing epichlorohydrin to react with a polyamide resin, which is a condensation reaction product of an alkylpolyamine compound with an alkyldicarboxylic acid, and to quaternarizing the resultant, and, examples thereof include a reaction product of epichlorohydrin with a polyamide in which the polyamide is produced from adipic acid and diethylenetriamine. Concerning the degree of polymerization of the polyamide compound, its Brookfield viscosity (B-type viscosity) at a temperature of 25° C. in an aqueous solution at a concentration of 10% by mass is preferably, but not limited to, in the range of 5 to 10,000 mPas·s (milli-pascal-second), more preferably of 10 to 5,000 mPas·s, still more preferably of 10 to 1,000 mPas·s. The content of the functional group(s) in the polyamide compound is preferably, but not limited to, in a range of 0.01 to 1 mol/100 g, more preferably of 0.03 to 0.5 mol/100 g.

(3) Modified Polyvinyl Alcohol C

In the invention, the modified polyvinyl alcohol C is a polyvinyl alcohol that includes, as a copolymerized component, an ethylenic unsaturated monomer having a primary or secondary amino group.

In the invention, the modified polyvinyl alcohol having at least one functional group selected from a primary or secondary amino group may further have any functional group other than the primary or secondary amino group as long as the advantage of the invention is not reduced. Examples of the monomer unit for providing such a functional group include ethylene, isobutylene, acrylonitrile, methacrylonitrile, acrylic acid, methacrylic acid, fumaric acid (anhydride), maleic acid (anhydride), itaconic acid (anhydride), allyl sulfonate, methallyl sulfonate, vinyl sulfonate, acrylamido-2-methylpropanesulfonic acid, methacrylamido-2-methylpropanesulfonic acid, sulfopropyl acrylate, sulfopropyl methacrylate and alkali salts thereof, acrylamide, methacrylamide, trimethyl-(3-acrylamido-3-dimethylpropyl)-ammonium chloride, ethyl vinyl ether, butyl vinyl ether, N-vinylpyrrolidone, vinyl chloride, vinyl bromide, vinyl fluoride, vinylidene chloride, vinylidene fluoride, and tetrafluoroethylene. It is also possible to use a product having, at a terminal thereof, a functional group which is prepared by polymerizing a vinyl ester monomer such as vinyl acetate in the presence of a thiol compound such as thiol acetate or mercaptopropionate.

In the modified polyvinyl alcohol having at least one functional group selected from a primary or secondary amino group according to the invention, the content of the primary or secondary amino group may be selected and set at any appropriate value depending on various situations. In general, the content of the monomer unit having the functional group is preferably 0.1% by mole or more and 30% by mole or less, more preferably 0.5% by mole or more and 25% by mole or less. If the functional group is less than 0.1% by mole, the introduction of the functional group may fail to provide a sufficient effect in some cases. If the functional group is more than 30% by mole, polyvinyl alcohol-specific properties may be insufficiently exhibited.

The degree of polymerization of the modified polyvinyl alcohol with the functional group is preferably 100 or more, particularly preferably from 200 to 8,000, while it depends on the intended purpose and cannot be uniformally defined. The saponification degree of the modified polyvinyl alcohol is preferably, but not limited to, 50% by mole or more, particularly preferably from 80 to 99.9% by mole.

Specific examples of the modified polyvinyl alcohol C according to the invention include: a modified polyvinyl alcohol having a degree of polymerization of 1,050, a saponification degree of 98.5% by mole and a primary amino group content of 3.0% by mole; a modified polyvinyl alcohol having a degree of polymerization of 1,000, a saponification degree of 97.0% by mole and an aniline group content of 2.1% by mole; and a modified polyvinyl alcohol having a degree of polymerization of 1,250, a saponification degree of 93.5% by mole and a secondary amino group content of 4.0% by mole.

In the invention, the modified polyvinyl alcohol C may be synthesized by conventional polymerization methods and conventional saponification methods, and examples thereof include the method described in JP-A No. 11-43515.

In the invention, the modified polyvinyl alcohol having at least one functional group selected from a primary or secondary amino group is preferably used in combination with a crosslinking agent and a crosslinking accelerator. The crosslinking agent is preferably a polyvalent epoxy compound. Examples of the polyvalent epoxy compound for use in the invention include glycidyl ethers such as diglycidyl ether of bisphenol A, di-β-methylglycidyl ether of bisphenol A, diglycidyl ether of bisphenol F, tetraglycidyl ether of tetrahydroxyphenylmethane, resorcinol diglycidyl ether, diglycidyl ether of brominated bisphenol A, diglycidyl ether of chlorinated bisphenol A, diglycidyl ether of hydrogenated bisphenol A, diglycidyl ether of alkylene oxide adduct of bisphenol A, novolak glycidyl ether, diglycidyl ether of polyalkylene glycol, glycerin triglycidyl ether, pentaerythritol diglycidyl ether, or epoxy urethane resins; glycidyl ether-ester compounds such as glycidyl ether-ester of p-oxybenzoic acid; glycidyl esters such as diglycidyl phthalate ester, diglycidyl tetrahydrophthalate ester, diglycidyl hexahydrophthalate ester, diglycidyl acrylate ester, or diglycidyl ester of dimer acid; glycidyl amines such as glycidyl aniline, tetraglycidyl diaminodiphenylmethane, triglycidyl isocyanurate, or triglycidyl aminophenol; linear aliphatic epoxy resins such as epoxidized polybutadiene or epoxidized soybean oil; alicyclic epoxy resins such as 3,4-epoxy-6-methylcyclohexylmethyl-3,4-epoxy-6-methylcyclohexane carboxylate, 3,4-epoxycyclohexylmethyl-(3,4-epoxycyclohexane)carboxylate, bis(3,4-epoxy-6-methylcyclohexylmethyl)adipate, vinylcyclohexene diepoxide, dicyclopentadiene oxide, bis(2,3-epoxycyclopentyl)ether, or limonene dioxide; and polyamide epichlorohydrin.

In the invention, the crosslinking accelerator is preferably a compound having an —NH— bond. The compound having the —NH— bond for use in the invention preferably has an amino bond, a urea bond, an amide bond, an imide bond, or a hydrazino bond. Examples of the compound having the amino bond include hydroxylamine, chloramine, ammonia, methanolamine, ethanolamine, dimethylamine, diethylamine, isopropylamine, butylamine, proline, hydroxyproline, dicyanoamide, ethyleneimine, ethylenediamine, propylenediamine, diethylenetriamine, 2-diethylaminoethanol, 2-dimethylaminoethanol, 1,2-diaminopropane, 1,3-diaminopropane, triethylenetetramine, tetraethylenepentamine, iminobispropylamine, tetramethylenediamine, guanidine carbonate, glycine, alanine, sarcosine, glutamic acid, hexamethylenediamine, melamine, morpholine, 2-amino-4,5-dicyanoimidazole, 3-azahexane-1,6-diamine, hexamethylenediamine, 2-acrylamido-2-methylpropanesulfonic acid, α-amino-ε-caprolactam, acetoguanamine, guanine, acetaldehyde ammonia, 4,7-diazadecane-1,10-diamine, pyrrolidine, piperidine, piperazine, polyethyleneimine, polyallylamine, polyvinylamine, and aminobenzoate salts. Examples of the compound having the urea bond include urea, thiourea, methylurea, ethylurea, dimethylurea, diethylurea, ethylene urea, acetylurea, guanylurea, guanylthiourea, azodicarbonamide, glycolylurea, and acetylurea. Examples of the compound having the amide bond include formamide, acetamide, benzamide, oxamide, pyrrolidone, pyrrolidone carboxylic acid, oxamic acid, succinamide, dicyandiamide, oxazolidone, and malonamide.

Examples of the compound having the imide bond include succinimide, phthalimide, maleimide, imide succinate, hydantoin, barbituric acid, 1-methylol-5,5-dimethylhydantoin, and isocyanuric acid. Examples of the compound having the hydrazino bond include hydrazine, hydrazinobenzoic acid, α-hydrazinoisobutyric acid, hydrazinoacetic acid, hydrazinoformic acid, α-hydrazinopropionic acid, 2-hydrazinoethanol, dihydrazide oxalate, dihydrazide succinate, dihydrazide malonate, dihydrazide glutarate, dihydrazide adipate, dihydrazide sebacate, dihydrazide maleate, dihydrazide fumarate, dihydrazide itaconate, ethylene-1,2-dihydrazine, propylene-1,3-dihydrazine, reaction products of hydrazine hydrate with polyacrylamide, and reaction products of hydrazine hydrate with a water-soluble or water-dispersible polymer having an amide group and/or an ester group.

These compounds may be used singly or in combination of two or more.

Addition Amount of Modified PVA in Film, Ratio of Modified PVA to Binder, and Coating Amount

In a case where the modified PVA is added to the image-forming layer, the amount of the modified PVA is preferably in the range of 5 to 100% by mass relative to the total amount of the binders. If the content of the modified PVA is less than 5% by mass, the addition of the modified PVA could be unsatisfactorily effective.

In a case where the modified PVA is added to the outermost surface layer, the amount of the modified PVA is preferably in the range of 5 to 75% relative to the total amount of the binders. If the content of the modified PVA is less than 5% by mass, the addition of the modified PVA may be unsatisfactorily effective. If the content is more than 75% by mass, the gelatin binder may be short so that setting may fail in the application process. In a case where the modified PVA is added to the intermediate layer, the amount of the modified PVA is preferably in the range of 5 to 100% by mass relative to the total amount of the binders. If the content of the modified PVA is less than 5% by mass, the addition of the modified PVA could be unsatisfactorily effective.

In a case where the modified PVA is added to the back layer, the amount of the modified PVA is preferably in the range of 5 to 75% by mass relative to the total amount of the binders. If the content of the modified PVA is less than 5% by mass, the addition of the modified PVA could be unsatisfactorily effective. If the content is more than 75% by mass, the gelatin binder may be short so that setting may fail in the application process.

Other Additives

When the modified polyvinyl alcohol B is used, polyamide-epichlorohydrin is preferably used as an additive so that the amount thereof becomes 1% by mass relative to the amount of the modified polyvinyl alcohol (see JP-A No. 6-128495).

Non-Photosensitive Intermediate Layer

A non-photosensitive intermediate layer is provided on the image-forming layer and the outermost layer and contains a film-forming binder. The intermediate layer may further contain any additive such as a redusing agent, either a development accelerater or a development inhibiter, a dye, a pigment, a plasticizer, a lubricant, a cross-linking agent, and/or a surfactant as described below.

1) Binder in Non-Photosensitive Intermediate Layer

The amount of the polymer latex having the monomer component represented by the following Formula (M) in the binder of the non-photosensitive intermediate layer used in the invention is 50% by mass or more, and preferably in the range of 10 to 70% by mass, relative to the total mass of the binder.
CH₂═CR⁰¹—CR⁰²═CH₂ Formula (M)

In formula (M), R⁰¹ and R⁰² independently represent a hydrogen atom, an alkyl group having 1 to 6 carbon atoms, a halogen atom, or a cyano group. More preferably each of R⁰¹ and R⁰² is a hydrogen atom, or one of them is a hydrogen atom and the other is a methyl group.

When R⁰¹ and R⁰² respectively represent an alkyl group, it preferably has 1 to 4 carbon atoms, and more preferably has 1 to 2 carbon atoms. When R⁰¹ and R⁰² respectively represent a halogen atom, it preferably is a fluorine atom, a chlorine atom, or a bromine atom, and more preferably a chlorine atom.

Preferably, each of R⁰¹ and R⁰² is a hydrogen atom, or one of them is a hydrogen atom and the other is a methyl group or a chlorine atom. More preferably, each of them is a hydrogen atom, or one is a hydrogen atom and the other is a methyl group.

Specific examples of the monomer represented by Formula (M) include 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

The ratio (copolymerization ratio) of the amount of the monomer represented by Formula (M) to that of all the monomers of the polymer is 10 mass % to 70 mass %, preferably 15 mass % to 65 mass %, and more preferably 20 mass % to 60 mass %. When the copolymerization ratio of the monomer represented by Formula (M) is less than 10 mass %, the amount of fusible component in the binder reduces, whereby processing fragility deteriorates.

On the other hand, when the copolymerization ratio of the monomer exceeds 70 mass %, the amount of fusible component in the binder increases, and the mobility of the binder increases. Therefore, image storability deteriorates.

The acidic group is preferably carboxylic acid, sulfonic acid, and/or phosphoric acid, and more preferably carboxylic acid. The copolymerization ratio of the amount of the acidic monomer to that of all the monomers of the polymer is preferably 1 to 20 mass %, and more preferably 1 to 10 mass %. Specific examples of the monomer having an acidic group include acrylic acid, methacrylic acid, itaconic acid, sodium p-styrenesulfonate, isoprenesulfonic acid, and phosphorylethyl methacrylate. The acidic monomer is more preferably acrylic acid and/or methacrylic acid, and still more preferably acrylic acid.

The glass transition temperature (Tg) of the polymer which is a copolymerization of the monomer represented by formula (M) in the invention is preferably in the range of −20° C. to 50° C.

The glass transition temperature (Tg) of the polymer in the invention can be calculated by the following equation:
1/Tg=Σ(Xi/Tgi)

In the equation, it is assumed that the polymer is obtained by copolymerizing n monomer components. In other words, i is an integer of 1 to n. Xi represents the mass fraction of an i-th monomer (ΣXi=1), and Tgi represents the glass transition temperature (absolute temperature) of a homopolymer of the i-th monomer. Z indicates the sum of values respectively corresponding to i of 1 to n. The glass transition temperature (Tgi) of a homopolymer of each monomer is obtained from “Polymer Handbook (3rd edition)” (J. Brandrup, E. H. Immergut (Wiley-Interscience, 1989)).

Specific Examples of Polymer

Specific examples of the polymer for use in the invention are shown in Table 1 as exemplified compounds (PA-1) to (PA-17), but the invention is not limited by these specific examples.

TABLE 1

| | Styrene | Isoprene | Acidic monomer | | |
|---|---|---|---|---|---|
| Compound | Co-polymerization | Co-polymerization | | Co-polymerization | Tg |
| No. | ratio (wt %) | ratio (wt %) | Kind | ratio (wt %) | (° C.) |
| PA-1 | 60.4 | 36.6 | Acrylic acid | 3.0 | 15.5 |
| PA-2 | 63 | 34 | Acrylic acid | 3.0 | 20.2 |
| PA-3 | 65 | 32 | Acrylic acid | 3.0 | 23.9 |
| PA-4 | 59.5 | 37.5 | Acrylic acid | 3.0 | 13.9 |
| PA-5 | 45 | 50 | Acrylic acid | 5.0 | −6.6 |
| PA-6 | 70 | 26 | Acrylic acid | 4.0 | 35.8 |
| PA-7 | 45 | 53 | Acrylic acid | 2.0 | −11.2 |
| PA-8 | 60 | 35 | Methacrylic acid | 5.0 | 21.2 |
| PA-9 | 50 | 46 | Methacrylic acid | 4.0 | 1.5 |
| PA-10 | 37 | 56 | Methacrylic acid | 7.0 | −12.4 |
| PA-11 | 70.5 | 27 | Methacrylic acid | 2.5 | 35.2 |
| PA-12 | 65.5 | 30 | Itaconic acid | 4.5 | 31.8 |
| PA-13 | 60 | 34.5 | Itaconic acid | 5.5 | 24.0 |
| PA-14 | 47 | 50 | Itaconic acid | 3.0 | −4.6 |
| PA-15 | 53.5 | 42.5 | Sodium p-styrenesulfonate | 4.0 | 6.9 |
| PA-16 | 66 | 29 | Sodium p-styrenesulfonate | 5.0 | 32.2 |
| PA-17 | 45.5 | 52 | Sodium p-styrenesulfonate | 2.5 | −8.8 |
| PA-18 | 57 | 40 | Sodium isoprenesulfonate | 3.0 | 9.0 |
| PA-19 | 45 | 51 | Sulfonate | 4.0 | −8.8 |
| PA-20 | 60 | 35.5 | Phosphoryl ethyl | 4.5 | 18.0 |
| | | | methacrylate | | |

The coating liquid containing the polymer latex to be used in the invention may contain an aqueous solvent, and may further contain a water-miscible organic solvent. Examples of the water-miscible organic solvent include alcohols (for example, methyl alcohol, ethyl alcohol, and propyl alcohol), cellosolves (for example, methyl cellosolve, ethyl cellosolve, and butyl cellosolve), ethyl acetate, and dimethylformamide. The amount of the organic solvent to be added is preferably not more than 50% relative to the total amount of the solvent of the coating liquid, and more preferably not more than 30% relative to the total amount of the solvent of the coating liquid.

Furthermore, in the polymer latex to be used in the invention, the polymer concentration is, based on the amount of the latex liquid, preferably 10 mass % to 70 mass %, more preferably 20 mass % to 60 mass %, and still more preferably 30 mass % to 55 mass %.

The polymer latex in the invention preferably has an equilibrium moisture content of not more than 2 mass % at 25° C. and 60% RH. The equilibrium moisture content is more preferably 0.01 mass % to 1.5 mass %, and still more preferably 0.02 mass % to 1.0 mass %.

The equilibrium moisture content at 25° C. and 60% RH can be represented by the following equation:
Equilibrium moisture content at 25° C. and 60% RH={(W1−W0)/W0}×100 (mass %),

In the equation, W1 is the mass of a polymer in humidity-conditioned equilibrium in an atmosphere of 25° C. and 60% RH, and W0 is the mass of the polymer in a bone-dry state at 25° C.

The definition and measuring method of the equilibrium moisture content may be referred to documents such as “KOBUNSHI ZAIRYO SHIKENHOU (Testing methods for Polymer materials)” in “KOBUNSHI KOUFAKU KOUZA (Lecture of Polymer Enginerring) 14” edited by published by the Society of Polymer Science, Japan and phblished by Chijunsyokan Co., Ltd.

The average particle diameter of the latex particles used in the invention is in the range of 1 nm to 50,000 nm, preferably in the range of 5 nm to 1,000 nm, more preferably in the range of 10 nm to 500 μm, and still more preferably in the range of 50 nm to 200 nm. There is no particular limitation on the particle diameter distribution of the latex particles, and the latex particles may have a broad particle diameter distribution or a monodisperse particle diameter distribution. From the viewpoint of controlling the physical properties of a coating liquid, mixing two or more types of particles each having a monodisperse particle diameter distribution is preferable.

In the invention, the non-photosensitive intermediate layer may further include a hydrophilic polymer such as gelatin, polyvinyl alcohol, methyl cellulose, hydroxypropyl cellulose, or carboxymethyl cellulose as necessary. The amount of such a hydrophilic polymer to be added is preferably not more than 50 mass %, and more preferably not more than 20 mass %, based on the total amount of the binders in the non-photosensitive intermediate layer A.

The total amount of the binder contained (coated) in the non-photosensitive intermediate layer is preferably in the range of 1 to 8 g/m², more preferably in the range of 2 to 6 g/m². The non-photosensitive intermediate layer used in the invention may further contain a crosslinking agent for crosslinking, a surfactant for improving coatability of the non-photosensitive intermediate layer coating liquid and the like.

Binder of Image-Forming Layer

The binder of the image-forming layer in the invention may be any polymer. The polymer is preferably transparent or translucent, and generally colorless. The polymer may be a natural resin, polymer or copolymer, or a synthetic resin, polymer or copolymer, or a film-forming medium. Specific examples thereof include gelatins, rubbers, polyvinyl alcohols, hydroxyethylcelluloses, cellulose acetates, cellulose acetate butyrates, polyvinylpyrrolidones, casein, starch, polyacrylic acids, polymethylmethacrylic acids, polyvinyl chlorides, polymethacrylic acids, styrene-maleic anhydride copolymers, styrene-acrylonitrile copolymers, styrene-butadiene copolymers, polyvinyl acetals (e.g. polyvinyl formal, and polyvinyl butyral), polyesters, polyurethanes, phenoxy resins, polyvinylidene chlorides, polyepoxides, polycarbonates, polyvinyl acetates, polyolefins, cellulose esters, and polyamides. The binder may be used with water, or an organic solvent or used as an emulsion to form a coating liquid.

In the invention, the glass transition temperature (Tg) of the binder which can be contained in a layer including the organic silver salt is preferably in the range of 0° C. to 80° C., more preferably in the range of 10° C. to 70° C., and still more preferably in the range of 15° C. to 60° C.

Two or more binders may be used together, if necessary. For example, a polymer having Tg of 20° C. or more and that having Tg of less than 20° C. can be used together. In the case where two or more kinds of polymers having different Tgs may be blended, it is preferred that the mass-averaged Tg is within the range mentioned above.

In the invention, it is preferred that the image-forming layer is formed by applying a coating liquid containing water in an amount of 30% by mass or more with respect to the total amount of solvent(s) and drying the resultant coating.

In the invention, in the case where the image-forming layer is formed by first applying a coating liquid containing water in an amount of 30% by mass or more with respect to the total amount of solvent(s) and drying the resultant coating, and in the case where the binder of the image-forming layer is soluble or dispersible in an aqueous solvent (water solvent), particularly in the case where a polymer latex having an equilibrium moisture content of 2% by mass or lower at 25° C. and 60% RH is used as the binder, improved performance can be obtained. Most preferably, the ionic conductivity of the binder is adjusted to 2.5 mS/cm or lower. To attain this, a process for purifying a prepared polymer, which has been synthesized, with a separation functional membrane can be conducted.

The equilibrium moisture content of the binder polymer in the invention at 25° C. and 60% RH is preferably 2% by mass or lower, more preferably 0.01% by mass to 1.5% by mass, and still more preferably 0.02% by mass to 1% by mass.

The binder used in the invention is particularly preferably a polymer dispersible in the aqueous solvent. Examples of a system in which the polymer is dispersed include a latex in which water-insoluble fine particles of hydrophobic polymer are dispersed, or a system in which polymer molecules or micelles formed by the polymer molecules are dispersed. Among these, a latex in which polymer particles are dispersed is preferable. The average size of the dispersed particles is generally in the range of 1 nm to 50,000 nm, preferably from 5 nm to 1,000 nm, more preferably from 10 nm to 500 nm, and still more preferably from 50 nm to 200 nm. There is no particular limitation on the particle diameter distribution of the dispersed particles, and the dispersed particles may have a broad distribution or a monodisperse particle diameter distribution. From the viewpoint of controlling the physical properties of a coating liquid, mixing two or more types of particles each having a monodisperse particle distribution is preferable.

In the invention, the polymer dispersible in the aqueous solvent is preferably a hydrophobic polymer such as acrylic polymer, polyester, rubber (e.g., an SBR resin), polyurethane, polyvinyl chloride, polyvinyl acetate, polyvinylidene chloride, or polyolefin. The polymer may be linear, branched or cross-linked, and may be a homopolymer obtained by polymerizing one kind of monomer, or a copolymer obtained by polymerizing two or more kinds of monomers. In the case of a copolymer, it may be a random copolymer or a block copolymer. The number-average molecular weight of the polymer is generally in the range of 5,000 to 1,000,000, and preferably from 10,000 to 200,000. Those having too small molecular weight result in an image-forming layer having an insufficient mechanical strength, whereas those having too large molecular weight have a poor film-forming property. Further, the binder is particularly preferably a cross-linkable polymer latex.

Specific Examples of Latex

Specific examples of the polymer latex are given below, and are expressed by starting monomers. The numerical values in parentheses represent the mass percentages of the left monomers. The molecular weight is the number average molecular weight. Latexes whose starting monomers include a polyfunctional monomer form a cross-linked structure, and the concept of molecular weight is not applicable thereto. Hence, they are denoted as “cross-linking”, and the molecular weight is not shown. Tg represents the glass transition temperature of the polymer.
P-1; latex of MMA(70)-EA(27)-MAA(3) (molecular weight of 37,000, and Tg of 61° C.)
P-2; latex of MMA(70)-2EHA(20)-St(5)-AA(5) (molecular weight of 40,000, and Tg of 59° C.)
P-3; latex of St(50)-Bu(47)-MAA(3) (cross-linking, and Tg of −17° C.)
P-4; latex of St(68)-Bu(29)-AA(3) (cross-linking, and Tg of 17° C.)
P-5; latex of St(71)-Bu(26)-AA(3) (cross-linking, and Tg of 24° C.)
P-6; latex of St(70)-Bu(27)-IA(3) (cross-linking)
P-7; latex of St(75)-Bu(24)-AA(1) (cross-linking, and Tg of 29° C.)
P-8; latex of St(60)-Bu(35)-DVB(3)-MAA(2) (cross-linking)
P-9; latex of St(70)-Bu(25)-DVB(2)-AA(3) (cross-linking)
P-10; latex of VC(50)-MMA(20)-EA(20)-AN(5)-AA(5) (molecular weight of 80,000)
P-11; latex of VDC(85)-MMA(5)-EA(5)-MAA(5) (molecular weight of 67,000)
P-12; latex of Et(90)-MAA(10) (molecular weight of 12,000)
P-13; latex of St(70)-2EHA(27)-AA(3) (molecular weight of 130,000, and Tg of 43° C.)
P-14; latex of MMA(63)-EA(35)-AA(2) (molecular weight of 33,000, and Tg of 47° C.)
P-15; latex of St(70.5)-Bu(26.5)-AA(3) (cross-linking, and Tg of 23° C.)
P-16; latex of St(69.5)-Bu(27.5)-AA(3) (cross-linking, and Tg of 20.5° C.)

In the above structures, MMA represents methyl metacrylate, EA represents ethyl acrylate, MAA represents methacrylic acid, 2EHA represents 2-ethylhexyl acrylate, St represents styrene, Bu represents butadiene, AA represents acrylic acid, DVB represents divinylbenzene, VC represents vinyl chloride, AN represents acrylonitrile, VDC represents vinylidene chloride, Et represents ethylene, and IA represents itaconic acid.

The above polymer latexes are commercially available. Specifically, the commercial products are as follows: those of acrylic polymers include CEVIAN A-4635, 4718, and 4601 (all trade names, manufactured by Daicel Chemical Industries, Ltd.), and NIPOL® LX811, 814, 821, 820, and 857 (all trade names, manufactured by Zeon Corporation); those of polyesters include FINETEX ES 650, 611, 675, and 850 (all trade names, manufactured by Dainippon Ink and Chemicals), and WD-SIZE, and WMS (all trade names, manufactured by Eastman Chemical); those of polyurethanes include HYDRAN AP10, 20, 30, and 40 (all trade names, manufactured by Dainippon Ink and Chemicals); those of rubbers include LACSTAR 7310K, 3307B, 4700H, and 7132C (all trade names, manufactured by Dainippon Ink and Chemicals), and NIPOL® LX416, 410, 438C, and 2507 (all trade names, manufactured by Zeon Corporation); those of polyvinyl chlorides include G351 and G576 (all trade names, manufactured by Zeon Corporation); those of polyvinylidene chlorides include L502 and L513 (all trade names, manufactured by Asahi Kasei Corp.); and those of polyolefins include CHEMIPEARL® S120 and SA100 (all trade names, manufactured by Mitsui Chemicals, Inc.).

These polymer latexes may be used singly or in combination of two or more thereof.

Preferable Latex

The polymer latex for use in the invention is preferably a latex of styrene-butadiene copolymer. The mass ratio of the styrene monomer unit to the butadiene monomer unit of the styrene-butadiene copolymer is preferably in the range of 40:60 to 95:5. Further, the styrene and butadiene monomer units preferably account for 60 to 99% by mass with respect to all the monomers of the copolymer. Further, the monomers of the polymer latex used in the invention preferably contain acrylic acid or methacrylic acid in the range from 1 to 6% by mass with respect to the sum of styrene and butadiene, and more preferably from 2 to 5% by mass. The monomers of the polymer latex in the invention preferably contain acrylic acid. The preferable range of the molecular weight of the polymer latex is similar to that described above.

Typical examples of the styrene-butadiene-acid copolymer latex for use in the invention include the above-exemplified polymers P-3 to P-8 and P-15; and commercially available LACSTAR-3307B, 7132C, and NIPOL® LX416.

The organic silver salt-containing layer in the invention, namely image-forming layer, is preferably formed using the polymer latex as its binder. As for the amount of the binder of the image forming layer, the mass ratio of all the binders to the organic silver salt is generally in the range of 1/10 to 10/1, preferably from 1/3 to 5/1, and more preferably from 1/1 to 3/1.

Such an organic silver salt-containing layer is usually a photosensitive layer (i.e., image-forming layer) containing a photosensitive silver salt, i.e., a photosensitive silver halide, and in such a case, the mass ratio of all the binders to the silver halide is generally in the range of 400 to 5 and preferably in the range of 200 to 10.

The total amount of the binder(s) in the image-forming layer in the invention is preferably in the range of 0.2 g/m² to 30 g/m², more preferably in the range of 1 g/m² to 15 g/m², and even more preferably in the range of 2 g/m² to 10 g/m². The image-forming layer in the invention may contain a cross-linking agent for cross-linking the binder, and/or a surfactant to improve coating properties.

Preferable Solvent for Coating Liquid

In the invention, the solvent for use in the coating liquid for the image-forming layer of the photothermographic material (hereinafter, both a solvent and a dispersion medium are called solvents for simplicity) is preferably an aqueous solvent containing water in an amount of 30 mass % or more. In addition to water, the aqueous solvent may contain any water-miscible organic solvent such as methyl alcohol, ethyl alcohol, isopropyl alcohol, methyl cellosolve, ethyl cellosolve, dimethylformamide, or ethyl acetate. The water content of the solvent for coating liquid is preferably 50 mass % or more and more preferably 70 mass % or more. Typical examples of the solvent composition include water, a mixture of water and methyl alcohol at a mass ratio of 90/10, a mixture of water and methyl alcohol at a mass ratio of 70/30, a mixture of water, methyl alcohol and dimethylformamide at a mass ratio of 80/15/5, a mixture of water, methyl alcohol and ethyl cellosolve at a mass ratio of 85/10/5, and a mixture of water, methyl alcohol and isopropyl alcohol at a mass ratio of 85/10/5.

The image-forming layer of the invention may contain a hydrophilic polymer such as gelatin, polyvinyl alcohol, methyl cellulose, hydroxypropyl cellulose, or carboxymethyl cellulose, if necessary. The content of the hydrophilic polymer is generally 30% by mass or less, and preferably 20% by mass or less with respect to the total mass of the binder(s) contained in the image-forming layer.

Non-Photosensitive Organic Silver Salt

1) Composition

The organic silver salt which can be used in the present invention is relatively stable to light but serves as to supply silver ions and forms silver images when heated to 80° C. or higher under the presence of an exposed photosensitive silver halide and a reducing agent. The organic silver salt may be any organic material containing a source capable of supplying silver ions that are reducible by a reducing agent. Such non-photosensitive organic silver salt is disclosed, for example, in JP-A No. 10-62899 (paragraph Nos. 0048 to 0049), EP-A No. 0803764A1 (page 18, line 24 to page 19, line 37), EP-A No. 0962812A1, JP-A Nos. 11-349591, 2000-7683, and 2000-72711, and the like. A silver salt of organic acid, particularly, a silver salt of long chained aliphatic carboxylic acid (having 10 to 30 carbon atoms, and preferably having 15 to 28 carbon atoms) is preferable. Preferred examples of the silver salt of fatty acid can include, for example, silver lignocerate, silver behenate, silver arachidinate, silver stearate, silver oleate, silver laurate, silver capronate, silver myristate, silver palmitate, silver erucate and mixtures thereof. In the invention, among these silver salts of fatty acid, it is preferred to use a silver salt of fatty acid with a silver behenate content of 50 mol % or more, more preferably, 85 mol % or more, and further preferably, 95 mol % or more. Further, it is preferred to use a silver salt of fatty acid with a silver erucate content of 2 mol % or less, more preferably, 1 mol % or less, and further preferably, 0.1 mol % or less.

It is preferable that the content of silver stearate is 1 mol % or less. When the content of silver stearate is 1 mol % or less, a silver salt of organic acid having low Dmin, high sensitivity and excellent image storability can be obtained. The above-mentioned content of silver stearate is preferably 0.5 mol % or less, and particularly preferably, silver stearate is not substantially contained.

Further, in the case where the silver salt of organic acid includes silver arachidinate, it is preferred that the content of silver arachidinate is 6 mol % or less in order to obtain a silver salt of organic acid having low Dmin and excellent image storability. The content of silver arachidinate is more preferably 3 mol % or less.

2) Shape

There is no particular restriction on the shape of the organic silver salt usable in the invention and it may needle-like, bar-like, tabular or flaky shape.

In the invention, a flaky shaped organic silver salt is preferred. Short needle-like, rectangular, cuboidal or potato-like indefinite shaped particle with the major axis to minor axis ratio being 5 or less is also used preferably. Such organic silver particle has a feature less suffering from fogging during thermal development compared with long needle-like particles with the major axis to minor axis length ratio of more than 5. Particularly, a particle with the major axis to minor axis ratio of 3 or less is preferred since it can improve the mechanical stability of the coating film. In the present specification, the flaky shaped organic silver salt is defined as described below. When an organic acid silver salt is observed under an electron microscope, calculation is made while approximating the shape of an organic acid silver salt particle to a rectangular body and assuming each side of the rectangular body as a, b, c from the shorter side (c may be identical with b) and determining x based on numerical values a, b for the shorter side as below.
x=b/a

As described above, x is determined for the particles by the number of about 200 and those capable of satisfying the relation: x (average)≧1.5 as an average value x is defined as a flaky shape. The relation is preferably: 30≧x (average)≧1.5 and, more preferably, 15≧x (average)≧1.5. The “needle-like” shape is expressed as 1≦x (average)<1.5.

In the flaky shaped particle, a can be regarded as a thickness of a tabular particle having a main plate with b and c being as the sides. a in average is preferably in a range of 0.01 μm to 0.3 μm and, more preferably, in a range of 0.1 μm to 0.23 μm. c/b in average is preferably in a range of 1 to 9, more preferably in a range of 1 to 6, further preferably in a range of 1 to 4 and, most preferably in a range of 1 to 3.

By controlling the sphere equivalent diameter to 0.05 μm to 1 μm, it causes less agglomeration in the photothermographic material and image storability is improved. The sphere equivalent diameter is preferably in a range of 0.1 μm to 1 μm. In the invention, an sphere equivalent diameter can be measured by a method of photographing a sample directly by using an electron microscope and then image processing the negative images.

In the flaky shaped particle, the sphere equivalent diameter of the particle/a is defined as an aspect ratio. The aspect ratio of the flaky particle is, preferably, in a range of 1.1 to 30 and, more preferably, in a range of 1.1 to 15 with a viewpoint of causing less agglomeration in the photothermographic material and improving the image storability.

The particle diameter distribution of the organic silver salt is preferably a monodispersion. In the monodispersion, the percentage for the value obtained by dividing the standard deviation for the length of minor axis and major axis by the minor axis and the major axis respectively is, preferably, 100% or less, more preferably, 80% or less and, further preferably, 50% or less. The shape of the organic silver salt can be measured by determining dispersion of an organic silver salt as transmission type electron microscopic images. Another method of measuring the monodispersion is a method of determining of the standard deviation of the volume weighted mean diameter of the organic silver salt in which the percentage for the value defined by the volume weight mean diameter (variation coefficient), is preferably, 100% or less, more preferably, 80% or less and, further preferably, 50% or less. The monodispersion can be determined from particle diameter (volume weighted mean diameter) obtained, for example, by a measuring method of irradiating a laser beam to organic silver salts dispersed in a liquid, and determining a self correlation function of the fluctuation of scattered light to the change of time.

3) Preparation

Methods known in the art may be applied to a method for producing the organic silver salt used in the invention and to a method for dispersing thereof. For example, reference can be made to JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, 2002-107868, and the like.

When a photosensitive silver salt is present together during dispersing of the organic silver salt, fog increases and sensitivity becomes remarkably lower, so that it is more preferable that the photosensitive silver salt is not substantially contained during dispersion. In the invention, an amount of the photosensitive silver salt to be dispersed in the aqueous dispersion is preferably in a range of 1 mol % or less, more preferably in a range of 0.1 mol % or less per 1 mol of the organic acid silver salt in the solution and, further preferably, addition of the photosensitive silver salt is not positively conducted.

In the invention, the photothermographic material can be prepared by mixing an aqueous dispersion of an organic silver salt and an aqueous dispersion of a photosensitive silver salt. A mixing ratio between the organic silver salt and the photosensitive silver salt can be selected depending on a purpose of utilization. The ratio of the photosensitive silver salt to the organic silver salt is, preferably, in a range of 1 mol % to 30 mol %, more preferably in a range of 2 mol % to 20 mol % and, particularly preferably in a range of 3 mol % to 15 mol %. A method of mixing two or more kinds of aqueous dispersions of organic silver salts and two or more kinds of aqueous dispersions of photosensitive silver salts upon mixing is preferably used for controlling the photographic properties.

4) Addition Amount

While the organic silver salt in the invention can be used in a desired amount, a total amount of coated silver including silver halide is preferably in a range of 0.1 g/m² to 5.0 g/m², more preferably in a range of 0.3 g/m² to 3.0 g/m², and further preferably in a range of 0.5 g/m² to 2.0 g/m². Particularly, in order to improve image storability, the total amount of coated silver is preferably 1.8 mg/m² or less, and more preferably 1.6 mg/m² or less. When a preferable reducing agent is used in the invention, it is possible to obtain a sufficient image density by even such the low amount of silver.

Reducing Agent for Non-Photosensitive Organic Silver Salt

The photothermographic material of the invention preferably contains a reducing agent for the organic silver salt. The reducing agent may be any substance (preferably, organic substance) capable of reducing silver ions into metallic silver. Examples of the reducing agent are described in paragraphs 0043 to 0045 of JP-A No. 11-65021, page 7, line 34 to page 18, line 12 of EP-A No. 0803764A1 and the like.

In the invention, a so-called hindered phenolic reducing agent or a bisphenol reducing agent having a substituent at an ortho-position of a phenolic hydroxy group thereof is preferable. Particularly, the compound represented by the following Formula (R) is preferable.

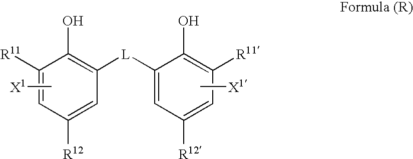

In Formula (R), R¹¹ and R^{11′} each independently represent an alkyl group having 1 to 20 carbon atoms. R¹² and R^{12′} each independently represent one selected from the group consisting of a hydrogen atom and a group capable of being a substitutent on a benzene ring. L represents one selected from an —S— group and a —CHR¹³— group. R¹³ represents one selected from a hydrogen atom and an alkyl group having 1 to 20 carbon atoms. X¹ and X^{1′} each independently represent one selected from the group consisting of a hydrogen atom and a group capable of being a substitutent on a benzene ring.

Formula (R) is explained in detail.

Hereinafter, the scope of the term “an alkyl group” includes a cycloalkyl group unless otherwise stated.

1) R¹¹ and R^{11′}

R¹¹ and R^{11′} each independently represent a substituted or unsubstituted alkyl group having 1 to 20 carbon atoms. The substituent for the alkyl group is not particular restricted, and preferable examples thereof include an aryl group, a hydroxy group, an alkoxy group, an aryloxy group, an alkylthio group, an arylthio group, an acylamino group, a sulfoneamide group, a sulfonyl group, a phosphoryl group, an acyl group, a carbamoyl group, an ester group, an ureido group, an urethane group, and a halogen atom.

2) R¹², R^{12′}, X¹ and X^{1′}

R¹² and R¹²′ each independently represent a hydrogen atom or a group capable of being a substituent on a benzene ring. X¹ and X^{1′} each independently represent a hydrogen atom or a group capable of being a substituent on a benzene ring. Preferable examples of the groups capable of being a substituent on a benzene ring in R¹², R^{12′}, X¹ and X^{1′} include an alkyl group, an aryl group, a halogen atom, an alkoxy group, and an acylamino group.

3) L

L represents a —S— group or a —CHR¹³-group. R¹³ represents a hydrogen atom or an alkyl group having 1 to 20 carbon atoms in which the alkyl group may have a substituent. Specific examples of the unsubstituted alkyl group for R¹³ can include, for example, a methyl group, an ethyl group, a propyl group, a butyl group, a heptyl group, an undecyl group, an isopropyl group, a 1-ethylpentyl group, a 2,4,4-trimethylpentyl group, a cyclohexyl group, a 2,4-dimetyl-3-cyclohexenyl group, a 3,5-dimethyl-3-cyclohexenyl group, and the like. Examples of the substituent for the alkyl group are similar to those of the substituent of R¹¹ and include a halogen atom, an alkoxy group, an alkylthio group, an aryloxy group, an arylthio group, an acylamino group, a sulfoneamide group, a sulfonyl group, a phosphoryl group, an oxycarbonyl group, a carbamoyl group, a sulfamoyl group, and the like.

4) Preferable substituents

Each of R¹¹ and R^{11′} is preferably a primary, secondary or tertiary alkyl group having 1 to 15 carbon atoms. Specific examples thereof include a methyl group, an isopropyl group, a t-butyl group, a t-amyl group, a t-octyl group, a cyclohexyl group, a cyclopentyl group, a 1-methylcyclohexyl group, a 1-methylcyclopropyl group and the like. More preferable examples of R¹¹ and R^{11′} include an alkyl group having 1 to 4 carbon atoms. Further preferable examples thereof among them include a methyl group, a t-butyl group, a t-amyl group, and a 1-methylcyclohexyl group. Most preferable examples thereof include a methyl group and a t-butyl group.

Each of R¹² and R^{12′} is preferably an alkyl group having 1 to 20 carbon atoms. Specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group and the like. More preferable examples thereof include a methyl group, an ethyl group, a propyl group, an isopropyl group, and a t-butyl group, and particularly examples thereof include a methyl group and an ethyl group.

Each of X¹ and X^{1′} is preferably a hydrogen atom, a halogen atom, or an alkyl group,. More preferable examples thereof include a hydrogen atom.

L is preferably a —CHR¹³— group.

Preferable examples of R¹³ include a hydrogen atom or an alkyl group having 1 to 15 carbon atoms. A cyclic alkyl group is preferably used as the alkyl group in addition to a chain alkyl group. An alkyl group which has a C═C bond therein is also preferably used. Preferable examples of the alkyl group include a methyl group, an ethyl group, a propyl group, an isopropyl group, a 2,4,4-trimethylpentyl group, a cyclohexyl group, a 2,4-dimethyl-3-cyclohexenyl group, a 3,5-dimetyl-3-cyclohexenyl group and the like. Particularly preferable examples of R¹³ include a hydrogen atom, a methyl group, an ethyl group, a propyl group, an isopropyl group, or a 2,4-dimethyl-3-cyclohexenyl group.

In the case where each of R¹¹ and R^{11′} is a tertiary alkyl group and each of R¹² and R^{12′} is a methyl group, R¹³ is preferably a primary or secondary alkyl group having 1 to 8 carbon atoms (such as a methyl group, an ethyl group, a propyl group, an isopropyl group, a 2,4-dimethyl-3-cyclohexenyl group, or the like).

In the case where each of R¹¹ and R^{11′} is a tertiary alkyl group and each of R¹² and R^{12′} is an alkyl group other than a methyl group, R¹³ is preferably a hydrogen atom.

In the case where each of R¹¹ and R¹¹ is not a tertiary alkyl group, R¹³ is preferably a hydrogen atom or a secondary alkyl group, and particularly preferably a secondary alkyl group. Examples of the secondary alkyl group for R¹³ include an isopropyl group and a 2,4-dimethyl-3-cyclohexenyl group.

The reducing agent described above shows different thermal developing performances, color tones of developed silver images and the like depending on a combination of R¹¹, R^{11′}, R¹², R^{12′}, and R¹³. Since these performances can be controlled by using two or more kinds of reducing agents in combination, it is preferred to use two or more kinds of reducing agents in combination depending on a purpose thereof.

Specific examples of the reducing agents used in the invention including the compounds represented by Formula (R) are shown below. However, the invention is not restricted by them.

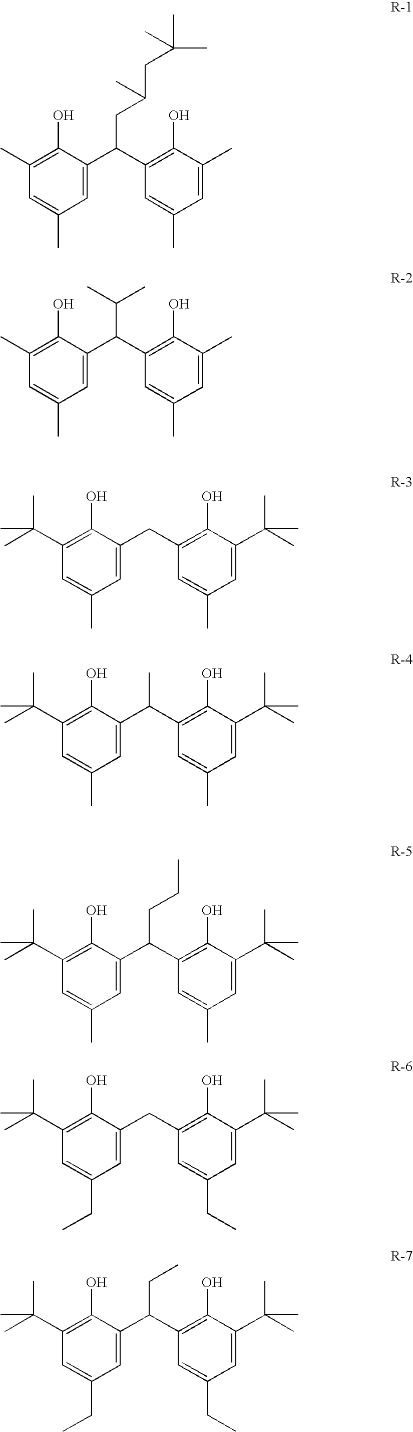

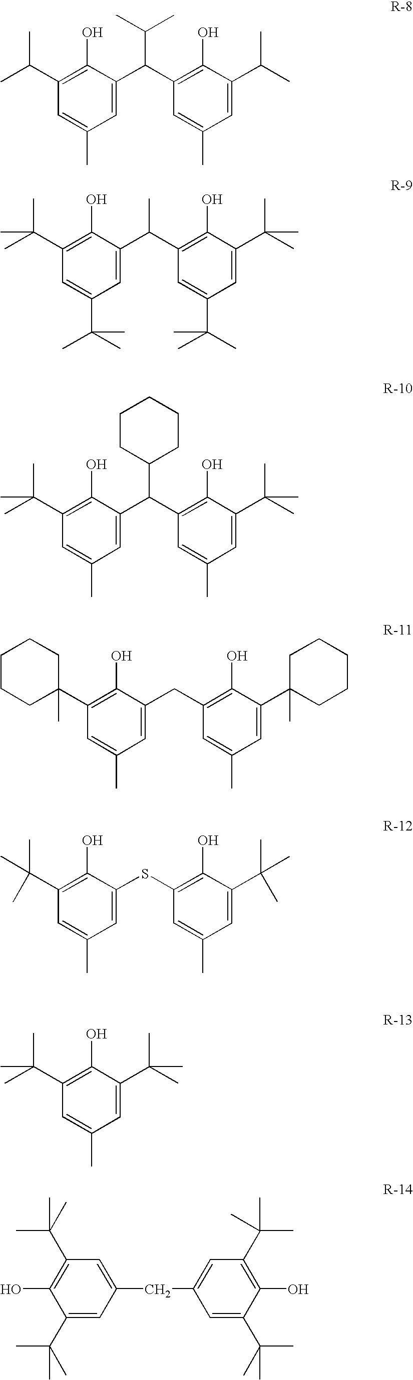

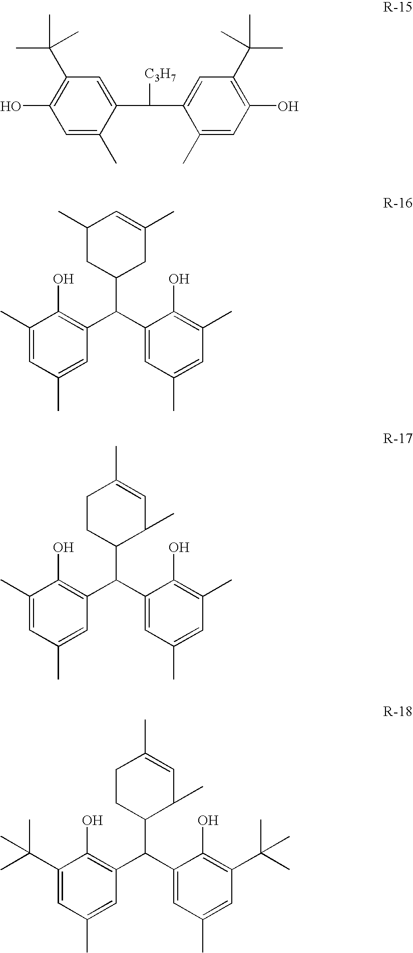

Examples of the preferable reducing agent of the invention other than those above include t compounds disclosed in JP-A Nos. 2001-188314, 2001-209145, 2001-350235, and 2002-156727, and EP No. 1 278 101A2.

An addition amount of the reducing agent in the invention is preferably in a range of 0.1 g/m² to 3.0 g/m², more preferably in a range of 0.2 g/m² to 2.0 g/m², and further preferably in a range of 0.3 g/m² to 1.0 g/m². An amount of the reducing agent per 1 mol of silver in the surface having the image forming layer is preferably in a range of 5 mol % to 50 mol %, more preferably in a range of 8 mol % to 30 mol %, and further preferably in a range of 10 mol % to 20 mol %. The reducing agent of the invention is preferably contained in the image forming layer.

The reducing agent may be incorporated into photothermographic material of the invention by being added to the coating liquid in the form of such as solution, emulsion dispersion, solid fine particle dispersion, or the like.

Examples of a well known emulsion dispersing method include a method which includes dissolving the reducing agent using an oil such as dibutyl phthalate, tricresyl phosphate, glyceryl triacetate, diethyl phthalate or the like, an auxiliary solvent such as ethyl acetate or cyclohexanone, or the like, adding thereto a surfactant such as sodium dodecylbenzene sulfonate, sodium oleoyl-N-methyltaurate, sodium di(2-ethylhexyl) sulfosuccinate or the like, and mechanically producing an emulsion dispersion. During this process, polymers such as α-methylstyrene oligomer or poly(t-butylacrylamide) can be preferably added in order to regulating a viscosity and/or a refractive index of drops of the oil.

Examples of a method for dispersing solid fine particles include a method comprising dispersing the powder of the reducing agent in an appropriate medium such as water by means of a ball mill, a colloid mill, a vibrating ball mill, a sand mill, a jet mill, a roller mill or an ultrasonics, thereby obtaining a solid dispersion. In this case, a protective colloid (such as polyvinyl alcohol) or a surfactant (for instance, an anionic surfactant such as sodium triisopropylnaphthalenesulfonate (a mixture of compounds having the isopropyl groups in different substitution sites)) may be employed in the method. In the mills enumerated above, beads made of zirconia and the like are generally used as the dispersion media, and Zr and the like eluting from the beads may be incorporated in the dispersion. Although depending on the dispersing conditions, an amount of Zr and the like incorporated in the dispersion is ordinarily in a range from 1 ppm to 1000 ppm. It is practically acceptable so long as Zr is incorporated in an amount of 0.5 mg or less relative to 1 g of silver.

An antiseptic (for instance, sodium benzoisothiazolinone salt) is preferably added to the water dispersion.

In the invention, the reducing agent is particularly preferably used as a solid particle dispersion, in that the reducing agent is added in a form of fine particles having an average particle diameter (diameter) that is in a range of 0.01 μm to 10 μm, more preferably in a range of 0.05 μm to 5 μm, and further preferably in a range of 0.1 μm to 2 μm. In the invention, other solid dispersions are preferably used by being dispersed so as to respectively has an average particle diameter (diameter) which is within the particle diameter range.

Development Accelerator

Examples of a development accelerator which can be preferably used in the photothermographic material of the invention include: sulfoneamide phenolic compounds such as those represented by formula (1) described in JP-A No. 2000-267222 or those represented by formula (A) described in JP-A No. 2000-330234; hindered phenolic compounds represented by formula (II) described in JP-A No. 2001-92075; hydrazine compounds such as those represented by formula (I) described in JP-A No. 10-62895, those represented by formula (I) described in JP-A No. 11-15116, those represented by formula (D) described in JP-A No. 2002-156727, or those represented by formula (1) described in JP-A No. 2002-278017; and phenolic or naphtholic compounds represented by formula (2) described in JP-A No. 2001-264929. Preferable examples of the development accelerator further include phenolic compounds described in JP-A Nos. 2002-311533 or 2002-341484. Particularly preferable examples of the development accelerator include naphtholic compounds described in JP-A No. 2003-66558. The development accelerator described above is used in a range from 0.1 mol % to 20 mol %, preferably, in a range from 0.5 mol % to 10 mol % and, more preferably, in a range from 1 mol % to 5 mol % with respect to the reducing agent. The development accelerator can be introduced into the photothermographic material in a similar manner as that for the reducing agent, and is particularly preferably introduced thereto by being added as a solid dispersion or an emulsion dispersion. In a case of being added as an emulsion dispersion, the development accelerator is preferably added as an emulsion dispersion dispersed by using a solvent which has a high boiling point and is solid at a normal temperature and an auxiliary solvent which has a low boiling point, or the development accelerator is preferably added as a so-called oilless emulsion dispersion which does not use a solvent having a high boiling point.

Among these development accelerators, hydrazine compounds described in JP-A Nos. 2002-156727 or 2002-278017 and naphtholic compounds described in JP-A No. 2003-66558 are further preferably used in the present invention.

Particularly preferable development accelerators of the invention are compounds represented by the following Formulae (A-1) and (A-2).
Q₁—NHNH—Q₂ Formula (A-1)

In Formula (A-1), Q₁ represents an aromatic group which bonds to —NHNH—Q₂ at a carbon atom or a heterocyclic group which bonds to —NHNH—Q₂ at a carbon atom, and Q₂ represents one selected from the group consisting of a carbamoyl group, an acyl group, an alkoxycarbonyl group, an aryloxycarbonyl group, a sulfonyl group, and a sulfamoyl group.

In Formula (A-1), the aromatic group or the heterocyclic group represented by Q₁ is preferably a 5- to 7-membered unsaturated ring. Preferable examples thereof include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, and a thiophene ring. Preferable examples thereof further include a condensed ring in which the rings described above are condensed with each other.

The rings described above may have one or more substituents, and in a case where they have two or more substituents, the substituents may be same with or different from each other. Examples of the substituents include a halogen atom, an alkyl group, an aryl group, a carboamide group, an alkylsulfoneamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. In the case where the substituents are groups capable of having one or more substituents, they may have a substituent(s), and preferable examples of such substituents include a halogen atom, an alkyl group, an aryl group, a carbonamide group, an alkylsulfoneamide group, an arylsulfoneamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

The carbamoyl group represented by Q₂ preferably has 1 to 50 carbon atoms and, more preferably has 6 to 40 carbon atoms, and examples thereof include an unsubstituted carbamoyl group, a methyl carbamoyl group, a N-ethylcarbamoyl group, a N-propylcarbamoyl group, a N-sec-butylcarbamoyl group, a N-octylcarbamoyl group, a N-cyclohexylcarbamoyl group, a N-tert-butylcarbamoyl group, a N-dodecylcarbamoyl group, a N-(3-dodecyloxypropyl)carbamoyl group, a N-octadecylcarbamoyl group, a N-{3-(2,4-tert-pentylphenoxy)propyl}carbamoyl group, a N-(2-hexyldecyl)carbamoyl group, a N-phenylcarbamoyl group, a N-(4-dodecyloxyphenyl)carbamoyl group, a N-(2-chloro-5-dodecyloxycarbonylphenyl)carbamoyl group, a N-naphthylcarbaoyl group, a N-3-pyridylcarbamoyl group, and a N-benzylcarbamoyl group.

The acyl group represented by Q₂ preferably has 1 to 50 carbon atoms and, more preferably has 6 to 40 carbon atoms, and example thereof include a formyl group, an acetyl group, a 2-methylpropanoyl group, a cyclohexylcarbonyl group, an octanoyl group, a 2-hexyldecanoyl group, a dodecanoyl group, a chloroacetyl group, a trifluoroacetyl group, a benzoyl group, a 4-dodecyloxybenzoyl group, and a 2-hydroxymethylbenzoyl group. The alkoxycarbonyl group represented by Q₂ preferably has 2 to 50 carbon atom, and more preferably has 6 to 40 carbon atoms, and examples thereof include a methoxycarbonyl group, an ethoxycarbonyl group, an isobutyloxycarbonyl group, a cyclohexyloxycarbonyl group, a dodecyloxycarbonyl group, and a benzyloxycarbonyl group.

The aryloxy carbonyl group represented by Q₂ preferably has 7 to 50 carbon atoms, and more preferably has 7 to 40 carbon atoms, and examples thereof include a phenoxycarbonyl group, a 4-octyloxyphenoxycarbonyl group, a 2-hydroxymethylphenoxycarbonyl group, and a 4-dodecyloxyphenoxycarbonyl group. The sulfonyl group represented by Q₂ preferably has 1 to 50 carbon atoms, and more preferably has 6 to 40 carbon atoms, and examples thereof include a methylsulfonyl group, a butylsulfonyl group, an octylsulfonyl group, a 2-hexadecylsulfonyl group, a 3-dodecyloxypropylsulfonyl group, a 2-octyloxy-5-tert-octylphenyl sulfonyl group, and a 4-dodecyloxyphenyl sulfonyl group.

The sulfamoyl group represented by Q₂ preferably has 0 to 50 carbon atoms, and more preferably has 6 to 40 carbon atoms, and examples thereof include an unsubstituted sulfamoyl group, a N-ethylsulfamoyl group, a N-(2-ethylhexyl)sulfamoyl group, a N-decylsulfamoyl group, a N-hexadecylsulfamoyl group, a N-{3-(2-ethylhexyloxy)propyl}sulfamoyl group, a N-(2-chloro-5-dodecyloxycarbonylphenyl)sulfamoyl group, and a N-(2-tetradecyloxyphenyl)sulfamoyl group. The group represented by Q₂ may further have a substituent group mentioned as the example of the substituent of 5- to 7-membered unsaturated ring represented by Q₁ at a position which may have a substituent. In a case where the group has two or more substituents, such substituents may be same with or different from each other.

Further, preferable range of the compounds represented by Formula (A-1) is herein described. A 5-membered or 6-membered unsaturated ring is preferable as Q₁, and further preferable examples thereof include a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thioazole ring, an oxazole ring, an isothiazole ring, an isooxazole ring, and a ring in which any one of the rings described above is condensed with a benzene ring or an unsaturated hetero ring. Further, Q₂ is preferably a carbamoyl group, and particularly preferably is a carbamoyl group having a hydrogen atom on the nitrogen atom thereof.

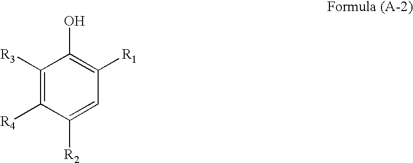

In Formula (A-2), R₁ represents one selected from the group consisting of an alkyl group, an acyl group, an acylamino group, a sulfoneamide group, an alkoxycarbonyl group, and a carbamoyl group. R₂ represents one selected from the group consisting of a hydrogen atom, a halogen atom, an alkyl group, an alkoxy group, an aryloxy group, an alkylthio group, an arylthio group, an acyloxy group, and a carbonate ester group. R₃ and R₄ each independently represent a group capable of being a substituent on a benzene ring which is mentioned as the example of the substituent for Formula (A-1). R₃ and R₄ may be linked with each other to form a condensed ring.

Preferable examples of R₁ include an alkyl group having 1 to 20 carbon atoms (such as a methyl group, an ethyl group, an isopropyl group, a butyl group, a tert-octyl group, a cyclohexyl group or the like), an acylamino group (such as an acetylamino group, a benzoylamino group, a methylureido group, a 4-cyanophenylureido group or the like), and a carbamoyl group (such as a n-butylcarbamoyl group, an N,N-diethylcarbamoyl group, a phenylcarbamoyl group, a 2-chlorophenylcarbamoyl group, a 2,4-dichlorophenylcarbamoyl group or the like). Among these, an acylamino group (including an ureido group and an urethane group) is more preferable. Preferable examples of R₂ include a halogen atom (more preferably, a chlorine atom or a bromine atom), an alkoxy group (such as a methoxy group, a butoxy group, an n-hexyloxy group, an n-decyloxy group, a cyclohexyloxy group, a benzyloxy group or the like), and an aryloxy group (such as a phenoxy group, a naphthoxy group or the like).

R₃ is preferably a hydrogen atom, a halogen atom, or an alkyl group having 1 to 20 carbon atoms, and most preferably a halogen atom. R₄ is preferably a hydrogen atom, an alkyl group, or an acylamino group, and more preferably an alkyl group or an acylamino group. Examples of the preferable substituents therefor are similar to those for R₁. In the case where R₄ is an acylamino group, R₄ may be preferably linked with R₃ to form a carbostyryl ring.

In the case where R₃ and R₄ in Formula (A-2) are linked together to form a condensed ring, a naphthalene ring is particularly preferable as the condensed ring. A substituent which is similar to those described as the substituent for Formula (A-1) may be bonded to the naphthalene ring. In the case where Formula (A-2) is a naphtholic compound, R₁ is preferably a carbamoyl group. Among them, a benzoyl group is particularly preferable. R₂ is preferably an alkoxy group or an aryloxy group and, particularly preferably an alkoxy group.

Specific preferable examples of the development accelerator used in the invention are described below. The invention is not restricted to them. 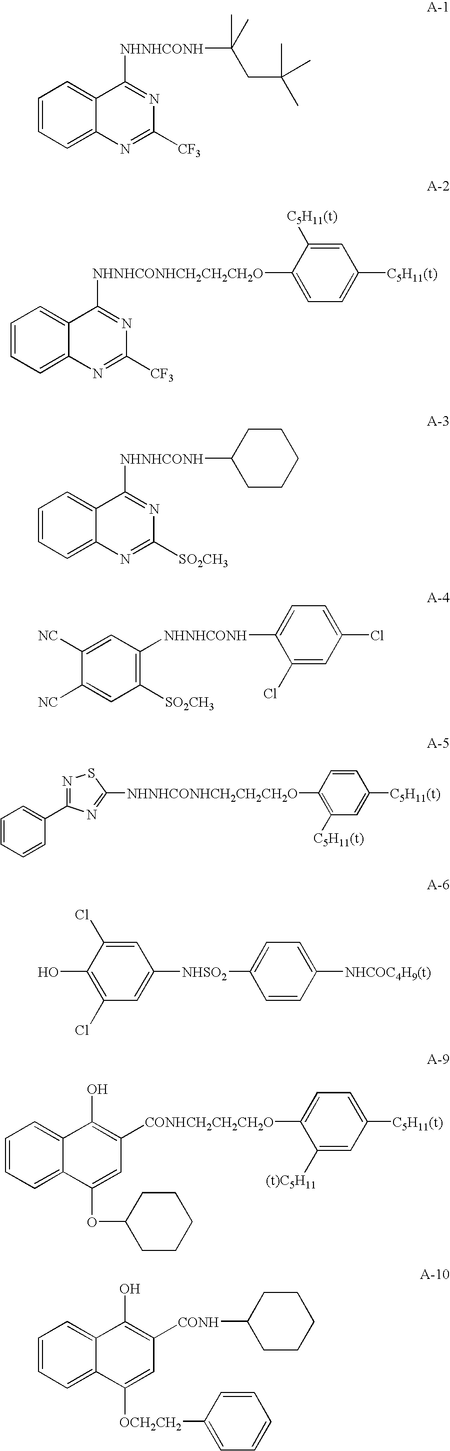 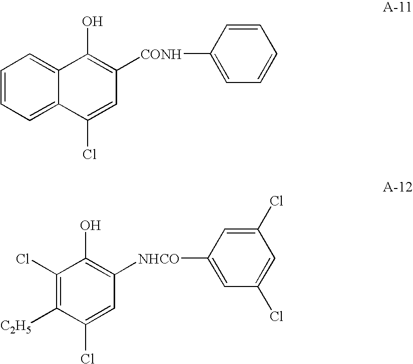
Hydrogen Bonding Compound

In the invention, in the case where the reducing agent has an aromatic hydroxy group (—OH) or an amino group (—NHR, in which R represents a hydrogen atom or an alkyl group), particularly in the case where the reducing agent is a bisphenol described above, it is preferable to additionally use a non-reducing compound having a group capable of reacting with the aromatic hydroxy group or the amino group of the reducing agent to form a hydrogen bond.

Examples of the group capable of reacting with the aromatic hydroxy group or the amino group of the reducing agent include a phosphoryl group, a sulfoxido group, a sulfonyl group, a carbonyl group, an amido group, an ester group, an urethane group, an ureido group, a tertiary amino group, a nitrogen-containing aromatic group, and the like. Particularly preferable examples among them include a phosphoryl group, a sulfoxido group, an amido group (which has no >N—H moiety but is blocked in a form of such as >N—Ra (in which Ra represents a substituent other than H)), an urethane group (which has no >N—H moiety but is blocked in a form of such as >N—Ra (in which Ra represents a substituent other than H)), and an ureido group (which has no >N—H moiety but is blocked in a form of such as >N—Ra (in which Ra represents a substituent other than H)).

Particularly preferable example of the hydrogen bonding compound used in the invention is the compound represented by the following Formula (D).

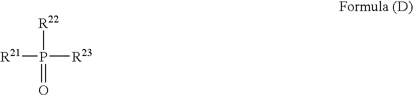

In Formula (D), R²¹ to R²³ each independently represent one selected from the group consisting of an alkyl group, an aryl group, an alkoxy group, an aryloxy group, an amino group, and a heterocyclic group, each of which may have a substitutent or may be unsubstituted.

In the case where R²¹ to R²³ each has a substituent, examples of the substituent include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like. Preferable examples thereof include an alkyl group and an aryl group, such as a methyl group, an ethyl group, an isopropyl group, a t-butyl group, a t-octyl group, a phenyl group, a 4-alkoxyphenyl group, a 4-acyloxyphenyl group or the like.

Specific examples of the alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, a 2-phenoxypropyl group, and the like.

Specific examples of the aryl group represented by R²¹ to R²³ include a phenyl group, a cresyl group, a xylyl group, a naphthyl group, a 4-t-butylphenyl group, a 4-t-octylphenyl group, a 4-anisidyl group, a 3,5-dichlorophenyl group, and the like.

Specific examples of the alkoxyl group represented by R²¹ to R²³ include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group, and the like.

Specific examples of the aryloxy group represented by R²¹ to R²³ include a phenoxy group, a cresyloxy group, an isopropylphenoxy group, a 4-t-butylphenoxy group, a naphthoxy group, a biphenyloxy group, and the like.

Specific examples of the amino group represented by R²¹ to R²³ include a dimethylamino group, a diethylamino group, a dibutylamino group, a dioctylamino group, an N-methyl-N-hexylamino group, a dicyclohexylamino group, a diphenylamino group, an N-methyl-N-phenylamino, and the like.

Preferable examples of the group represented by R²¹ to R²³ include an alkyl group, an aryl group, an alkoxy group, and an aryloxy group. In view of an effect of the invention, it is preferable that at least one of R²¹ to R²³ is an alkyl group or an aryl group, and more preferably, two or more of them are respectively an alkyl group or an aryl group. From the viewpoint of low cost availability, it is preferable that R²¹ to R²³ are of the same group.

Specific examples of hydrogen bonding compounds represented by Formula (D) of the invention and others are shown below. However, the invention is not limited thereto.

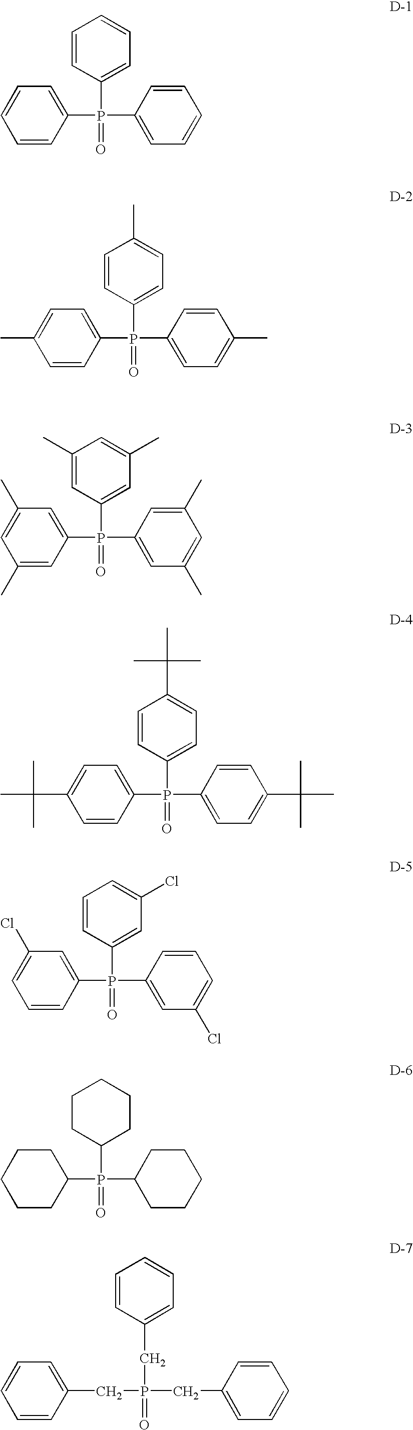

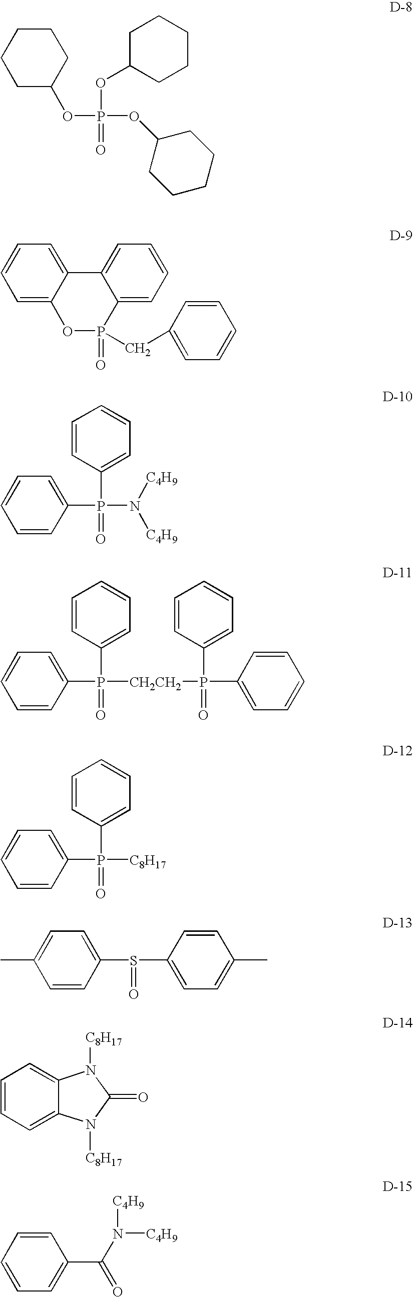

Specific examples of the hydrogen bonding compounds other than those enumerated above are found in EP No. 1 096 310 and in JP-A Nos. 2002-156727 and 2002-318431.

The compound represented by Formula (D) can be used in the photothermographic material of the invention by being incorporated into the coating liquid in a form of solution, emulsion dispersion, or solid fine particle dispersion similar to the case of reducing agent. It is preferable to be used in the form of solid dispersion. In the solution, the compound represented by Formula (D) forms a hydrogen-bonded complex with a compound having a phenolic hydroxyl group or an amino group, and can be isolated as a complex in a crystalline state depending on a combination of the reducing agent and the compound represented by Formula (D). It is particularly preferable to use the crystal powder thus isolated in the form of solid fine particle dispersion in view of obtaining a stable performance. Further, it is also preferable to use a method of leading formation of a complex during dispersion by mixing the reducing agent and the compound represented by Formula (D) in the form of powders and dispersing them with a suitable dispersion agent using sand grinder mill or the like.

An amount of the compound represented by Formula (D) is preferably in a range from 1 mol % to 200 mol %, more preferably from 10 mol % to 150 mol %, and further preferably, from 20 mol % to 100 mol %, with respect to the reducing agent.

Silver Halide

1) Halogen Composition

There is no particular restriction on the halogen composition of the photosensitive silver halide used in the invention, and silver chloride, silver bromochloride, silver bromide, silver iodobromide, silver iodochlorobromide, silver iodide and the like can be preferably used. Among them, silver bromide, silver iodobromide and silver iodide are preferable. A distribution of the halogen composition in a grain may be uniform or the halogen composition may be changed stepwise, or it may be changed continuously. Further, a silver halide grain having a core/shell structure can be preferably used. Preferable structure is a twofold to fivefold structure and, more preferably, core/shell grain having a twofold to fourfold structure can be used. Further, a technique of localizing silver bromide or silver iodide to the surface of a silver chloride, silver bromide or silver chlorobromide grains can also be preferably used.

2) Method of Grain Formation

Methods for forming photosensitive silver halide is well-known in the relevant art and, for example, methods described in Research Disclosure No. 10729, June 1978 and U.S. Pat. No. 3,700,458 can be used. Specifically, a method of preparing photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferable.

3) Grain Size

The grain size of the photosensitive silver halide is preferably small with an aim of suppressing clouding after image formation and, specifically, it is 0.20 μm or less, more preferably, 0.01 μm to 0.15 μm and, further preferably, 0.02 μm to 0.12 μm. The grain size as used herein means an average diameter of a circle converted such that it has a same area as a projected area of the silver halide grain (projected area of a main plane in a case of a tabular grain).

4) Grain Shape

The shape of the silver halide grain can include, for example, cubic, octahedral, tabular, spherical, rod-like or potato-like shape. The cubic grain is particularly preferred in the invention. A silver halide grain rounded at corners can also be used preferably. The surface indices (Miller indices) of the outer surface of a photosensitive silver halide grain is not particularly restricted, and it is preferable that the ratio occupied by the [100] face is rich, because of showing high spectral sensitization efficiency when a spectral sensitizing dye is adsorbed. The ratio is preferably 50% or more, more preferably 65% or more, and further preferably 80% or more. The ratio of the [100]face, Miller indices, can be determined by a method described in T. Tani; J. Imaging Sci., vol. 29, page 165, (1985) utilizing adsorption dependency of the [111] face and [100] face in adsorption of a sensitizing dye.

5) Heavy Metal

The photosensitive silver halide grain of the invention can contain metals or complexes of metals belonging to groups 8 to 13 of the periodic table (showing groups 1 to 18). Preferred are metals or complexes of metals belonging to groups 6 to 10. The metal or the center metal of the metal complex from groups 6 to 10 of the periodic table is preferably ferrum, rhodium, ruthenium or iridium. The metal complex may be used alone, or two or more kinds of complexes comprising identical or different species of metals may be used together. A preferred content is in a range from 1×10⁻⁹ mol to 1×10⁻³ mol per 1 mol of silver. The heavy metals, metal complexes and the adding method thereof are described in JP-A No. 7-225449, in paragraph Nos. 0018 to 0024 of JP-A No.11-65021 and in paragraph Nos. 0227 to 0240 of JP-A No. 11-119374.

In the present invention, a silver halide grain having a hexacyano metal complex is present on the outermost surface of the grain is preferred. The hexacyano metal complex includes, for example, [Fe(CN)₆]⁴⁻, [Fe(CN)₆]³−, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl) ammonium ion), which are easily misible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

The addition amount of the hexacyano metal complex is preferably from 1×10⁻⁵ mol to 1×10⁻² mol and, more preferably, from 1×10⁻⁴ mol to 1×10⁻³ per 1 mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion formation step prior to a chemical sensitization step, of conducting chalcogen sensitization such as sulfur sensitization, selenium sensitization and tellurium sensitization or noble metal sensitization such as gold sensitization, during washing step, during dispersion step and before chemical sensitization step. In order not to grow the fine silver halide grain, the hexacyano metal complex is rapidly added preferably after the grain is formed, and it is preferably added before completion of the emulsion formation step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)₆]⁴⁻), desalting method of a silver halide emulsion and chemical sensitizing method are described in paragraph Nos. 0046 to 0050 of JP-A No.11-84574, in paragraph Nos. 0025 to 0031 of JP-A No.11-65021, and paragraph Nos. 0242 to 0250 of JP-A No.11-119374.

6) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating liquid, and gelatin having a molecular weight of 10,000 to 1,000,000 is preferably used. And phthalated gelatin is also preferably used. These gelatins may be used at grain formation step or at the time of dispersion after desalting treatment and it is preferably used at grain formation.

7) Sensitizing Dye

As the sensitizing dye applicable in the invention, those capable of spectrally sensitizing silver halide grains in a desired wavelength region upon adsorption to silver halide grains having spectral sensitivity suitable to spectral characteristic of an exposure light source can be selected advantageously. The sensitizing dyes and the adding method are disclosed, for example, JP-A No. 11-65021 (paragraph Nos. 0103 to 0109), as a compound represented by the formula (II) in JP-A No. 10-186572, dyes represented by the formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP-A No. 0803764A1, and in JP-A Nos. 2001-272747, 2001-290238 and 2002-23306. The sensitizing dyes described above may be used alone or two or more of them may be used in combination. In the invention, sensitizing dye can be added preferably after desalting step and before coating step, and more preferably after desalting step and before the completion of chemical ripening.

In the invention, the sensitizing dye may be added at any amount according to the property of sensitivity and fogging, but it is preferably added from 10⁻⁶ mol to 1 mol, and more preferably in a range of 10⁻⁴ mol to 10⁻¹ mol, relative to 1 mol of silver halide in the image forming layer.

The photothermographic material of the invention may also contain super sensitizers in order to improve spectral sensitizing effect. The super sensitizers usable in the invention can include those compounds described in EP-A No. 587338, U.S. Pat. Nos. 3,877,943 and 4,873,184 and JP-A Nos. 5-341432, 11-109547, and 10-111543.

8) Chemical Sensitization

The photosensitive silver halide grain in the invention is preferably chemically sensitized by sulfur sensitizing method, selenium sensitizing method or tellurium sensitizing method. As the compound used preferably for sulfur sensitizing method, selenium sensitizing method and tellurium sensitizing method, known compounds, for example, compounds described in JP-A No. 7-128768 can be used. Particularly, tellurium sensitization is preferred in the invention and compounds described in the literature cited in paragraph No. 0030 in JP-A No. 11-65021 and compounds shown by formulae (II), (III), and (IV) in JP-A No. 5-313284 are more preferred.

The photosensitive silver halide grain in the invention is preferably chemically sensitized by gold sensitizing method alone or in combination with the chalcogen sensitization described above. As the gold sensitizer, those having a pxidation number of gold of either +1 or +3 are preferred and those gold compounds used usually as the gold sensitizer are preferred. As typical examples, chloroauric acid, bromoauric acid, potassium chloroaurate, potassium bromoaurate, auric trichloride, potassium auric thiocyanate, potassium iodoaurate, tetracyanoauric acid, ammonium aurothiocyanate and pyridyl trichloro gold are preferred. Further, gold sensitizers described in U.S. Pat. No. 5,858,637 and JP-A No. 2002-278016 are also used preferably.

In the invention, chemical sensitization can be applied at any time so long as it is after grain formation and before coating and it can be applied, after desalting, (1) before spectral sensitization, (2) simultaneously with spectral sensitization, (3) after spectral sensitization and (4) just before coating.

The amount of sulfur, selenium and tellurium sensitizer used in the invention may vary depending on the silver halide grain used, the chemical ripening condition and the like and it is used by about 10⁻⁸ mol to 10⁻² mol, preferably, 10⁻⁷ mol to 10⁻³ mol per 1 mol of silver halide.

The addition amount of the gold sensitizer may vary depending on various conditions and it is generally about 10⁻⁷ mol to 10⁻³ mol and, more preferably, 10^{-1 6} mol to 5×10⁻⁴ mol relative to 1 mol of silver halide.

There is no particular restriction on the condition for the chemical sensitization in the invention and, appropriately, pH is 5 to 8, pAg is 6 to 11 and temperature is at 40° C. to 95° C.

In the silver halide emulsion used in the invention, a thiosulfonic acid compound may be added by the method shown in EP-A No. 293917.

A reductive compound is used preferably for the photosensitive silver halide grain in the invention. As the specific compound for the reduction sensitization, ascorbic acid or thiourea dioxide is preferred, as well as use of stannous chloride, aminoimino methane sulfonic acid, hydrazine compounds, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 7 or higher or pAg to 8.3 or lower for the emulsion, and it is also preferred to apply reduction sensitization by introducing a single addition portion of silver ions during grain formation.

9) Compound of which a 1-Electron Oxidized Member, Formed by a 1-Electron Oxidation, is Capable of Releasing 1 or More Electrons

The photothermographic material of the invention preferably includes a compound of which a 1-electron oxidized member, formed by a 1-electron oxidation, is capable of releasing 1 or more electrons. Such compound is employed either singly or in combination with various aforementioned chemical sensitizers and can provide an increase in the sensitivity of silver halide.

The compound a 1-electron oxidized member, formed by a 1-electron oxidation, of which is capable of releasing 1 or more electrons, to be included in the photothermographic material of the invention, is a compound selected from the following types 1 and 2.

Type 1

A compound of which a 1-electron oxidized member, formed by a 1-electron oxidation, is capable of causing an ensuing bond cleaving reaction thereby further releasing one or more electrons.

Type 2

A compound of which a 1-electron oxidized member, formed by a 1-electron oxidation, is capable, after an ensuing bond forming process, of further releasing one or more electrons.

Firstly, the compound of type 1 will be explained.

Examples of the compound of type 1, of which a 1-electron oxidized member, formed by a 1-electron oxidation, is capable of causing an ensuing bond cleaving reaction thereby further releasing one electron, include compounds described as “1-photon 2-electron sensitizer” or “deprotonation electron donating sensitizer” in JP-A No. 9-211769 (compounds PMT-1 to S-37 described in Tables E and F on pages 28 to 32), JP-A No. 9-211774, JP-A No. 11-95355 (compounds INV1-36), JP-T No. 2001-500996 (specific examples: compounds 1-74, 80-87, 92-122), U.S. Pat. Nos. 5,747,235 and 5,747,236, EP No. 786692A1 (specific examples: compounds INV1-35), EP No. 893732A1, U.S. Pat. Nos. 6,054,260 and 5,994,051. Preferred ranges of these compounds are the same as those described in the cited patents.

Also examples of the compound of type 1, of which a 1-electron oxidized member, formed by a 1-electron oxidation, is capable of causing an ensuing bond cleaving reaction thereby further releasing one or more electrons, include compounds represented by Formula (1) (same meaning as in a general formula (1) described in JP-A No. 2003-114487), by Formula (2) (same meaning as in a general formula (2) described in JP-A No. 2003-114487), by Formula (3) (same meaning as in the general formula (1) described in JP-A No. 2003-114488), by Formula (4) (same meaning as in the general formula (2) described in JP-A No. 2003-114488), by Formula (5) (same meaning as in a general formula (3) described in JP-A No. 2003-114487), by Formula (6) (same meaning as in the general formula (1) described in JP-A No. 2003-75950), by Formula (7) (same meaning as in the general formula (2) described in JP-A No. 2003-75950), by Formula (8) (same meaning as in the general formula (1) described in JP-A No. 2003-239943), and by Formula (9) (same meaning as in a general formula (3) described in JP-A No. 2003-245929) among compounds capable of causing a reaction represented by the chemical reaction formula (1) (same meaning as in a chemical reaction formula (1) described in JP-A No. 2003-245929). Preferable ranges of these compounds are the same as those described in the cited patents.

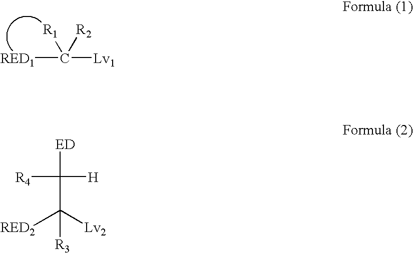

In Formulas (1) and (2), RED₁ and RED₂ each represents a reducing group; R₁ represents a non-metal atomic group capable of forming, together with a carbon atom (C) and RED₁, a cyclic structure corresponding to a tetrahydro member or a hexahydro member of a 5- or 6-membered aromatic ring (including an aromatic heterocycle); R₂, R₃ and R₄ each represents a hydrogen atom or a substituent; Lv₁ and Lv₂ each represents a releasable group; and ED represents an electron donating group.

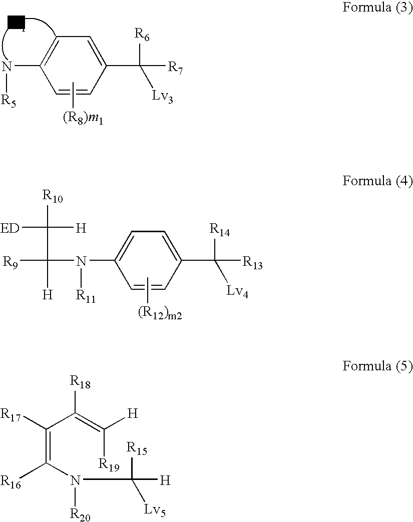

In Formulas (3), (4) and (5), Z₁ represents an atomic group capable of forming a 6-membered ring together with a nitrogen atom and two carbon atoms of a benzene ring; R₅, R₆, R₇, R₉, R₁₀, R₁₁, R₁₃, R₁₄, R₁₅, R₁₆, R₁₇, R₁₈ and R₁₉ each represents a hydrogen atom or a substituent; R₂₀ represents a hydrogen atom or a substituent, but, in the case R₂₀ represents a group other than an aryl group, R₁₆ and R₁₇ are mutually bonded to form an aromatic ring or an aromatic hetero ring; R₈ and R₁₂ each represents a substituent substitutable on the benzene ring; m1 represents an integer from 0 to 3; m2 represents an integer from 0 to 4; and Lv₃, Lv₄ and Lv₅ each represents a releasable group.

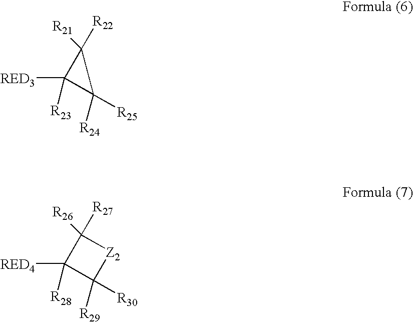

In Formulas (6) and (7), RED₃ and RED₄ each represents a reducing group; R₂₁ to R₃₀ each represents a hydrogen atom or a substituent; Z₂ represents —CR₁₁₁R₁₁₂—, —NR₁₁₃— or —O—; R₁₁₁ and R₁₁₂ each independently represent a hydrogen atom or a substituent; and R₁₁₃ represents a hydrogen atom, an alkyl group, an aryl group or a heterocyclic group.

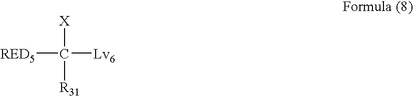

In Formula (8), RED₅ is a reducing group and represents an arylamino group or a heterocyclic amino group; R₃₁, represents a hydrogen atom or a substituent; X represents an alkoxy group, an aryloxy group, a heterocyclic oxy group, an alkylthio group, an arylthio group, a heterocyclic thio group, an alkylamino group, an arylamino group, or a heterocyclic amino group; Lv₆ is a releasable group and represents a carboxy group, a salt thereof or a hydrogen atom.

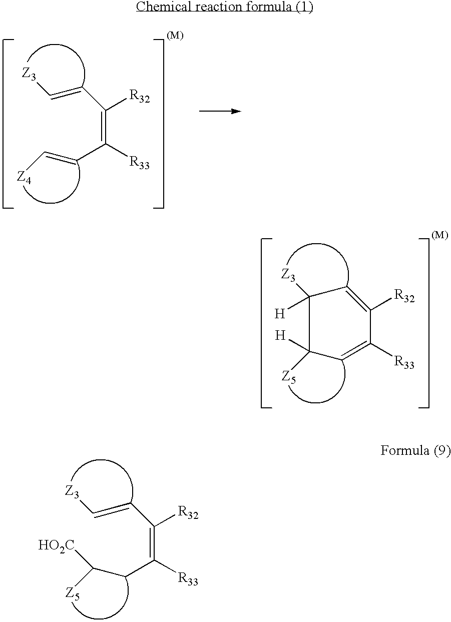

The compound represented by Formula (9) is a compound capable, after a 2-electron oxidation involving decarboxylation, of being further oxidized to causing a bond forming reaction represented by the chemical reaction formula (1). In the chemical reaction formula (1), R₃₂ and R₃₃ each represents a hydrogen atom or a substituent; Z₃ represents a group forming, together with C═C, a 5- or 6-membered hetero ring; Z₄ represents a group forming, together with C═C, a 5- or 6-membered aryl or heterocyclic group; and M represents a radical, a radical cation or a cation. In Formula (9), R₃₂, R₃₃ and Z₃ have the same meaning as those in the chemical reaction formula (1), and Z₅ represents a group forming, together with C—C, a 5- or 6-membered alicyclic hydrocarbon or heterocyclic group.

In the following, the compound of type 2 will be explained.

Examples of the compound of type 2, of which a 1-electron oxidized member, formed by a 1-electron oxidation, is capable of causing an ensuing bond forming reaction thereby further releasing one or more electrons, include compounds represented by Formula (10) (same meaning as in a general formula (1) described in JP-A No. 2003-140287), and by Formula (11) (same meaning as in a general formula (2) described in JP-A No. 2004-245929) among compounds capable of causing a reaction represented by the chemical reaction formula (1) (same meaning as in a chemical reaction formula (1) described in JP-A No. 2004-245929). Preferred ranges of these compounds are the same as those described in the cited patents.
RED₆-Q-Y Formula (10)

In Formula (10), RED₆ represents a reducing group to be subjected to a 1-electron oxidation; Y represents a reactive group including a carbon-carbon double bond site, a carbon-carbon triple bond site, an aromatic group site, or a non-aromatic heterocyclic site of a benzo condensed ring, capable of forming a new bond by reacting with a 1-electron oxidized member generated by a 1-electron oxidation of RED₆; and Q represents a connecting group for connecting RED₆ and Y.

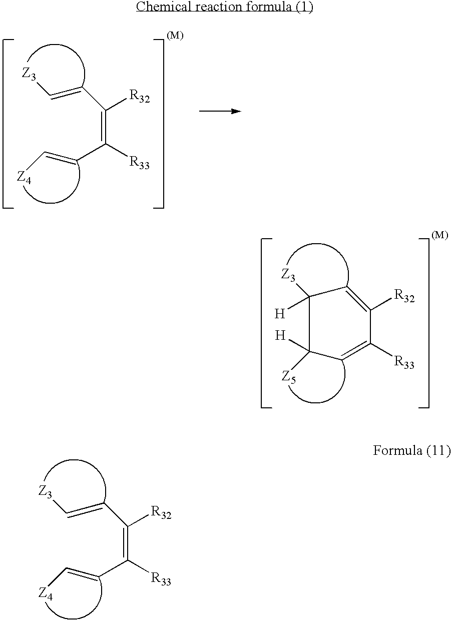

The compound represented by Formula (11) is a compound capable, upon being oxidized, of causing a bond forming reaction represented by the chemical reaction formula (1). In the chemical reaction formula (1), R₃₂ and R₃₃ each represents a hydrogen atom or a substituent; Z₃ represents a group forming, together with C═C, a 5- or 6-membered hetero ring; Z₄ represents a group capable of forming, together with C═C, a 5- or 6-membered aryl or heterocyclic group; Z₅ represents a group capable of forming, together with C—C, a 5- or 6-membered alicyclic hydrocarbon or heterocyclic group; and M represents a radical, a radical cation or a cation. In Formula (11), R₃₂, R₃₃, Z₃ and Z₄ have the same meaning as those in the chemical reaction formula (1).

Among the compounds of types 1 and 2, either “a compound having, within the molecule, a group adsorptive to silver halide” or “a compound having, within the molecule, a partial structure of a spectral sensitizing dye” is preferable. A group adsorptive to silver halide is represented by the group described in JP-A No. 2003-156823, page 16, right column, line 1 to page 17, right column, line 12. A partial structure of a spectral sensitizing dye is a structure described in the aforementioned patent, page 17, right column, line 34 to page 18, left column, line 6.

Among the compounds of types 1 and 2, “a compound having, within the molecule, at least a group adsorptive to silver halide” is more preferable. More preferably, it is “a compound having, within the molecule, two or more groups adsorptive to silver halide”. In the case two or more adsorptive groups are present within a same molecule, such adsorptive groups may be the same or different.

The adsorptive group is preferably a mercapto-substituted nitrogen-containing heterocyclic group (such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, or a 1,5-dimethyl-1,2,4-triazolium-3-thiolate group), or a nitrogen-containing heterocyclic group having an —NH— group capable of forming imino silver (>NAg) as a partial structure of the hetero ring (such as a benzotriazole group, a benzimidazole group, or an indazole group). It is particularly preferably a 5-mercaptotetrazole group, a 3-mercapto-1,2,4-triazole group, or a benzotriazole group, and most preferably a 3-mercapto-1,2,4-triazole group or a 5-mercaptotetrazole group.

As the adsorptive group, there is also preferred a case having two or more mercapto groups as a partial structure within the molecule. The mercapto group (—SH) may become a thion group in the case a tautomerism is possible. Preferred examples of the adsorptive group having two or more mercapto groups as a partial structure (such as dimercapto-substituted nitrogen-containing heterocyclic group) include a 2,4-dimercaptopyrimidine group, a 2,4-dimercaptotriazine group, and a 3,5-dimercapto-1,2,4-triazole group.

A quaternary salt structure of nitrogen or phosphor can also be advantageously employed as an adsorptive group. Specific examples of the quaternary salt structure of nitrogen include an ammonio group (such as a trialkylammonio group, a dialkylaryl (or heteroaryl) ammonio group, or an alkyldiaryl (or heteroaryl) ammonio group), or a group including a nitrogen-containing heterocyclic group containing a quaternary nitrogen atom. Examples of the quaternary salt structure of phosphor include a phosphonio group (such as a trialkylphosphonio group, a dialkylaryl (or heteroaryl) phosphonio group, an alkyldiaryl (or heteroaryl) phosphonio group, or a triaryl (or heteroaryl) phosphonio group). There is more preferably employed a quaternary salt structure of nitrogen, further preferably a 5- or 6-membered nitrogen-containing aromatic heterocyclic group including a quaternarized nitrogen atom. Particularly preferably a pyridinio group, a quinolinio group or an isoquinolinio group. Such nitrogen-containing aromatic heterocyclic group including a quaternarized nitrogen atom may arbitrarily have a substituent.

Examples of a counter anion for the quaternary salt include a halogen ion, a carboxylate ion, a sulfonate ion, a sulfate ion, a perchlorate ion, a carbonate ion, a nitrate ion, a BF₄ ion, a PF₆ ion and a Ph₄B ion. In the case a group having a negative charge such as a carboxylate group is present in the molecule, an intramolecular salt may be formed with such group. As a counter anion not present within the molecule there is particularly preferred a chloro ion, a bromo ion or a methanesulfonate ion.

Preferably, the compound of type 1 or 2 having a quaternary salt structure of nitrogen or phosphor as the adsorptive group have a structure represented by Formula (X).
(P—Q₁—)ᵢ—R(—Q₂—S)ⱼ Formula (X)

In Formula (X), P and R each independently represent a quaternary salt structure of nitrogen or phosphor not constituting a partial structure of a sensitizing dye; Q₁ and Q₂ each independently represent a connecting group, more specifically a single bond, an alkylene group, an arylene group, a heterocyclic group, —O—, —S—, —NR_{N}—, —C(═O)—, —SO₂—, —SO—, or —P(═O)—, either singly or a combination of these groups; RN represents a hydrogen atom, an alkyl group, an aryl group, or a heterocyclic group; S represents a residue formed by eliminating an atom from a compound represented by type (1) or (2); i and j represent integers of 1 or more, which are selected within a range that i+j is from 2 to 6, preferably i is 1 to 3 and j is 1 to 2, more preferably i is 1 or 2 and j is 1, and particularly preferably i is 1 and j is 1. The compound represented by Formula (X) preferably has a total number of carbon atoms of 10 to 100, more preferably 10 to 70, further preferably 11 to 60 and particularly preferably 12 to 50.

The compound of types 1 and 2 of the invention may be used in any stage in a preparation of an emulsion in a producing process of the photosensitive material. For example, it may be used in a formation of photosensitive silver halide grains, in a desalting step, at a chemical sensitization or before coating. It may also be added in a divided manner in plural times in these steps. A timing of addition is preferably within a period from the end of the formation of photosensitive silver halide grains to the start of a desalting step, or at a chemical sensitization (from immediately before the start of chemical sensitization to immediately after the end of chemical sensitization), or prior to a coating, and more preferably within a period from the chemical sensitization to the time before mixing with the non-photosensitive organic silver halide salt.

The compound of types 1 and 2 of the invention is added preferably by dissolving in water, a water-soluble solvent such as methanol or ethanol, or a mixture thereof. In the case of dissolving in water, a compound showing a higher solubility at a higher pH may be dissolved at a higher pH. In the case of dissolving in water, a compound showing a lowher solubility at a higher pH may be dissolved at a lower pH.

The compound of types 1 and 2 of the invention is preferably used in an image forming layer which contains the photosensitive silver halide and the non-photosensitive organic silver halide salt. It may be added in a protective layer or an intermediate layer in addition to the image forming layer, and may be diffused at the coating. These compounds may be added before or after an addition of a sensitizing dye, and is included in the silver halide emulsion layer (image forming layer) in an amount of 1×10⁻⁹ to 5×10⁻¹ moles per 1 mole of silver halide, more preferably 1×10⁻⁸ to 5×10⁻² moles.

10) Adsorptive Redox Compound Having Adsorptive Group and Reducing Group

In the invention, there is preferably included an adsorptive redox compound having an adsorptive group to silver halide and a reducing group within a molecule. Such adsorptive redox compound is preferably represented by the following Formula (I).
A—(W)ₙ-B Formula (I)

In Formula (I), A represents a group adsorptive to silver halide (hereinafter called adsorptive group); W represents a divalent connecting group; n represents 0 or 1; and B represents a reducing group.

In Formula (1), the absorbable group represented by A means a group directly adsorptive to silver halide or a group capable of accelerating an adsorption to silver halide, and is specifically a mercapto group (or a salt thereof), a thion group (—C(═S)—), a heterocyclic group containing at least an atom selected from a nitrogen atom, a sulfur atom, a selenium atom and a tellurium atom, a sulfide group, a disulfide group, a cationic group, or an ethinyl group.

A mercapto group (or a salt thereof) as the adsorptive group means not only a mercapto group (or a salt thereof) itself but also, more preferably, a heterocyclic group, an aryl group or an alkyl group substituted with at least a mercapto group (or a salt thereof). The heterocyclic group is a 5- to 7-membered, single-ringed or condensed-ringed, aromatic or non-aromatic heterocyclic group such as an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group or a triazine ring group. It can also be a heterocyclic group including a quaternary nitrogen atom, and, in such case, a substituted mercapto group may be dissociated to form a meso ion. In the case the mercapto group forms a salt, a counter ion can be a cation of an alkali metal, an alkali earth metal or a heavy metal (Li⁺, Na⁺, K⁺, Mg²⁺, Ag⁺, Zn²⁺, etc.), an ammonium ion, a heterocyclic group containing a quaternary nitrogen atom, or a phosphonium ion.

The mercapto group as the adsorptive group may also become a thion group by a tautomerism.

The thion group as the adsorptive group also includes a linear or cyclic thioamide group, a thioureido group, a thiourethane group, or a dithiocarbamate ester group.

The heterocyclic group containing at least an atom selected from a nitrogen atom, a sulfur atom, a selenium atom and a tellurium atom, as the adsorptive group, is a nitrogen-containing heterocyclic group having an —NH— group capable of forming an imino silver (>NAg) as a partial structure of the hetero ring, or a heterocyclic group having —S—, —Se—, —Te— or ═N— capable of coordinating with a silver ion by a coordinate bond as a partial structure of the hetero ring. Examples of the former include a benzotriazole group, a triazole group, an indazole group, a pyrrazole group, a tetrazole group, a benzimidazole group, an imidazole group and a purine group, while examples of the latter include a thiophene group, a thiazole group, an oxazole group, a benzothiophene group, a benzothiazole group, a benzoxazole group, a thiadiazole group, an oxadiazole group, a triazine group, a selenoazole group, a benzselenoazole group, a tellurazole group and a benztellurazole group.

A sulfide group or a disulfide group as the adsorptive group can be any group having an —S— or —S—S-partial structure.

A cationic group as the adsorptive group means a group containing a quaternary nitrogen atom, and specifically includes an ammonio group or a nitrogen-containing heterocyclic group containing a quaternary nitrogen atom. A nitrogen-containing heterocyclic group including a quaternary nitrogen atom can be, for example, pyridinio group, quinolinio group, isoquinolinio group or imiazolio group.

An ethinyl group as the adsorptive group means —C≡CH, in which the hydrogen atom may be substituted.

Such adsorptive group mentioned in the foregoing may arbitrarily have a substituent.

Specific examples of the adsorptive group also include those described in JP-A No. 11-95355, pages 4 to 7.

In Formula (I), the adsorptive group represented by A is preferably a mercapto-substituted heterocyclic group (such as a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, 2,4-dimercaptopyrimidine group, 2,4-dimercaptotriazine group, 3,5-dimercapto-1,2,4-triazole group or 2,5-dimercapto-1,3-thiazole group), or a nitrogen-containing heterocyclic group having an —NH— group capable of forming imino silver (>NAg) as a partial structure of the hetero ring (such as a benzotriazole group, a benzimidazole group, or an indazole group). It is further preferably a 2-mercaptobenzimidazole group, or a 3,5-dimercapto-1,2,4-triazole group.

In Formula (I), W represents a divalent connecting group. Such connecting group can be of any type, as long as it does not detrimentally affect the photographic properties. For example, there can be utilized a divalent connecting group constituted of a carbon atom, a hydrogen atom, an oxygen atom, a nitrogen atom, and a sulfur atom. Specific examples include an alkylene group having 1 to 20 carbon atoms (such as methylene group, ethylene group, trimethylene group, tetramethylene group, or hexamethylene group), an alkenylene group having 2 to 20 carbon atoms, an alkinylene group having 2 to 20 carbon atoms, an arylene group having 6 to 20 carbon atoms (such as phenylene group or naphthylene group), —CO—, —SO₂—, —O—, —S—, —NR₁— and a combination thereof, wherein R₁ represents a hydrogen atom, an alkyl group, a heterocyclic group or an aryl group.

The connecting group represented by W may arbitrarily have a substituent.

In Formula (I), the reducing group represented by B represents a group capable of reducing silver ion, for example a triple bond group such as a formyl group, an amino group, an acetylene group or a propalgyl group, a mercapto group, or a residue obtained by eliminating a hydrogen atom from a hydroxylamine, a hydroxamic acid, a hydroxyurea, a hydroxyurethane, a hydroxysemicarbazide, a reductone (including a reductone compound), an aniline, a phenol (including a chroman-6-ol, 2,3-dihydrobenzofuran-5-ol, an aminophenol, a sulfonamidephenol, and a polyphenol such as hydroquinone, cathecol, resorcinol, benzenetriol or bisphenol), an acilhydrazine, a carbamoylhydrazine, or 3-pyrazolidone. These may arbitrarily have a substituent.

In Formula (I), an oxidation potential of the reducing group represented by B can be measured by a measuring method described in Akira Fujishima, “Denki Kagaku Sokuteiho (electrochemical measuring method)” (pp. 150-208, published by Gihodo) and “Jikken Kagaku Koza”, edited by Chemical Society of Japan, 4th ed. (vol. 9, pp. 282-344, Maruzen). The measurement can be executed, for example, by a rotary disk voltammetry method, by dissolving a sample in a solution of methanol: pH 6.5 Britton-Robinson buffer=10%:90% (vol. %), passing nitrogen gas for 10 minutes, and executing a measurement with a sweeping rate of 20 mV/sec at 25° C. and 1000 rpm, utilizing a glassy carbon rotary disk electrode (RDE) as an operating electrode, a platinum wire as a counter electrode and a saturated calomel electrode as a reference electrode. A half-peak potential (E1/2) can be determined from an obtained voltammogram.

The reducing group represented by B of the invention, in the measurement with the aforementioned method, preferably has an oxidation potential within a range from about −0.3 to 1.0 V, more preferably about −0.1 to 0.8 V, and particularly preferably about 0 to 0.7 V.

In Formula (I), the reducing group represented by B is preferably a residue obtained by eliminating a hydrogen atom from a hydroxylamine, a hydroxamic acid, a hydroxyurea, a hydroxysemicarbazide, a reductone, a phenol, an acylhydrazine, a carbamoylhydrazine, or a 3-pyrazolidone.

The compound of Formula (I) of the invention may incorporate a ballast group or a polymer chain, which is generally employed in an immobile photographic additive such as a coupler. Further, examples of the polymer include those described in JP-A No. 1-100530.

The compound of Formula (I) of the invention may also be a bis or tris member. The compound of Formula (I) of the invention preferably has a molecular weight within a range of 100 to 10,000, more preferably 120 to 1,000 and particularly preferably 150 to 500.

In the following, examples of the compound of Formula (I) of the invention will be shown, but the present invention is not limited to these examples.

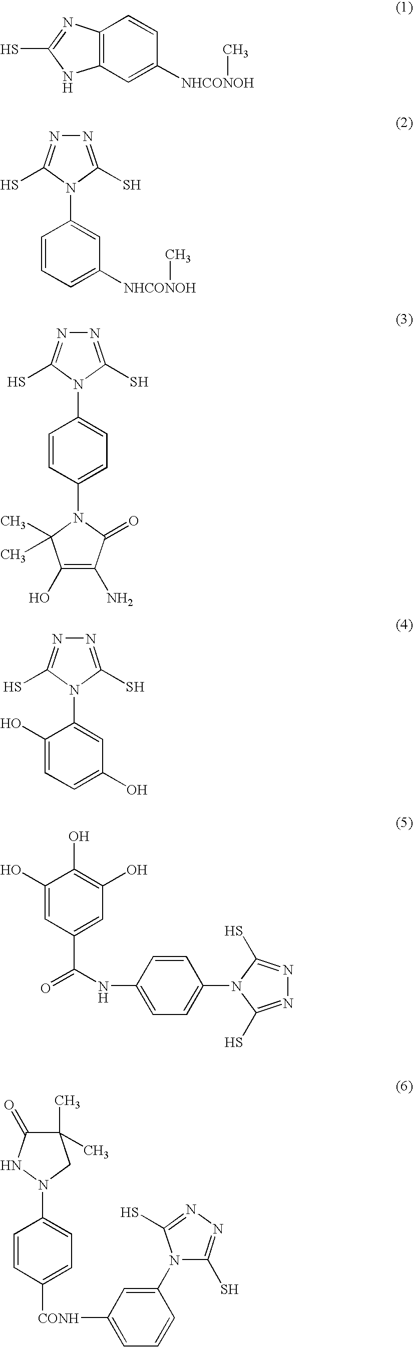

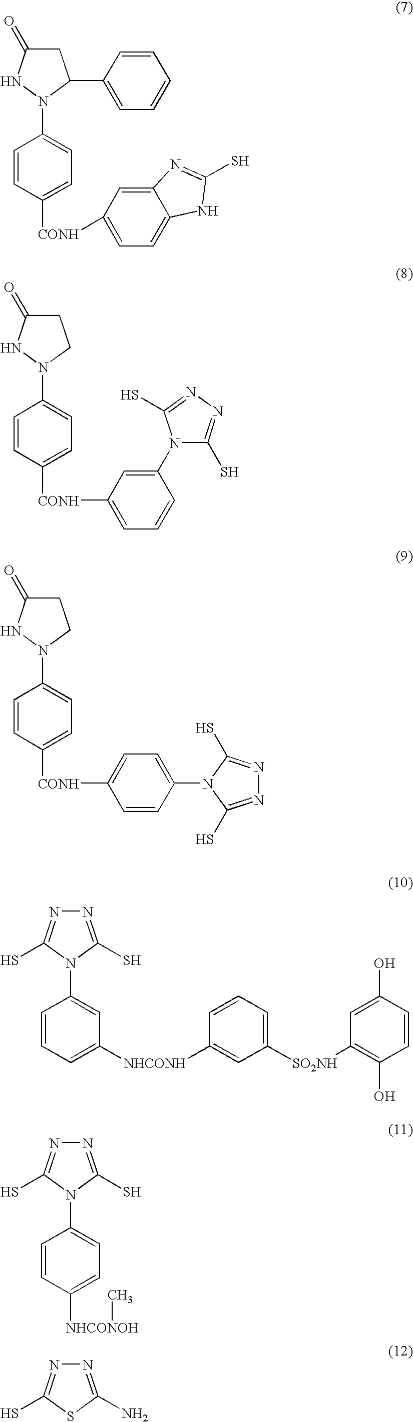

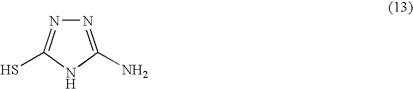

Further, specific compounds 1 to 30 and 1″-1 to 1″-77, described in EP No. 1308776A2, pages 73 to 87, can be included in preferable examples of the compound having the adsorptive group and the reducing group in the invention.

These compounds can be easily synthesized by a known method. The compound of Formula (I) of the invention may be employed singly, but it is also preferable to use two or more compounds at the same time. In the case of employing two or more compounds, they may be added in a same layer or in different layers, and may be used in different adding methods.

The compound of Formula (I) of the invention is preferably added in a silver halide emulsion layer (image formung layer), and is more preferably added at the preparation of the emulsion. In the case of addition at the preparation of the emulsion, the addition may be made in any step of the preparation process, for example in a step of forming silver halide grains, before the start of a desalting step, in a desalting step, before the start of a chemical ripening, in a chemical ripening step, or a step prior to the preparation of a final emulsion. It may also be added in divided manner in plural times in these steps. It is preferably added to the image forming layer, but it may also be added, in addition to the image forming layer, in a protective layer or an intermediate layer adjacent thereto and may be diffused at the coating.

A preferable amount of addition is variable significantly depending on the aforementioned method of addition and the kind of the compound to be added, however it is generally 1×10⁻⁶ to 1 mole per 1 mole of photosensitive silver halide, preferably 1×10⁻⁵ to 5×10⁻¹ moles and further preferably 1×10⁻⁴ to 1×10⁻¹ moles.

The compound of Formula (I) of the invention may be added by dissolving in water, a water-soluble solvent such as methanol or ethanol, or a mixture thereof. In such case, a pH adjustment may be executed with an acid or an alkali, and a surfactant may also be made present. It may also be added in a state of an emulsified dispersion by dissolving in a high-boiling organic solvent. It may also be added as a solid dispersion.

11) Combined Use of Plural Silver Halides

A photosensitive silver halide emulsion to be used in the photosensitive material of the invention may be formed by a single type, or by a combination of two or more types (for example types different in an average grain size, in a halogen composition, in a crystallizing tendency, or in chemical sensitizing conditions). A gradation may be regulated by employing photosensitive silver halides of plural types of different sensitivities. Technologies relating thereto are described for example in JP-A Nos. 57-119341, 53-106125, 47-3929, 48-55730, 46-5187, 50-73627 and 57-150841. As to a difference in sensitivity, there is preferred a difference of 0.2 logE or larger between the emulsions.

12) Coating Amount

An addition amount of the photosensitive silver halide, in terms of a coated silver amount per 1 m² of the photosensitive material, is preferably 0.03 to 0.6 g/m², more preferably 0.05 to 0.4 g/m², and most preferably 0.07 to 0.3 g/m². With respect to 1 mole of organic silver salt, the photosensitive silver halide is preferably present within a range of 0.01 to 0.5 moles, more preferably 0.02 to 0.3 moles and further preferably 0.03 to 0.2 moles.

13) Mixing of Photosensitive Silver Halide and Organic Silver Salt

There is no particular limitation for a method and a condition of a method of mixing the photosensitive silver halide and the organic silver salt, and any method such as a method of mixing the photosensitive silver halide and the organic silver salt, each of which is separately prepared, by a high-speed agitator, a ball mill, a sand mill, a colloid mill, a vibrating mill, a homogenizer, etc., a method of preparing the organic silver salt by mixing an already prepared silver halide at any timing in the course of preparation of the organic silver salt thereby preparing the organic silver salt, or the like may be employed as long as the effect of the invention is sufficiently expressed. In view of controlling a pgotographic property, it is preferable to mix two or more kinds of aqueous organic silver salt dispersants and two or more kinds of aqueous photosensitive silver halide salt dispersants.

14) Mixing of Silver Halide to Coating Liquid

A preferred timing of addition of the silver halide of the invention to a coating liquid for forming an image forming layer is in a period from 180 minutes before coating to immediately before coating, preferably from 60 minutes to 10 seconds before coating, however a mixing method and a mixing condition are not particularly restricted as long as the effect of the invention can be sufficiently exhibited. Specific examples of the mixing method include a mixing method in a tank, so as to obtain a desired average stay time calculated from a flow rate of addition and a liquid supply rate to a coater, and a method using a static mixer described for example in N. Hamby, M. F. Edwards and A. W. Nienow, “Liquid mixing technology”, translated by Koji Takahashi and published by Nikkan Kogyo Shimbun, 1989, Chapter 8.

Antifogging Agent

An antifogging agent, a stabilizer and a stabilizer precursor employable in the invention can be compounds described in JP-A No. 10-62899, paragraph 0070, EP-A No. 0803764A1, page 20, line 57 to page 21, line 7, JP-A Nos. 9-281637 and 9-329864, U.S. Pat. No. 6,083,681, and European Patent No. 1048975.

In the following an organic polyhalogen compound preferable in the invention will be explained in detail. A polyhalogen compound preferred in the invention is represented by the following Formula (H).
Q-(Y)ₙ—C(Z₁)(Z₂)X Formula (H)

In Formula (H), Q represents an alkyl group, an aryl group or a heterocyclic group; Y represents a divalent connecting group; n represents 0 or 1; Z₁ and Z₂ each represents a halogen atom; and X represents a hydrogen atom or an electron-attracting group.

In Formula (H), Q is preferably an aryl group having 1 to 6 carbon atoms or a heterocyclic group having 6 to 12 carbon atoms or at least one nitrogen atom such as pyridine or qunoline.

In the case Q is an aryl group in Formula (H), Q preferably represents a phenyl group substituted with an electron-attracting group of which a Hammett's substituent constant σp assumes a positive value. As to the Hammett's substituent constant, reference may be made for example to Journal of Medicinal Chemistry, 1973, Vol. 16, No. 11, 1207-1216. Such electron-attracting group can be, for example, a halogen atom, an alkyl group having an electron-attracting group as a substituent, an aryl group having an electron-attracting group as a substituent, a heterocyclic group, an alkylsulfonyl group, an arylsulfonyl group, an acyl group, an alkoxycarbonyl group, a carbamoyl group, a sulfamoyl group or the like. The electron-attracting group is particularly preferably a halogen atom, a carbamoyl group or an alkoxycarbonyl group, and most preferably a carbamoyl group.

X is preferably an electron-attracting group. Preferable examples thereof include a halogen atom, an aliphatic sulfonyl group, an aryl sulfonyl group, a heterocyclic sulfonyl group, an aliphatic acyl group, an aryl acyl group, a heterocyclic acyl group, an aliphatic oxycarbonyl group, an aryl oxycarbonyl group, a heterocyclic oxycarbonyl group, a carbamoyl group and a sulfamoyl group, more preferable examples thereof include a halogen atom and a carbamoyl group, and further preferable examples thereof include a bromine atom.

Each of Z₁ and Z₂ is preferably a bromine atom or an iodine atom, and more preferably a bromine atom.

Y preferably represents —C(═O)—, —SO—, —SO₂—, —C(═O)N(R)— or —SO₂ N(R)—, more preferably represents —C(═O)—, —SO₂— or —C(═O)N(R)—, and particularly preferably represents —SO₂— or —C(═O)N(R)—. The “R” herein represents a hydrogen atom, an aryl group or an alkyl group, more preferably represents a hydrogen atom or an alkyl group, and most preferably represents a hydrogen atom.

n represents 0 or 1, and preferably represents 1.

In Formula (H), in the case where Q is an alkyl group, Y is preferably —C(═O)N(R)—. In the case where Q is an aryl group or a heterocyclic group, Y is preferably —SO₂—.

In Formula (H), the form where the residues, that are obtained by removing a hydrogen atom from the compound, bind each other (generally called as a bis form, a tris form or a tetrakis form) is also preferably used.

In Formula (H), a form having a substituent of a dissociative group (for example, a COOH group or a salt thereof, a SO₃H group or a salt thereof, a PO₃H group or a salt thereof, and the like), a group containing a quaternary nitrogen cation (for example, an ammonium group, a pyridinium group, and the like), a polyethyleneoxy group, a hydroxy group, or the like is also preferable.

Specific examples of the compound represented by formula (H) of the invention are shown below.

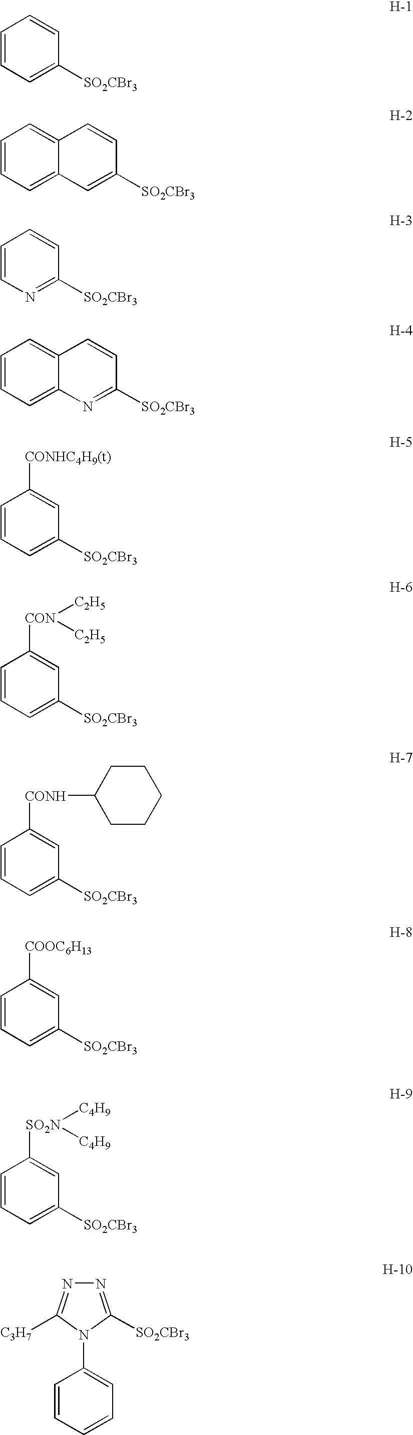

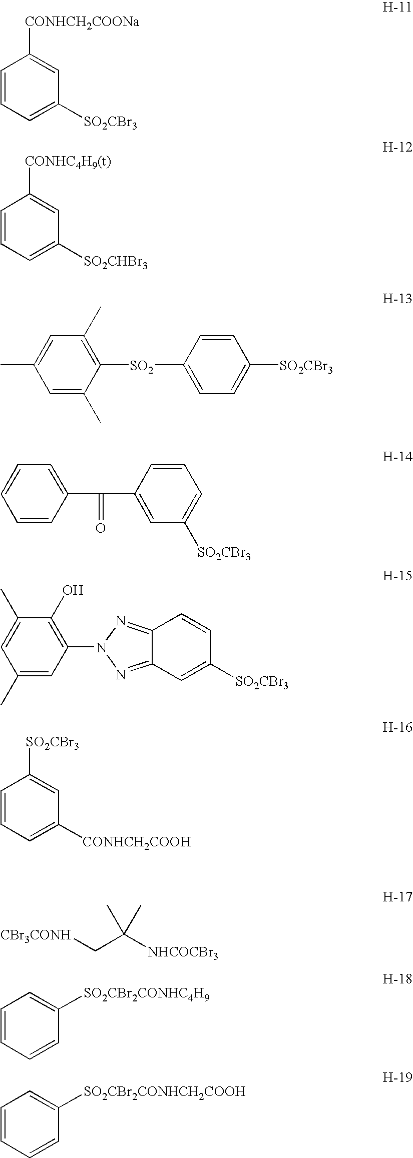

Preferable examples of the organic polyhalogen compounds employable in the invention other than those above further include those disclosed in U.S. Pat. Nos. 3,874,946, 4,756,999, 5,340,712, 5,369,000, 5,464,737, and 6,506,548, and JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441. Particularly, compounds disclosed in JP-A Nos. 7-2781, 2001-33911 and 2001-312027 are preferable.

The compounds represented by Formula (H) of the invention are preferably used in an amount from 10⁻⁴ mol to 1 mol, more preferably 10⁻³ mol to 0.5 mol, and further preferably 1×10⁻² mol to 0.2 mol, per 1 mol of non-photosensitive silver salt incorporated in the image forming layer.

In the invention, examples of a method for incorporating the antifoggant into the photothermographic material include those described as the method for incorporating the reducing agent, and it is similarly preferable for the organic polyhalogen compound to be added in the form of solid fine particle dispersion.

2) Other Antifoggants

Examples of the antifoggants other than those described above include a mercury (II) salt described in paragraph number 0113 of JP-A No. 11-65021, benzoic acids described in paragraph number 0114 of the same literature, a salicylic acid compound described in JP-A No. 2000-206642, a formaline scavenger compound represented by formula (S) in JP-A No. 2000-221634, a triazine compound related to Claim 9 of JP-A No. 11-352624, a compound expressed by general formula (III), 4-hydroxy-6-methyl-1,3,3a, 7-tetrazaindene and the like, as described in JP-A No. 6-11791.

The photothermographic material of the invention may further contain an azolium salt in order to prevent fogging. As azolium salts, there can be mentioned a compound represented by formula (XI) as described in JP-A No. 59-193447, a compound described in JP-B No. 55-12581, and a compound represented by formula (II) in JP-A No. 60-153039. The azolium salt may be added to any part of the photothermographic material, but as the addition layer, preferred is to select a layer on the side having thereon the image forming layer, and more preferred is to select the image forming layer. The azolium salt may be added at any time of the process of preparing the coating liquid; in the case where the azolium salt is added into the layer containing the organic silver salt, any time of the process may be selected, from the preparation of the organic silver salt to the preparation of the coating liquid, and preferred is to add the salt after preparing the organic silver salt and just before the coating. The azolium salt may be added by any method and examples thereof include those using a powder, a solution or a fine-particle dispersion, and the like. Furthermore, it may be added as a solution having mixed therein other additives such as sensitizing agents, reducing agents, toners, and the like. In the invention, the azolium salt may be added at any amount, and preferable amount thereof is in a range from 1×10⁻⁶ mol to 2 mol, and more preferably from 1×10⁻⁶ mol to 0.5 mol per 1 mol of silver.

Other Additives

1) Mercapto Compounds, Disulfides and Thiones

In the invention, mercapto compounds, disulfide compounds, and thione compounds may be added in view of controlling a development process by suppressing or enhancing thereof, improving a spectral sensitizing efficiency, improving storage properties before and after development and the like. Examples thereof include those described in paragraph Nos. 0067 to 0069 of JP-A No. 10-62899, a compound represented by formula (I) of JP-A No. 10-186572 and specific examples thereof shown in paragraph Nos. 0033 to 0052 therein, those described in lines 36 to 56 in page 20 of EP-A No. 0803764A1 and the like. Among them, mercapto-substituted heterocyclic aromatic compounds, which are described in JP-A Nos. 9-297367, 9-304875, 2001-100358, 2002-303954, 2002-303951 and the like, are particularly preferable.

2) Color Toning Agent

A color toning agent is preferably added to the photothermographic material of the present invention. Examples of the color toning agent include those described in JP-A No.10-62899 (paragraph Nos. 0054 to 0055), EP-A No.0803764A1 (page 21, lines 23 to 48), and JP-A Nos.2000-356317 and 2000-187298. Preferable examples thereof include phthalazinones (phthalazinone, phthalazinone compounds and metal salts thereof, e.g., 4-(1-naphthyl)phthalazinone,6-chlorophthalazinone, 5,7-dimethoxyphthalazinone and 2,3-dihydro-1,4-phthalazinedione); combinations of phthalazinones and phthalic acids(e.g., phthalic acid, 4-methylphthalic acid, 4-nitrophthalic acid, diammonium phthalate, sodium phthalate, potassium phthalate and tetrachlorophthalic anhydride); phthalazines(phthalazine, phthalazine compounds and metal salts thereof, e.g., 4-(1-naphthyl)phthalazine, 6-isopropylphthalazine, 6-ter-butylphthalazine, 6-chlorophthalazine, 5,7-dimethoxyphthalazine and 2,3-dihydrophthalazine); combinations of phthalazines and phthalic acids, and the like. Particularly preferred is a combination of phthalazines and phthalic acids. Among them, particularly preferable are a combination of 6-isopropylphthalazine and phthalic acid, and a combination of 6-isopropylphthalazine and 4-methylphthalic acid.

3) Dyes and Pigments

From the viewpoint of improving color tone, preventing a generation of interference fringes on laser exposure and preventing irradiation, various dyes and pigments (such as C.I. Pigment Blue 60, C.I. Pigment Blue 64, C.I. Pigment Blue 15:6 or the like) may be used. Detailed description can be found in WO No. 98/36322, JP-A Nos. 10-268465 and 11-338098, and the like.

4) Nucleator

A nucleator is preferably added to the image forming layer of the photothermographic material of the invention. Details on the nucleators, methods of addition and an addition amount thereof can be found in paragraph No. 0118, paragraph Nos. 0136 to 0193 of JP-A No. 11-223898, as compounds represented by formulae (H), (1) to (3), (A), and (B) in JP-A No. 2000-284399; as for a nucleation accelerator, description can be found in paragraph No. 0102 of JP-A No. 11-65021, and in paragraph Nos. 0194 to 0195 of JP-A No. 11-223898.

In the case of using formic acid or formates as a strong fogging agent, it is preferably incorporated into a side having thereon the image forming layer containing photosensitive silver halide at an amount of 5 mmol or less per 1 mol of silver, and preferably 1 mmol or less per 1 mol of silver.

When a nuleator is used in the photothermographic material of the invention, it is preferable to additionally use an acid which results from hydration of diphosphorus pentaoxide or a salt of the acid. Examples of the acid resulting from the hydration of diphosphorus pentaoxide or salts thereof include a metaphosphoric acid (salt), a pyrophosphoric acid (salt), an orthophosphoric acid (salt), a triphosphoric acid (salt), a tetraphosphoric acid (salt), a hexametaphosphoric acid (salt) and the like. Particularly preferable acids obtainable by the hydration of diphosphorus pentaoxide or salts thereof include an orthophosphoric acid (salt) and a hexametaphosphoric acid (salt). Specific examples of the salt include sodium orthophosphate, sodium dihydrogen orthophosphate, sodium hexametaphosphate, ammonium hexametaphosphate and the like.

An addition amount of the acid obtained by hydration of diphoshorus pentaoxide or the salt thereof (i.e., a coating amount of the acid or the salt per 1 m² of the photothermographic material) may be set as desired depending on sensitivity and fogging, and is preferably an amount in a range of 0.1 mg/m² to 500 mg/m², and more preferably in a range of 0.5 mg/m² to 100 mg/m².

Preparation of Coating liquid and Coating

A temperature for preparing the coating liquid for the image forming layer of the invention is preferably in a range of 30° C. to 65° C., more preferably 35° C. or more to less than 60° C., and further preferably in a range of 35° C. to 55° C. Furthermore, the temperature of the coating liquid for the image forming layer immediately after adding the polymer latex is preferably maintained in a range of 30° C. to 65° C.

Layer Structure and Components of Layers

The photothermographic material of the invention preferably has a layer structure in which the image forming layer and the non-photosensitive intermediate layer are in adjacent with each other. It is also preferable that the photothermographic material of the invention further has a layer structure in which a non-photosensitive intermediate layer B is provided between the non-photosensitive intermediate layer and an outermost layer.

In view of coatability, at least one of the outermost layer and the non-photosensitive intermediate layer B contains a hydrophilic polymer that derives from an animal protein (animal protein-derived hydrophilic polymer).

1) Non-Photosensitive Intermediate Layer B

As is described above, the photothermographic material of the invention may have a layer structure in which a non-photosensitive intermediate layer B is provided between the non-photosensitive intermediate layer and an outermost layer. It is preferable that at least one of the outermost layer and the non-photosensitive intermediate layer B contains 50% by mass or more of a hydrophilic polymer relative to a total amount of the binder contained in the non-photosensitive intermediate layer B. It is more preferable that at least one of the outermost layer and the non-photosensitive intermediate layer B contains 60 to 100% by mass or more of a hydrophilic polymer relative to a total amount of the binder contained in the non-photosensitive intermediate layer B.

In the invention, the hydrophilic polymer for the non-photosensitive intermediate layer B is preferably an animal protein-derived hydrophilic polymer. The animal protein-derived hydrophilic polymer is natural or chemically modified water-soluble polymer such as glue, casein, gelatin, or albumen. The hydrophilic polymer is preferably gelatin, and both acid- and alkali-treated gelatins (e.g., lime-treated gelatin), which are classified according to its production method, may be used preferably. The gelatin preferably has a molecular weight of 10,000 to 1,000,000. The hydrophilic polymer may also be other modified gelatin (e.g., phthalated gelatin) modified using amino or carboxyl groups. The gelatin can be inert gelatin (e.g., NITTA GELATIN 750 (trade name, manufactured by Nitta Gelatin Inc.)), and/or phthalated gelatin (e.g., NITTA GELATIN 801 (trade name, manufactured by Nitta Gelatin Inc.)).

An aqueous gelatin solution solates at a temperature of 30° C. or higher, and gels and loses liquidity at a temperature of less than 30° C. The sol-gel transition occurs reversibly depending on temperature, and the aqueous gelatin solution serving as a coating liquid has a setting property of losing liquidity when cooled down to a temperature of lower than 30° C.

In addition, the photothermographic material may further contain a non-animal protein-derived hydrophilic or hydrophobic polymer described below in addition to the animal protein-derived hydrophilic polymer.

The non-photosensitive intermediate layer B may further contain a cross-linking agent, a surfactant, a pH adjusting agent, an antiseptic, a fungicide, a dye, a pigment, and/or a color tone adjusting agent.

Examples of the hydrophilic polymer which is not animal protein-derived and is usable in the invention include natural polymers other than animal protein (e.g., gelatin) such as polysaccharides, microorganism-derived polymers, and animal-derived polymers; semisynthetic polymer such as cellulose, starch, and alginic acid; and synthetic polymers such as vinyl resins and polyvinyl alcohol. The natural and semisynthetic polymers include those whose raw materials include vegetable-derived cellulose. The non-animal protein-derived hydrophilic polymer is preferably polyvinyl alcohol and/or acrylic acid-vinylalcohol copolymer.

The non-animal protein-derived hydrophilic polymer does not have a setting property, but, when used with a gelling agent, can acquire a setting property, improving coating properties.

The hydrophobic polymer is preferably dispersible in an aqueous solvent.

Typical examples of the polymer dispersible in an aqueous solvent include synthetic resins, polymers and copolymers, and film-forming media such as cellulose acetates, cellulose acetate butyrates, polymethylmethacrylic acids, polyvinyl chlorides, polymethacrylic acids, styrene-maleic anhydride copolymers, styrene-acrylonitrile copolymers, styrene-butadiene copolymers, polyvinyl acetals (e.g., polyvinylformal and polyvinylbutyral), polyesters, polyurethanes, phenoxy resins, polyvinylidene chlorides, polyepoxides, polycarbonates, polyvinyl acetates, polyolefins, cellulose esters, and polyamides.

4) Auxiliary Additive

The intermediate layers A and B and the outermost layer in the invention may contain various auxiliary additives in addition to the binder in accordance with neccesity.

Gelling Agent

The gelling agent in the invention is a substance that, when added to the non-animal protein-derived hydrophilic polymer or the aqueous hydrophobic polymer latex and cooled, causes gelation of the polymer or latex, or which, when added to the polymer or latex together with a gelation-accelerating substance, causes the gelation. The gelation results in a drastic decrease in liquidity.

The gelling agent may be a water-soluble polysaccharide, and specific examples thereof include agar, κ-carrageenan, τ-carrageenan, alginic acid, alginates, agarose, furcelleran, gellan gum, glucono delta lactone, azotobacter vinelandii gum, xanthan gum, pectin, guar gum, locust bean gum, tara gum, cassia gum, glucomannan, tragacanth gum, karaya gum, pullulan, arabic gum, arabinogalactan, dextran, carboxymethylcellulose sodium salt, methylcellulose, psyllium seed gum, starch, chitin, chitosan, and curdlan.

Examples of a substance which gelates when cooled after melting heating include agar, carrageenan, and gellan gum.

Among these, the gelling agent is more preferably κ-carrageenan (e.g., K-9F (trade name, manufactured by Mitsui Sugar Co., Ltd.), and K-15, K-21 to 24, or I-3 (trade names, manufactured by Nitta Gelatin Inc.), τ-carrageenan, or agar, and still more preferably κ-carrageenan.

The content of the gelling agent used is preferably 0.01 to 10.0 mass %, more preferably 0.02 to 5.0 mass %, and still more preferably 0.05 to 2.0 mass %, with respect to the binder polymer.

Gelation Accelerator

The gelling agent is preferably used in combination with a gelation accelerator. The gelation accelerator used in the invention is a substance which, when brought into contact with a gelling agent, accelerates gelation. A specific combination of the gelling agent and the gelation accelerator exhibits such function. Examples of the combinations of the gelling agent and the gelation accelerator usable in the invention include the following ones:

Combination of: an alkali metal ion such as a potassium ion, or an alkaline earth metal ion such as a calcium ion or magnesium ion serving as a gelation accelerator; and, as a gelling agent, carrageenan, alginates, gellan gum, azotobacter vinelandii gum, pectin, or carboxymethylcellulose sodium salt

Combination of: a boron compound such as boric acid as a gelling accelerator; and gum such as guar gum, locust bean gum, tara gum, or cassia gum as a gelling agent

Combination of: an acid or alkali as a gelling accelerator; and alginate, glucomannan, pectin, chitin, chitosan, or curdlan as a gelling agent

Combination of: a gelling agent; and, as a gelation accelerator, water-soluble polysaccharide capable of reacting with the gelling agent to form gel. Specific examples thereof include a combination of xanthan gum as a gelling agent and cassia gum as a gelation accelerator, and a combination of carrageenan as a gelling agent and locust bean gum as a gelation accelerator.

Specific examples of the combination of the gelling agent and the gelation accelerator include the followings.

a) Combination of κ-carrageenan and potassium;

b) Combination of τ-carrageenan and calcium;

c) Combination of low methoxyl pectin and calcium;

d) Combination of sodium alginate and calcium;

e) Ccombination of gellan gum and calcium;

f) Combination of gellan gum and acid; and

g) Combination of locust bean gum and xanthan gum.

Prulal of the above combinations may be simultaneously used.

The gelation accelerator and the gelling agent are preferably contained in different layers, though they may be contained in the same layer. The gelation accelerator is more preferably contained in a layer which is not in contact with a layer containing the gelling agent. That is, it is more preferable that a layer free from both of the gelling agent and the gelation accelerator is disposed between the layer containing the gelling agent and the layer containing the gelation accelerator.

The gelling accelerator is preferably used in an amount of 0.1 to 200 mass %, and more preferably 1.0 to 100 mass % with respect to the gelling agent.

The intermediate layer and the outermost layer may further contain other additive, such as a surfactant, a pH adjusting agent, an antiseptic, a fungicide, a dye, a pigment, or a color tone adjusting agent, in accordance with necessity.

Filming Aid

A filming aid may be added to for an aqueous hydrophobic polymer dispersion to control the minimum filming temperature of the aqueous dispersion. The filming aid, which is also called plasticizer, is an organic compound (usually, an organic solvent) that lowers the minimum filming temperature of a polymer latex, and is described in, for example, Chemistry of Synthesis Latex written by Soichi Muroi, and published by Kobunshi Kankokai in 1970. Preferable examples of the filming aid are listed below, but the compounds for use in the invention are not limited to the following specific examples.

Z-1: Benzyl alcohol

Z-2:2,2,2,4-Tetramethylpentanediol-1,3-monoisobutyrate.

Z-3:2-Dimethylaminoethanol

Z-4: Diethylene glycol

Cross-Linking Agent

In the invention, a cross-linking agent is preferably contained in any of layers provided on a surface of a support on which surface an image-forming layer is provided. It is more preferably contained in a hydrophilic polymer containing-layer(s) such as the non-photosensitive intermediate layer B. Inclusion of the cross-linking agent results in increased hydrophobic property and water resistance of the non-photosensitive intermediate layer, giving an excellent photothermographic material.

The cross-linking agent is not particularly limited as long as it has a plurality of groups which can react with an amino group and/or a carboxyl group in the molecule thereof. Some examples of the cross-linking agent are described in T. H. James, The Theory of the Photographic Process, Fourth Edition, Page 77 to 87 (Macmillan Publishing Co., Inc., 1977). Both of an inorganic cross-linking agent such as chromium alum and an organic cross-linking agent are preferable, and it is more preferable that the cross-linking agent is an organic cross-linking agent.

A hydrophobic-polymer containing layer such as the non-photosensitive intermediate layer A may include a cross-linking agent. In this case, the cross-linking agent is not particularly limited as long as it has a plurality of groups capable of reacting with a carboxyl group in the molecule thereof.

Specific preferable examples of the organic cross-linking agent include carboxylic acid compounds, carbamic acid compounds, sulfonic ester compounds, sulfonyl compounds, epoxy compounds, aziridine compounds, isocyanate compounds, carbodiimide compounds, and oxazoline compounds. The organic cross-linking agent is preferably an epoxy compound, an isocyanate compound, a carbodiimide compound, and/or an oxazoline compound. The cross-linking agent may be used singly or in combination of two or more.

Specific examples of the cross-linking agent are described below, but the invention is not limited by these examples.

Carbodiimide Compound

Water-soluble or water-dispersible carbodiimide compounds are preferable. Examples thereof include isophorone diisocyanate-derived polycarbodiimides described in JP-A No. 59-187029 and JP-B No. 5-27450; tetramethylxylylene diisocyanate-derived carbodiimide compounds described in JP-A No. 7-330849, multi-branched carbodiimide compounds described in JP-A No. 10-30024; and dicyclohexylmethane diisocyanate-derived carbodiimide compounds described in JP-A No. 2000-7642.

Oxazoline Compound

Water-soluble or water-dispersible oxazoline compounds are preferable, and examples thereof include oxazoline compounds described in JP-A No. 2001-215653.

Isocyanate Compound

Isocyanate compounds can react with water. Therefore, the isocyanate compounds which function as the crosslinking agents are preferably water-dispersible, and more preferably self-emulsifiable from the viewpoint of pot life. Specific examples thereof include water-dispersible isocyanate compounds described in JP-A Nos. 7-304841, 8-277315, 10-45866, 9-71720, 9-328654, 9-104814, 2000-194045, 2000-194237, and 2003-64149.

Epoxy Compound

Water-soluble or water-dispersible epoxy compounds are preferable, and specific examples thereof include water-dispersible epoxy compounds described in JP-A Nos. 6-329877 and 7-309954.

Specific examples of the cross-linking agent for use in the invention are listed below, but the invention is not limited by the following examples.

Epoxy Compound

Trade name:

DIC FINE EM-60 (manufactured by Dainippon Ink and Chemicals, Inc.)

Isocyanate compound

Trade names:

DURANATE WB40-100 (manufactured by Asahi Kasei Corporation)

DURANATE WB40-80D (manufactured by Asahi Kasei Corporation)

DURANATE WT20-100 (manufactured by Asahi Kasei Corporation)

DURANATE WT30-100 (manufactured by Asahi Kasei Corporation)

CR-60N (manufactured by Dainippon Ink and Chemicals, Inc.)

Carbodiimide compound

Trade names:

CARBODILITE V-02 (manufactured by Nisshinbo Industries, Inc.)

CARBODILITE V-02-L2 (manufactured by Nisshinbo Industries, Inc.)

CARBODILITE V-04 (manufactured by Nisshinbo Industries, Inc.)

CARBODILITE V-06 (manufactured by Nisshinbo Industries, Inc.)

CARBODILITE E-01 (manufactured by Nisshinbo Industries, Inc.)

CARBODILITE E-02 (manufactured by Nisshinbo Industries, Inc.)

Oxazoline compound

Trade names:

EPOCROS K-1010E (manufactured by Nippon Shokubai Co., Ltd.)

EPOCROS K-1020E (manufactured by Nippon Shokubai Co., Ltd.)

EPOCROS K-1030E (manufactured by Nippon Shokubai Co., Ltd.)

EPOCROS K-2010E (manufactured by Nippon Shokubai Co., Ltd.)

EPOCROS K-2020E (manufactured by Nippon Shokubai Co., Ltd.)

EPOCROS K-2030E (manufactured by manufactured by Nippon Shokubai Co., Ltd.)

EPOCROS WS-500 (Nippon Shokubai Co., Ltd.)

EPOCROS WS-700 (manufactured by Nippon Shokubai Co., Ltd.)

The cross-linking agent used in the invention may be mixed with a binder solution before addition thereof to a coating liquid. Alternatively, the cross-linking agent may be added to the coating liquid in the end of the preparation of the coating liquid, or immediately before coating.

The amount of the cross-linking agent used in the invention is preferably 0.5 to 200 parts by mass, more preferably 2 to 100 parts by mass, and still more preferably 3 to 50 parts by mass with respect to 100 parts by mass of the binder of a layer in which the cross-linking agent is contained.

Thickener

A thickener is preferably added to a coating liquid for forming the non-photosensitive intermediate layer A. The addition of the thickener enables formation of a hydrophobic layer having a uniform thickness. Examples of the thickener include alkaline metal salts of polyvinyl alcohol, alkaline metal salts of hydroxyethylcellulose, and alkaline metal salts of carboxymethylcellulose. The thickener is preferably thixotropic in view of easy handling, and thus is preferably hydroxyethylcellulose, sodium hydroxymethylcarboxylate, and/or carboxymethyl-hydroxyethylcellulose.

The viscosity of the non-photosensitive intermediate layer A coating liquid including the thickener at 40° C. is preferably 1 to 200 mPa·s, more preferably 10 to 100 mPa·s, and still more preferably 15 to 60 mPa·s.

3) Outermost Layer

Exaplanation regarding a non-photosensitive layer which constitutes the outermost layer provided on a side of the photothermographic material on which the image forming layer is provided.

In addition to a binder, the outermost layer preferably further contains a matting agent, lubricant, surfactant and the like for improving transportability and to surface protection.

Preferable examples of the binder include a hydrophilic polymer, a polymer latex, and a mixture thereof.

Hydrophilic Polymer

It is preferable that the hydrophilic polymer used as the binder in the outermost layer is a animal protein-derived hydrophilic polymer that is similar to those described in the explanation regarding the non-photosensitive intermediate layer B.

Polymer Latex

Explanation regarding the polymer latex used in the outermost layer is herein provided. The amount of the polymer latex used in the outermost layer of the invention is preferably 50 to 100 parts by mass, and more preferably 50 to 75 parts by mass with respect to total amount of the binder of a layer in the outermost layer.

The polymer latex in the invention preferably has an equilibrium moisture content of 5 mass % or less at 25° C. and 60% RH. The equilibrium moisture content at 25° C. and 60% RH can be represented by the following equation:
Equilibrium moisture content at 25° C. and 60% RH={(W1−W0)/W0}×100 (mass %),

In the equation, W1 is the mass of a polymer in humidity-conditioned equilibrium in an atmosphere of 25° C. and 60% RH, and W0 is the mass of the polymer in a bone-dry state at 25° C.

In the invention, the equilibrium moisture content is preferably 2 mass % or less, more preferably 0.01 to 1.5 mass %, and still more preferably 0.02 to 1 mass %.

The glass transition temperature of the polymer latex in the invention is preferably 0 to 80° C., more preferably 10 to 70° C., and still more preferably 15 to 60° C.

Specific examples of the polymer latex usable in the invention include latexes of polyacrylate, polyurethane, polymethacrylate, or copolymers thereof.

Two or more polymer latexes can be used in combination in the invention, in accordance with necessity. For example, a polymer latex having a glass transition temperature of 20° C. or higher and that having a glass transition temperature of lower than 20° C. may be used in combination. If two or more polymers having different glass transition temperatures are used in combination, the mass-averaged Tg of the polymers is preferably within the above range.

In the invention, a coating liquid which includes a solvent containing water in an amount of 30 mass % or more based on the amount of the solvent is prepared and applied to a support and the resulting coating is dried to form a hydrophobic polymer-containing layer.

The coating liquid preferably has an ionic conductivity of 2.5 mS/cm or lower, and examples of the method for forming such a coating liquid include a method having purifying a synthesized polymer with a separation membrane.

The solvent of the coating liquid is preferably water or a mixed solvent of water and a water-miscible organic solvent whose content in the mixed solvent is 70 mass % or lower. Examples of the water-miscible organic solvent include alcohols such as methyl alcohol, ethyl alcohol, or propyl alcohol; cellosolves such as methyl cellosolve, ethyl cellosolve, or butyl cellosolve; ethyl acetate; and dimethylformamide.

In the invention, the average diameter of the dispersed particles is preferably in the range of 1 nm to 50,000 nm, more preferably in the range of 10 nm to 500 nm, and still more preferably in the range of 50 nm to 200 nm. There is no particular limitation on the particle diameter distribution of the dispersed particles, and the dispersed particles may have a broad distribution or a monodisperse particle diameter distribution. From the viewpoint of controlling the physical properties of a coating liquid, mixing two or more groups of particles each having a monodisperse particle distribution is preferable.

Preferable examples of the polymer include hydrophobic polymers such as acrylic polymer, polyester, rubber (e.g., an SBR resin), polyurethane, polyvinyl chloride, polyvinyl acetate, polyvinylidene chloride, or polyolefin. The polymer may be linear, branched or cross-linked, and may be a homopolymer obtained by polymerizing one kind of monomer, or a copolymer obtained by polymerizing two or more kinds of monomers. In the case of that the polymer is a copolymer, it may be a random copolymer or a block copolymer. The number-average molecular weight of the polymer is in the range of 5,000 to 1,000,000, and preferably in the range of 10,000 to 200,000. Polymers having a too small molecular weight result in an image-forming layer having an insufficient mechanical strength, whereas polymers having a too large molecular weight have a poor film-forming property. A cross-linkable polymer latex is particularly preferably used as the polymer latex used in the outermost layer of the photothermographic material of the invention.

Specific Examples of Latex

Specific examples of the polymer latex are given below, and are expressed by starting monomers. The numerical value in a parenthesis accompanied with each of abbrebiations of monomers represents the mass percentage of the monomer. The molecular weight is the number average molecular weight. Latexes whose starting monomers include a polyfunctional monomer form a cross-linked structure, and the concept of molecular weight is not applicable thereto. Hence, they are denoted as “cross-linking”, and the molecular weight is not shown. “Tg” represents the glass transition temperature of the polymer.

NP-1; latex of MMA(70)-EA(27)-MAA(3) (molecular weight of 37,000, and Tg of 61° C.)

NP-2; latex of MMA(70)-2EHA(20)-St(5)-AA(5) (molecular weight of 40,000, and Tg of 59° C.)

NP-3; latex of St(55)-Bu(42)-MAA(3) (cross-linking, and Tg of 5° C.)

NP-4; latex of St(68)-Bu(29)-AA(3) (cross-linking, and Tg of 17° C.)

NP-5; latex of St(71)-Bu(26)-AA(3) (cross-linking, and Tg of 24° C.)

NP-6; latex of St(70)-Bu(27)-IA(3) (cross-linking)

NP-7; latex of St(75)-Bu(24)-AA(1) (cross-linking, and Tg of 29° C.)

NP-8; latex of St(60)-Bu(35)-DVB(3)-MAA(2) (cross-linking)

NP-9; latex of St(70)-Bu(25)-DVB(2)-AA(3) (cross-linking)

NP-10; latex of VC(50)-MMA(20)-EA(20)-AN(5)-AA(5) (molecular weight of 80,000)

NP-11; latex of VDC(85)-MMA(5)-EA(5)-MAA(5) (molecular weight of 67,000)

NP-12; latex of Et(90)-MAA(10) (molecular weight of 12,000)

NP-13; latex of St(70)-2EHA(27)-AA(3) (molecular weight of 130,000, and Tg of 43° C.)

NP-14; latex of MMA(63)-EA(35)-AA(2) (molecular weight of 33,000, and Tg of 47° C.)

NP-15; latex of St(70.5)-Bu(26.5)-AA(3) (cross-linking, and Tg of 23° C.)

NP-16; latex of St(69.5)-Bu(27.5)-AA(3) (cross-linking, and Tg of 20.5° C.)

NP-17; latex of St(61.3)-Isoprene(33.5)-AA(3) (cross-linking, and Tg of 17° C.)

NP-18; latex of St(67)-Isoprene(28)-Bu(2)-AA(3) (cross-linking, and Tg of 27° C.)

In the above structures, MMA represents methyl metacrylate, EA represents ethyl acrylate, MAA represents methacrylic acid, 2EHA represents 2-ethylhexyl acrylate, St represents styrene, Bu represents butadiene, AA represents acrylic acid, DVB represents divinylbenzene, VC represents vinyl chloride, AN represents acrylonitrile, VDC represents vinylidene chloride, Et represents ethylene, and IA represents itaconic acid.

The above polymer latexes are available commercially. Specifically, the commercial products are as follows: those of acrylic polymers include CEVIAN A-4635, 4718, and 4601 (all trade names, manufactured by Daicel Chemical Industries, Ltd.), and NIPOL® LX811, 814, 821, 820, and 857 (all trade names, mmanufactured by Zeon Corporation); those of polyesters include FINETEX ES 650, 611, 675, and 850 (all trade names, mmanufactured by Dainippon Ink and Chemicals), and WD-SIZE, and WMS (all trade names, manufactured by Eastman Chemical); those of polyurethanes include HYDRAN AP10, 20, 30, and 40 (all trade names, manufactured by Dainippon Ink and Chemicals); those of rubbers include LACSTAR 7310K, 3307B, 4700H, and 7132C (all trade names, manufactured by Dainippon Ink and Chemicals), and NIPOL® LX416, 410, 438C, and 2507 (all trade names, manufactured by Zeon Corporation); those of polyvinyl chlorides include G351 and G576 (all trade names, manufactured by Zeon Corporation); those of polyvinylidene chlorides include L502 and L513 (all trade names, manufactured by Asahi Kasei Corp.); and those of polyolefins include CHEMIPEARL® S120 and SA100 (all trade names, manufactured by Mitsui Chemicals, Inc.).

One of these polymer latexes may be used alone, or two or more of them may be used in combination, in accordance with necessity.

The latex polymer for use in the hydrophobic polymer layer in the invention is particularly preferably an acrylic copolymer, polyester, or polyurethane. In addition, the latex polymer for use in the hydrophobic polymer layer in the invention preferably contains acrylic acid or methacrylic acid in an amount of 1 to 6 mass %, and more preferably 2 to 5 mass %. The latex polymer for use in the hydrophobic polymer layer in the invention preferably contains acrylic acid.

The coating amount of the hydrophobic polymer per m² of a support is preferably 0.1 to 10 g/m², and more preferably 0.3 to 5 g/m².

The concentration of the polymer in the coating liquid is preferably adjusted so as to make the viscosity of the coating liquid suitable for simultaneous multi-layer application, but is not particularly limited. The concentration thereof in the coating liquid is generally 5 to 50 mass %, preferably 10 to 40 mass %, and more preferably 15 to 30 mass %.

Matting Agent

A matting agent may be preferably added to the photothermographic material of the invention in order to improve transportability. Description on the matting agent can be found in paragraphs Nos. 0126 to 0127 of JP-A No. 11-65021. An addition amount of the matting agent is preferably in a range of 1 mg/m² to 400 mg/m² with respect to a coating amount of the photothermographic material per 1 m², and more preferably in a range of 5 mg/m² to 300 mg/m², with respect to a coating amount of the photothermographic material per 1 m².

There is no particular restriction on the shape of the matting agent usable in the invention and it may fixed form or non-fixed form. Preferred is to use those having fixed form and sphere shape.

A volume weighted average of a sphere equivalent diameter of the matting agent used in the image forming layer is preferably in a range of 0.3 μm to 10 μm, more preferably in a range of 0.5 μm to 7.0 μm. A variation coefficient of a particle diameter distribution of the matting agent used in the image forming layer is preferably in a range of 5 to 80%, more preferably in a range of 20 to 80%. The variation coefficient used herein is defined by “(a standard deviation of particle diameter)/(an average value of particle diameter)×100”. Further, it is preferable that two or more kinds of matting agents having different average values of particle diameter are used in the image forming layer. In such a case, a difference between an average value of particle diameter of a largest matting agent and an average value of particle diameter of a smallest matting agent is preferably in a range of 2 to 8 μm, and more preerably in a range of 2 to 6 μm.

A volume weighted average of a sphere equivalent diameter of the matting agent used in a back surface is preferably in a range of 1 μm to 15 μm, more preferably in a range of 3 μm to 10 μm. A variation coefficient of a particle diameter distribution of the matting agent used in the back surface is preferably in a range of 3 to 50%, more preferably in a range of 5 to 30%. Further, it is preferable that two or more kinds of matting agents having different average values of particle diameter are used in the back surface. In such a case, a difference between an average value of particle diameter of a largest matting agent and an average value of particle diameter of a smallest matting agent is preferably in a range of 2 to 14 μm, and more preerably in a range of 2 to 9 μm.

A matt degree of a surface of the image forming layer is not restricted as far as no star-dust trouble occurs. It is preferable that the matt degree is in a range of 30 seconds to 2,000 seconds, and it is more preferable that the matt degree is in a range of 40 seconds to 1,500 seconds in terms of Beck's smoothness. Beck's smoothness can be calculated easily, by the conventionally-known method of testing Beck's smoothness for papers and sheets using Beck's test apparatus, or TAPPI standard method T479.

The matt degree of the back layer in the invention is preferably in a range of 10 to 1,200 seconds, more preferably in a range of 20 to 800 seconds; and further preferably in a range of 40 to 500 seconds, in terms of the Beck's smoothness.

In the present invention, the matting agent is preferably contained in the outermost layer, in a layer which can be function as a surface protective layer, or in a layer nearer to the outermost layer.

Lubricant

The photothermographic material preferably contains a lubricant such as liquid paraffin, long-chain fatty acid, fatty acid amide, or fatty acid ester for improvement in handling property during production and scratch resistance during thermal development. The lubricant is preferably liquid paraffin and/or fatty acid ester having a branched structure and a molecular weight of 1,000 or more from which low-boiling components are removed.

The lubricant is preferably selected from compounds described in JP-A No. 11-65021, paragraph No. 0117, JP-A Nos. 2000-5137, 2004-219794, 2004-219802, and 2004-334077.

The amount of the lubricant is generally 1 mg/m² to 200 mg/m², preferably 10 mg/m² to 150 mg/m², and more preferably 20 mg/m² to 100 mg/m².

The lubricant may be contained in any of the image-forming layer and the non-image-forming layer, but is preferably contained in the outermost layer for improvement in transportability and scratch resistance.

Other Constituents

A surfactant, a solvent, a support, an antistatic agent and an electrically conductive layer, and a method for obtaining color images applicable in the invention are described in paragraph Nos. 0132, 0133, 0134, 0135, and 0136, respectively, of JP-A No. 11-65021. Further, a lubricant applicable in the invention is described in paragraphs 0061 to 0064 of JP-A 11-84573 and paragraphs 0049 to 0062 of JP-A2001-83679.

Surfactant

A fluorocarbon surfacant is preferably used in the invention. Specific examples of the fluorocarbon surfacant include those described in JP-A Nos. 10-197985, 2000-19680, and 2000-214554. Polymer fluorocarbon surfacants described in JP-A 9-281636 can be also preferably used. The fluorocarbon surfacants described in JP-A Nos. 2002-82411, 2003-57780, and 2003-149766 are also preferably used in the photothermographic material in the invention. The fluorocarbon surfacants described in JP-A Nos. 2003-57780 and 2003-149766 are particularly preferably used in an aqueous coating liquid in view of capacity in static control, stability of the coating surface state and sliding facility. The fluorocarbon surfactant described in JP-A No. 2003-149766 is mostly preferable because of high capacity in static control and that an amount thereof to be used is small.

According to the invention, the fluorocarbon surfactant can be used on either side of an image forming layer surface side or a back layer surface side. It is preferable to use it on both the sides thereof. Further, it is particularly preferable to use in combination with an electrically conductive layer containing metal oxides described above. In this case, a sufficient efficiency can be obtained even if an amount of the fluorocarbon surfactant on a side having the electrically conductive layer is reduced or removed.

An amount of the fluorocarbon surfactant is preferably in a range of 0.1 mg/m² to 100 mg/m² on each surface side of the image forming layer and the back layer. It is more preferably in a range of 0.3 mg/m² to 30 mg/m², and further preferably in a range of 1 mg/m² to 10 mg/m². Particularly, the fluorocarbon surfactant described in JP-A No. 2001-264110 is effective, and it is used preferably in a range of 0.01 mg/m² to 10 mg/m², and more preferably in a range of 0.1 mg/m² to 5 mg/m².

Image Forming Method

1) Exposure

The photothermographic material of the invention can be imagewisely exposed by used any means. The photothermographic material of the invention is preferably subjected to a scanning exposure. Examples of a laser beam which can be used in the invention include a He—Ne laser of red through infrared emission, a red laser diode, an Ar⁺ laser of blue through green emission, a He—Ne laser of blue through green emission, a He—Cd laser laser of blue through green emission, and a blue laser diode. Preferable examples tehreof include a red to infrared laser diode. The peak wavelength of the laser beam is in a range of 600 nm to 900 nm, and is preferably in a range of 620 nm to 850 nm.

In recent years, development has been made particularly on a module in which an SHG (a second harmonic generator) and a semiconductor laser are integrated into a single piece and on a blue semiconductor laser, whereby apparatuses which output laser in a short wavelength region have come into the limelight. A blue semiconductor laser enables high definition image recording and makes it possible to obtain an increase in recording density and a stable output over a long lifetime, which results in expectation of an expanded demand in the future. A peak wavelength of blue laser beam is is in a range of 300 nm to 500 nm, and is preferably is in a range of 400 nm to 500 nm.

Laser beam which oscillates in a longitudinal multiple modulation by a method such as high frequency superposition is also preferably employed.

2) Thermal Development

Any method may be used for developing the photothermographic material of the invention. The development is usually performed by elevating the temperature of the photothermographic material which has been imagewise exposed. A temperature for the development is preferably in a range of 80° C. to 250° C., more preferably in a range of 100° C. to 140° C., and further preferably in a range of 110° C. to 130° C. A period for development is preferably in a range of 1 to 60 seconds, more preferably in a range of 3 to 30 seconds, further preferably in a range of 5 to 25 seconds, and particularly preferably in a range of 7 to 15 seconds.

The process for thermal development may employ either drum heaters or plate heaters. Among them, the processes utilizing plate heaters are more preferable. Preferable examples of the process for thermal development by using a plate heater is described in JP-A No.11-133572, which discloses a thermal developing device in which a visible image is obtained by bringing a photothermographic material with a formed latent image into contact with a heating means at a thermal development region, wherein the heating means comprises a plate heater, and plurality of pressing rollers are oppositely provided along one surface of the plate heater, the thermal developing device is characterized in that thermal development is performed by passing the photothermographic material between the pressing rollers and the plate heater. It is preferable that the plate heater is divided into 2 to 6 portions, and a leading end thereof preferably has a lower temperature by 1° C. to 10° C. For example, 4 sets of plate heaters which can be respectively subjected to temperature controlling are used, and are controlled so that they respectively become 112° C., 119° C., 121° C., and 120° C. Such a process is also described in JP-A No.54-30032, which allows for excluding moisture and organic solvents included in the photothermographic material out of the system, and also allows to suppress a change of shape of the support of the photothermographic material upon rapid heating of the photothermographic material.

In view of downsizing of the thermal developing apparatus and shortening a time period for thermal development, it is preferable that the heater is more stably controlled, and a sheet of the photothermographic material is exposed from a top portion thereof and a thermal development of exposed portions are started before exposure of an end part of the sheet completes. Preferable examples of an imager which is capable of rapid processing for use in the invention is described in JP-A Nos. 2002-289804 and 2003-285455. The imager of the preferable example enables to implement a thermal development by using 4 steps of plate heater of 107° C., 121° C. and 121° C. within a period of 14 seconds, and an output time of a first sheet is shortened to approximately 60 seconds.

3) System

Examples of a medical laser imager equipped with an exposing portion and a thermal developing portion include dry laser imagers FM-DP L and DRYPIX 7000 (both trade names, manufactured by Fuji Film Medical Co., Ltd.). In connection with FM-DP L, description is found in Fuji Medical Review No. 8, pages 39 to 55. Those techniques may be reasonably applied to the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

Application of the Invention

The photothermographic material of the invention forms black-and-white images by silver imaging, and is preferably employed for use in utilizations such as a medical diagnosis, an industrial photography, a printing photography or the like.

### EXAMPLES

The present invention is specifically explained by way of examples below, which should not be construed as limiting the invention thereto.

### Example 1

Preparation of PET Support

(1) Film Manufacturing

Polyethylene terephtarate (PET) having IV (intrinsic viscosity) of 0.66 (measured in phenol/tetrachloroethane=6/4 (weight ratio) at 25° C.) was obtained according to a conventional manner using terephthalic acid and ethylene glycol. The product was pelletized, dried at 130° C. for 4 hours, melted at 300° C. Thereafter, the mixture was extruded from a T-die and rapidly cooled to form a non-tentered film.

The film was stretched along a longitudinal direction by 3.3 times using rollers having different peripheral speeds, and then stretched along a transverse direction by 4.5 times using a tenter machine. Temperatures used for these operations were 110° C. and 130° C., respectively. Then, the film was subjected to thermal fixation at 240° C. for 20 seconds, and relaxed by 4% along the transverse direction at the same temperature. Thereafter, a chucking part of the tenter machine was slit off, and both edges of the film were knurled. Then the film was rolled up at ae tension of 4 kg/cm² to obtain a roll having a thickness of 175 μm.

2) Surface Corona Discharge Treatment

Both surfaces of the support were treated at room temperature at 20 m/minute using a solid state corona discharge treatment machine (trade name: MODEL 6 KVA, manufactured by Piller GmbH). It was found that a treatment of 0.375 kV-A-minute/m² was applied to the support, judging from readings of current and voltage on that occasion. A frequency upon this treatment was 9.6 kHz, and a gap clearance between an electrode and a dielectric roll upon this treatment was 1.6 mm.

3) Undercoating

Preparation of Coating liquid for Undercoat Layer

Formulation (1): Coating liquid for undercoat layer on the
image forming layer side

| | | |
|---|---|---|
| Polyester resin (trade name: Pesresin A-520, | 46.8 | g |
| manufactured by Takamatsu Oil & Fat Co., Ltd. | | |
| (30% by weight solution)) | | |
| Aqueous dispersion of polyerter copolymer resin | 10.4 | g |
| (trade name: VYLONAL ® MD-1200, | | |
| manufactured by Toyobo Co., Ltd.) | | |
| Polyethyleneglycol monononylphenylether | 11.0 | g |
| (average ethylene oxide number = 8.5) 1% by | | |
| weight solution | | |
| Polymethylmetaacrylate polymer microparticles | 0.91 | g |
| (trade name: MP-1000, manufactured by Soken | | |
| Chemical & Engineering Co., Ltd.) (average | | |
| particle diameter: 0.4 μm) | | |
| Distilled water | 931 | mL |

Formulation (2): Coating liquid for first layer on the back surface

| | | |
|---|---|---|
| Styrene-butadiene copolymer latex (solid content of | 130.8 | g |
| 40% by weight, styrene/butadiene weight ratio = 68/32) | | |
| Sodium salt of 2,4-dichloro-6-hydroxy-S-triazine | 5.2 | g |
| (8% by weight aqueous solution) | | |
| Aqueous solution of sodium laurylbenzenesulfonate | 10 | mL |
| (1% by weight) | | |
| Dispersion of polystyrene particles | 0.5 | g |
| Distilled water | 854 | mL |

Formulation (3): Coating liquid for second layer on the back surface)

| | | |
|---|---|---|
| SnO₂/SbO (9/1 weight ratio, average particle | 84 | g |
| diameter of 0.5 μm, 17% by weight dispersion) | | |
| Gelatin (10% by weight aqueous solution) | 7.9 | g |
| Cellulose compound (trade name: METOLOSE TC-5, | 10 | g |
| manufactured by Shin-Etsu Chemical Co., | | |
| Ltd. (2% by weight aqueous solution)) | | |
| Aqueous solution of sodium dodecylbenzenesulfonate | 10 | mL |
| (1% by weight) | | |
| NaOH (1% by weight) | 7 | g |
| Antiseptic agent (trade name: PROXEL, manufactured | 0.5 | g |
| by Avecia KK.) | | |
| Distilled water | 881 | mL |

Both surfaces of the biaxially tentered polyethylene terephthalate support having the thickness of 175 μm were subjected to the corona discharge treatment as described above. Thereafter, a coating liquid having the formulation (1) for an undercoat layer was coated on one surface (image forming layer side) with a wire bar so that an amount of wet coating became 6.6 mL/m² (per one side), and dried at 180° C. for 5 minutes. Then, a coating liquid having the formulation (2) of an undercoat layer was coated on a reverse face (back surface) with a wire bar so that an amount of wet coating became 5.7 mL/m², and dried at 180° C. for 5 minutes. Further, the coating liquid having the formulation (3) of an undercoat layer was coated on the reverse face (back surface) with a wire bar so that an amount of wet coating became 8.4 mL/m², and dried at 180° C. for 6 minutes. Thus, an undercoated support was produced.

Back Layer

1) Preparation of Coating Liquid for Back Layer

Preparation of Dispersion of Solid Fine Particles (a) of Base Precursor

2.5 kg of base precursor-1,300 g of a surfactant (trade name: DEMOL N, manufactured by Kao Corporation), 800 g of diphenyl sulfone and 1.0 g of sodium salt of benzoisothiazolinone, were added to distilled water to provide a mixture liquid of an amount of 8.0 kg. The mixture liquid was subjected to beads dispersing process using a horizontal sand mill (trade name: UVM-2, manufactured by AIMEX Co., Ltd.). The dispersing process included feeding the mixed liquid to UVM-2 packed with zirconia beads having an average particle diameter of 0.5 mm with a diaphragm pump, and dispersing the mixture liquid at an inner pressure of 50 hPa or higher until a desired average particle diameter could be obtained.

The dispersing process was continued until a ratio of an optical density at 450 nm and an optical density at 650 nm for a spectral absorption of the dispersion (D₄₅₀/D₆₅₀) became 3.0 upon spectral absorption measurement. Thus resulting dispersion was diluted with distilled water so that a concentration of the base precursor became 25% by weight, and filtrated (with a polypropylene filter having an average fine pore diameter of 3 μm) for eliminating dust.

2) Preparation of Dispersion of Solid Fine Particle of Dye

6.0 kg cyanine dye-1, 3.0 kg of sodium p-dodecylbenzenesulfonate, 0.6 kg of a surfactant (trade name: DEMOL SNB, manufactured by Kao Corporation), and 0.15 kg of a defoaming agent (trade name: SURFYNOL 104E, manufactured by Nissin Chemical Industry Co., Ltd.) were mixed with distilled water to provide a mixture liquid of an amount of 60 kg. The mixture liquid was subjected to a dispersing process with 0.5 mm zirconia beads using a horizontal sand mill (trade name: UVM-2, manufactured by AIMEX Co., Ltd.).

The dispersion was dispersed until a ratio of an optical density at 650 nm and an optical density at 750 nm for s spectral absorption of the dispersion (D₆₅₀/D₇₅₀) became 5.0 or more upon spectral absorption measurement. Thus resulting dispersion was diluted with distilled water so that s concentration of the cyanine dye became 6% by weight, and filtrated with a filter (average fine pore diameter: 1 μm) for eliminating dust.

3) Preparation of Coating liquid for Antihalation Layer

A vessel was kept at 40° C., and 37 g of gelatin, 0.1 g of benzoisothiazolinone and water t were added thereto so as to allow the gelatin to be dissolved. Further, 36 g of the dispersion of the solid fine particle of the dye, 73 g of the dispersion of the solid fine particles (a) of the base precursor, 43 mL of a 3% by weight aqueous solution of sodium polystyrenesulfonate, and 82 g of a 10% by weight solution of SBR latex (copolymerization ratio of styrene/butadiene/acrylic acid: 68.3/28.7/3.0) were mixed thereto so as to provide a 773 mL of a coating liquid for an antihalation layer.

4) Preparation of Coating liquid for Back Surface Protective Layer

A vessel was kept at 40° C., and 43 g of gelatin having an isoelectric point at 4.8, 0.21 g of benzoisothiazolinone and water were added thereto so as to allow the gelatin to be dissolved. Further, 8.1 mL of a 1 mol/L aqueous sodium hydroxide solution, 0.93 g of fine particles of a monodispersed poly(ethyleneglycol dimethacrylate-co-methylmethacrylate) (average particle diameter: 7.7 μm, standard deviation of particle diameter: 0.3 μm), 5 g of a 10% by weight emulsion of liquid paraffin, 10 g of a 10% by weight emulsion of dipentaerythrytol hexaisostearate, 10 mL of a 5% by weight aqueous solution of di(2-ethylhexyl) sodium sulfosuccinate, 17 mL of a 3% by weight aqueous solution of sodium polystyrenesulfonate, 2.4 mL of a 2% by weight solution of a fluorocarbon surfactant (F-1), and 30 mL of a 20% by weight solution of latex ((copolymerization ratio of ethyl acrylate/styrene/ acrylic acid: 96.4/3.6) were mixed. Just prior to the coating, 50 mL of a 4% by weight aqueous solution of N,N-ethylenebis(vinylsulfone acetamide) was mixed therewith so as to provide 855 mL of a coating liquid for the back surface protective layer. A pH of the resulted coating liquid was 6.2.

5) Coating of Back Layer

The back surface side of the undercoated support was subjected to simultaneous double coating so that the coating liquid for the antihalation layer gave an amount of coated gelatin of 0.54 g/m², and so that the coating liquid for the back surface protective layer gave an amount of coated gelatin of 1.85 g/m², followed by drying so as to produce a back layer.

Image Forming Layer, Intermediate Layer, and Surface Protective Layer

1. Preparation of Materials for Coating

1) Silver Halide Emulsion

Preparation of Silver Halide Emulsion-1

To 1421 mL of distilled water was added 3.1 mL of a 1% by weight potassium bromide solution. Further, a liquid added with 3.5 mL of 0.5 mol/L sulfuric acid and 31.7 g of phthalated gelatin was kept at 30° C. while stirring in a stainless steel reaction vessel, and thereto were added total amount of: a solution A prepared through diluting 22.22 g of silver nitrate by adding distilled water to give the volume of 95.4 mL; and a solution B prepared through diluting 15.3 g of potassium bromide and 0.8 g of potassium iodide with distilled water to give the volume of 97.4 mL, over 45 seconds at a constant flow rate. Thereafter, 10 mL of a 3.5% by weight aqueous solution of hydrogen peroxide was added thereto, and 10.8 mL of a 10% by weight aqueous solution of benzimidazole was further added.

Moreover, a solution C prepared through diluting 51.86 g of silver nitrate by adding distilled water to give the volume of 317.5 mL and a solution D prepared through diluting 44.2 g of potassium bromide and 2.2 g of potassium iodide with distilled water to give the volume of 400 mL were added. A controlled double jet method was executed through adding total amount of the solution C at a constant flow rate over 20 minutes, accompanied by adding the solution D while maintaining the pAg at 8.1. A total amount of potassium hexachloroiridate (III) was further added thereto so as to give 1×10⁻⁴ mol per 1 mol of silver at 10 minutes after starting of the addition of the solution C and the solution D. Moreover, at 5 seconds after completing the addition of the solution C, a total amount of an aqueous solution of potassium hexacyanoferrate (II) was added thereto so as to give 3×10⁻⁴ mol per 1 mol of silver. The mixture was adjusted to the pH of 3.8 with 0.5 mol/L sulfuric acid. After stopping stirring, the mixture was subjected to precipitation/ desalting/ water washing processes. The mixture was adjusted to the pH of 5.9 with 1 mol/L sodium hydroxide to produce a silver halide dispersion having the pAg of 8.0.

The above-described silver halide dispersion was kept at 38° C. with stirring, and thereto was added 5 mL of a 0.34% by weight methanol solution of 1,2-benzoisothiazoline-3-one, followed by elevating the temperature to 47° C. at 40 minutes thereafter. At 20 minutes after elevating the temperature, a methanol solution of sodium benzene thiosulfonate was added thereto so that the amount of sodium benzene thiosulfonate became 7.6×10⁻⁵ mol per 1 mol of silver. At additional 5 minutes later, a methanol solution of tellurium sensitizer C was added thereto so that the amount of tellurium sensitizer C became 2.9×10⁻⁴ mol per 1 mol of silver. The resultant was then subjected to ripening for 91 minutes. Thereafter, a methanol solution containing a spectral sensitizing dye A and a spectral sensitizing dye B with a molar ratio of 3:1 was added thereto so that a total amount of the mixture of the spectral sensitizing dye A and the spectral sensitizing dye B became 1.2×10⁻³ mol in total of the spectral sensitizing dye A and B per 1 mol of silver. At 1 minute later, 1.3 mL of a 0.8% by weight methanol solution of N,N′-dihydroxy-N″,N″-diethylmelamine was added thereto, and at additional 4 minutes thereafter, a methanol solution of 5-methyl-2-mercaptobenzimidazole for providing 4.8×10⁻³ mol of 5-methyl-2-mercaptobenzimidazole per 1 mol of silver, a methanol solution of 1-phenyl-2-heptyl-5-mercapto-1,3,4-triazole for providing 5.4×10⁻³ mol of 1-phenyl-2-heptyl-5-mercapto-1,3,4-triazole per 1 mol of silver, and an aqueous solution of 1-(3-methylureidophenyl)-5-mercaptotetrazole for providing 8.5×10⁻³ mol of 1-(3-methylureidophenyl)-5-mercaptotetrazole per 1 mol of silver were added to produce a silver halide emulsion-1.

Grains in thus prepared silver halide emulsion were silver iodobromide grains having an average sphere equivalent diameter of 0.042 μm, a variation coefficient of an sphere equivalent diameter distribution of 20%, which uniformly include iodine at 3.5 mol %. Grain size and the like were determined from the average of 1000 grains using an electron microscope. The {100} face ratio of these grains was found to be 80% using a Kubelka-Munk method.

Preparation of Silver Halide Emulsion-2

Preparation of silver halide emulsion-2 was conducted in a similar manner to the process in the preparation of the silver halide emulsion-1 except that: the temperature of the liquid upon the grain forming process was altered from 30° C. to 47° C.; the solution B was changed to that prepared through diluting 15.9 g of potassium bromide with distilled water to give the volume of 97.4 mL; the solution D was changed to that prepared through diluting 45.8 g of potassium bromide with distilled water to give the volume of 400 mL; time period for adding the solution C was changed to 30 minutes; and potassium hexacyanoferrate (II) was deleted.

The precipitation/ desalting/ water washing /dispersion were carried out similarly to the silver halide emulsion-1. Furthermore, the spectral sensitization, chemical sensitization, and addition of 5-methyl-2-mercaptobenzimidazole and I-phenyl-2-heptyl-5-mercapto-1,3,4-triazole was executed similarly to the emulsion-1 except that: the amount of the tellurium sensitizer C to be added was changed to 1.1×10⁻⁴ mol per 1 mol of silver; the amount of the methanol solution of the spectral sensitizing dye A and the spectral sensitizing dye B with a molar ratio of 3:1 to be added was changed to 7.0×10⁻⁴ mol in total of the spectral sensitizing dye A and the spectral sensitizing dye B per 1 mol of silver; the addition of 1-phenyl-2-heptyl-5-mercapto-1,3,4-triazole was changed to give 3.3×10⁻³ mol per 1 mol of silver; and the addition of 1-(3-methylureidophenyl)-5-mercaptotetrazole was changed to give 4.7×10⁻³ mol per 1 mol of silver, to produce silver halide emulsion-2. The grains in the silver halide emulsion-2 were pure cubic silver bromide grains having an average sphere equivalent diameter of 0.080 μm and a variation coefficient of an sphere equivalent diameter distribution of 20%.

Preparation of Silver Halide Emulsion-3

Preparation of silver halide emulsion-3 was conducted in a similar manner to the process in the preparation of the silver halide emulsion-1 except that the temperature of the liquid upon the grain forming process was altered from 30° C. to 27° C. In addition, the precipitation/ desalting/water washing/dispersion were carried out similarly to the silver halide emulsion-1. Silver halide emulsion-3 was obtained similarly to the emulsion-1 except that: the addition of the methanol solution of the spectral sensitizing dye A and the spectral sensitizing dye B was changed to the solid dispersion (aqueous gelatin solution) at a molar ratio of 1:1 with the amount to be added being 6.0×10⁻³ mol in total of the spectral sensitizing dye A and the spectral sensitizing dye B per 1 mol of silver; the amount of the tellurium sensitizer C to be added was changed to 5.2×10⁻⁴ mol per 1 mol of silver; and bromoauric acid at 5×10⁻⁴ mol per 1 mol of silver and potassium thiocyanate at 2×10⁻³ mol per 1 mol of silver were added at 3 minutes following the addition of the tellurium sensitizer. The grains in the silver halide emulsion-3 were silver iodide bromide grains having a average sphere equivalent diameter of 0.034 μm and a variation coefficient of an sphere equivalent diameter distribution of 20%, which uniformly include iodine at 3.5 mol %.

Preparation of Mixed Emulsion A for Coating liquid

A mixed emulsion was prepared by mixing the silver halide emulsion-1, the silver halide emulsion-2 and the silver halide emulsion-3 so that the amount ratio of the silver halide emulsion-1 beccame 70% by weight, the amount ratio of the silver halide emulsion-2 beccame 15% by weight, and the amount ratio of the silver halide emulsion-3 beccame 15% by weight. 1% by weight aqueous solution of benzothiazolium iodide was added thereto so as to give 7×10⁻³ mol of benzothiazolium iodide per 1 mol of silver.

Further, as “a compound that can be one-electron-oxidized to provide a one-electron oxidation product, which releases one or more electrons”, compounds Nos. 1, 2, and 3 were added so that respective amounts thereof became 2×10⁻³ mol per 1 mol of silver contained in silver halide.

Further, absorptive redox componds 1 and 2 were added so that respective amounts thereof became 5×10⁻³ mol per 1 mol of silver halide.

Further, water was added to the mixed emulsion so that an amount of silver contained in the silver halide per 1 kg of the mixed emulsion became 38.3 g. Furthermore, 1-(3-methylureidophenyl)-5-mercaptotetrazole was added to the mixed emulsion so that an amount of the 1-(3-methylureidophenyl)-5-mercaptotetrazole per 1 kg of the mixed emulsion A became 0.34 kg.

2) Preparations of Dispersion of Silver Salt of Fatty Acid

Preparation of Dispersion of Silver Salt of Fatty Acid

88 kg of the recrystallized behenic acid, 422 L of distilled water, 49.2 L of 5 mol/L sodium hydroxide aqueous solution, 120 L of t-butyl alcohol were admixed, and subjected to a reaction with stirring at 75° C. for one hour to give a solution of sodium behenate. Separately, 206.2 L of an aqueous solution of 40.4 kg of silver nitrate (pH 4.0) was provided, and kept at a temperature of 10° C. A reaction vessel charged with 635 L of distilled water and 30 L of t-butyl alcohol was kept at 30° C., and thereto were added the total amount of the solution of sodium behenate and the total amount of the aqueous silver nitrate solution with sufficient stirring at a constant flow rate over 93 minutes and 15 seconds, and 90 minutes, respectively. Upon this operation, during first 11 minutes following the initiation of adding the aqueous silver nitrate solution, the added material was restricted to the aqueous silver nitrate solution alone. The addition of the solution of sodium behenate was thereafter started, and during 14 minutes and 15 seconds following the completion of adding the aqueous silver nitrate solution, the added material was restricted to the solution of sodium behenate alone. The temperature inside of the reaction vessel was then set to be 30° C., and the temperature outside was controlled so that the liquid temperature could be kept constant. In addition, the temperature of a pipeline for the addition system of the solution of sodium behenate was kept constant by circulation of warm water outside of a double wall pipe, so that the temperature of the liquid at an outlet in the leading edge of the nozzle for addition was adjusted to be 75° C. Further, the temperature of a pipeline for the addition system of the aqueous silver nitrate solution was kept constant by circulation of cool water outside of a double wall pipe. Position at which the solution of sodium behenate was added and the position, at which the aqueous silver nitrate solution was added, was arranged symmetrically with a shaft for stirring located at a center. Moreover, both of the positions were adjusted to avoid contact with the reaction liquid.

After completing the addition of the solution of sodium behenate, the mixture was left to stand at the temperature as it was for 20 minutes. The temperature of the mixture was then elevated to 35° C. over 30 minutes followed by ripening for 210 minutes. Immediately after completing the ripening, solid matters were filtered out with centrifugal filtration. The solid matters were washed with water until the electric conductivity of the filtrated water became 30 μS/cm. A silver salt of fatty acid was thus obtained. The resulting solid matters were stored as a wet cake without drying.

When the shape of the resulting particles of the silver behenate was evaluated by an electron micrography, a crystal was revealed having a=0.21 μm, b=0.4 μm and c=0.4 μm on the average value, with a mean aspect ratio of 2.1, and a variation coefficient of an sphere equivalent diameter distribution of 11% (a, b and c are as defined aforementioned.).

To the wet cake corresponding to 260 kg of a dry solid matter content, were added 19.3 kg of polyvinyl alcohol (trade name: PVA-217, manufactured by Kuraray Co., Ltd.) and water to give the total amount of 1,000 kg. Then, a slurry was obtained from the mixture using a dissolver blade. Additionally, the slurry was subjected to preliminary dispersion with a pipeline mixer (manufactured by Mizuho Industrial Co., Ltd.: PM-10 type).

Next, a stock liquid ahich has been subjected to a preliminary dispersing was treated three times using a dispersing machine (trade name: Microfluidizer M-610, manufactured by Microfluidex International Corporation, using Z type Interaction Chamber) with the pressure controlled to be 1,150 kg/cm² to give a dispersion of the silver behenate. For the cooling manipulation, coiled heat exchangers were equipped in front of and behind the interaction chamber respectively, and accordingly, the temperature for the dispersion was set to be 18° C. by regulating the temperature of the cooling medium.

3) Preparation of Reducing Agent Dispersions

Preparation of Reducing Agent-1 Dispersion

To 10 kg of reducing agent-1 (2,2′-methylenebis-(4-ethyl-6-tert-butylphenol)) and 16 kg of a 10% by weight aqueous solution of modified polyvinyl alcohol (trade name: POVAL MP203, manufactured by Kuraray Co., Ltd.,) was added 10 kg of water, and thoroughly mixed to give a slurry. This slurry was fed with a diaphragm pump, and was subjected to dispersion with a horizontal sand mill (trade name: UVM-2: manufactured by AIMEX Co., Ltd.) packed with zirconia beads having a mean particle diameter of 0.5 mm for 3 hours. Thereafter, 0.2 g of a benzoisothiazolinone sodium salt and water were added thereto, thereby adjusting the concentration of the reducing agent to be 25% by weight. This dispersion was subjected to heat treatment at 60° C. for 5 hours to obtain reducing agent-1 dispersion. Particles of the reducing agent included in the resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove impurities such as dust, and stored.

Preparation of Reducing Agent-2 Dispersion

To 10 kg of reducing agent-2 (6,6′-di-t-butyl-4,4′-dimethyl-2,2′-butylidenediphenol)) and 16 kg of a 10% by weight aqueous solution of modified polyvinyl alcohol (trade name: POVAL MP203, manufactured by Kuraray Co., Ltd.) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours and 30 minutes. Thereafter, 0.2 g of a benzoisothiazolinone sodium salt and water were added thereto, thereby adjusting the concentration of the reducing agent to be 25% by weight. This dispersion was warmed at 40° C. for one hour, followed by a subsequent heat treatment at 80° C. for one hour to obtain reducing agent-2 dispersion. Particles of the reducing agent included in the resulting reducing agent-2 dispersion had a median diameter of 0.50 μm, and a maximum particle diameter of 1.6 μm or less. The resultant reducing agent-2 dispersion was subjected to filtration with a polypropylene filter having a pore size of 3.0 μm to remove impurities such as dust, and stored.

4) Preparation of Hydrogen Bonding Compound-1 Dispersion

To 10 kg of hydrogen bonding compound-1 (tri(4-t-butylphenyl)phosphineoxide) and 16 kg of a 10% by weight aqueous solution of modified polyvinyl alcohol (trade name: POVAL MP203, manufactured by Kuraray Co., Ltd.) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 4 hours. Thereafter, 0.2 g of a benzoisothiazolinone sodium salt and water were added thereto, thereby adjusting the concentration of the hydrogen bonding compound to be 25% by weight. This dispersion was warmed at 40° C. for one hour, followed by a subsequent heat treatment at 80° C. for one hour to obtain hydrogen bonding compound-1 dispersion. Particles of the hydrogen bonding compound included in the resulting hydrogen bonding compound dispersion had a median diameter of 0.45 μm, and a maximum particle diameter of 1.3 μm or less. The resultant hydrogen bonding compound dispersion was subjected to filtration with a polypropylene filter having a pore size of 3.0 μm to remove impurities such as dust, and stored.

5) Preparations of Development Accelerator-1 Dispersion

To 10 kg of development accelerator-1 and 20 kg of a 10% by weight aqueous solution of modified polyvinyl alcohol (trade name: POVAL MP203, manufactured by Kuraray Co., Ltd.) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours and 30 minuets. Thereafter, 0.2 g of a benzoisothiazolinone sodium salt and water were added thereto, thereby adjusting the concentration of the development accelerator to be 20% by weight. Accordingly, development accelerator-1 dispersion was obtained. Particles of the development accelerator included in the resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove impurities such as dust, and stored.

6) Preparations of Dispersions of Development Accelerator-2 and Color-tone-adjusting Agent-1

Solid dispersions of development accelerator-2 and color-tone-adjusting agent-1 were also subjected to dispersing in a similar manner to the development accelerator-1, and thus dispersions of 20% by weight and 15% by weight were respectively obtained.

7) Preparation of Polyhalogen Compound Dispersions

Preparation of Organic Polyhalogen Compound-1 Dispersion

10 kg of organic polyhalogen compound-1 (tribromomethane sulfonylbenzene), 10 kg of a 20% by weight aqueous solution of modified polyvinyl alcohol (trade name: POVAL MP203, manufactured by Kuraray Co., Ltd.), 0.4 kg of a 20% by weight aqueous solution of sodium triisopropylnaphthalenesulfonate and 14 kg of water were thoroughly admixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzoisothiazolinone sodium salt and water were added thereto, thereby adjusting the concentration of the organic polyhalogen compound to be 26% by weight. Accordingly, organic polyhalogen compound-1 dispersion was obtained. Particles of the organic polyhalogen compound included in the resulting organic polyhalogen compound dispersion had a median diameter of 0.41 μm, and a maximum particle diameter of 2.0 μm or less. The resultant organic polyhalogen compound dispersion was subjected to filtration with a polypropylene filter having a pore size of 10.0 μm to remove impurities such as dust, and stored.

Preparation of Organic Polyhalogen Compound-2 Dispersion

10 kg of organic polyhalogen compound-2 (N-butyl-3-tribromomethane sulfonylbenzoamide), 20 kg of a 10% by weight aqueous solution of modified polyvinyl alcohol (trade name: POVAL MP203, manufactured by Kuraray Co., Ltd.) and 0.4 kg of a 20% by weight aqueous solution of sodium triisopropylnaphthalenesulfonate were thoroughly admixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzoisothiazolinone sodium salt and water were added thereto, thereby adjusting the concentration of the organic polyhalogen compound to be 30% by weight. This fluid dispersion was heated at 40° C. for 5 hours to obtain organic polyhalogen compound-2 dispersion. Particles of the organic polyhalogen compound included in the resulting organic polyhalogen compound dispersion had a median diameter of 0.40 μm, and a maximum particle diameter of 1.3 μm or less. The resultant organic polyhalogen compound dispersion was subjected to filtration with a polypropylene filter having a pore size of 3.0 μm to remove impurities such as dust, and stored.

8) Preparation of Phthalazine Compound-1 Solution

8 kg of a modified polyvinyl alcohol (trade name: POVAL MP203, manufactured by Kuraray Co., Ltd.) was dissolved in 174.57 kg of water, and then thereto were added 3.15 kg of a 20% by weight aqueous solution of sodium triisopropylnaphthalenesulfonate and 14.28 kg of a 70% by weight aqueous solution of phthalazine compound-1 (6-isopropyl phthalazine) to prepare a 5% by weight phthalazine compound-1 solution.

9) Preparation of Mercapto Compounds

Preparation of Aqueous Solution of Mercapto Compound-1

7 g of mercapto compound-1 (sodium salt of 1-(3-sulfophenyl)-5-mercaptotetrazole) was dissolved to 993 g of water to provide a 0.7% by weight aqueous solution.

9) Preparation of Mercapto Compounds

Preparation of Aqueous Solution of Mercapto Compound-2

20 g of mercapto compound-2 (1-(3-methylureidophenyl)-5-mercaptotetrazole) was dissolved to 980 g of water to provide a 2.0% by weight aqueous solution.

10) Preparations of Pigment-1 Dispersion

64 g of C.I. Pigment Blue 60 and 6.4 g of DEMOL N (described above) were added to 250 g of water and thoroughly mixed to give a slurry. Zirconia beads having an average particle diameter of 0.5 mm were provided in an amount of 800 g, and charged in a vessel with the slurry. Dispersion was performed with a dispersing machine (trade name: 1/4G SAND GRINDER MILL: manufactured by AIMEX Co., Ltd.) for 25 hours. Thereto was added water so as to adjust a concentration of the pigment in a thus obtained pigment-1 dispersion became 5% by weight. Particles of the pigment included in the resulting pigment dispersion had an average particle diameter of 0.21 μm.

11) Preparation of Binders for Image forming layer

Preparation of SBR Latex (TP-1) Solution

287 g of distilled water, 7.73 g of a surfactant (trade name: PIONIN A-43-S, manufactured by TAKEMOTO OIL & FAT CO., LTD., solid matter content: 48.5% by weight), 14.06 mL of 1 mol/L sodium hydroxide, 0.15 g of tetrasodium salt of ethylenediamine tetraacetate, 255 g of styrene, 11.25 g of acrylic acid, and 3.0 g of tert-dodecyl mercaptan were charged into a polymerization tank of a gas monomer reaction apparatus (trade name: TAS-2J type, manufactured by Taiatsu Techno Corporation). The reaction vessel was sealed and a contents thereof was subjected to stirring at a stirring rate of 200 rpm. Degassing was conducted with a vacuum pump, followed by repeating nitrogen gas replacement several times. 108.75 g of 1,3-butadiene was injected thereto, and an inner temperature thereof was elevated to 60° C. A solution of 1.875 g of ammonium persulfate dissolved in 50 mL of water was further added thereto, and the mixture was stirred for 5 hours as it stands. The temperature of the mixture was further elevated to 90° C., followed by stirring for 3 hours. After completing the reaction, an inner temperature thereof was lowered to reach to a room temperature, and thereafter the mixture was treated by adding 1 mol/L sodium hydroxide and ammonium hydroxide so that a molar ratio of Na⁺ ion: NH₄⁺ ion became 1: 5.3, and thus, a pH of the mixture was adjusted to 8.4. Thereafter, filtration with a polypropylene filter having a pore size of 1.0 μm was conducted to remove impurities such as dust followed by storage. Accordingly, a SBR latex TP-1 was obtained in an amount of 774.7 g. Upon a measurement of halogen ion by ion chromatography, concentration of chloride ion was revealed to be 3 ppm. As a result of a measurement of a concentration of the chelating agent by high performance liquid chromatography, it was revealed to be 145 ppm.

The aforementioned latex had an average particle diameter of 90 nm, a Tg of 17° C., a solid matter concentration of 44% by weight, an equilibrium moisture content at 25° C. and 60% RH of 0.6% by weight, an ionic conductance of 4.80 mS/cm (measurement of the ionic conductance was performed using a conductivity meter CM-30S (trade name, manufactured by To a Electronics Ltd.) at 25° C.).

Preparation of Isoprene Latex (TP-2) Solution

1,500 g of distilled water was charged into a polymerization tank of a gas monomer reaction apparatus (trade name: TAS-2J type, manufactured by Taiatsu Techno Corporation) and heated at 90° C. for 3 hours so as to form passivation films on a stainless-made surface of the polymerization tank and devices of stainless-made stirring devices in the polymerization tank. 582.28 g of distilled water which has been bubbled with nitrogen gas for 1 hour, 9.49 g of a surfactant (trade name: PIONIN A-43-S, manufactured by TAKEMOTO OIL & FAT CO., LTD.), 19.56 g of 1 mol/L sodium hydroxide, 0.20 g of tetrasodium salt of ethylenediamine tetraacetate, 314.99 g of styrene, 190.87 g of isoprene, 10.43 g of acrylic acid, and 2.09 g of tert-dodecyl mercaptan were charged into the polymerization tank. The reaction vessel was sealed, a contents thereof was subjected to stirring at a stirring rate of 225 rpm, and an internal temperature thereof was elevated to 65° C. A solution of 2.61 g of ammonium persulfate dissolved in 40 mL of water was further added thereto, and the mixture was stirred for 6 hours as it stands. A polymerization conversion ratio that was measured by a solid content thereof at this stage was 90%. A solution of 5.22 g of acrylic acid dissolved in 46.98 g of water, 10 g of water, and a solution of 1.30 g of ammonium persulfate dissolved in 50.7 mL of water was further succeedingly added thereto. The temperature of the mixture was further elevated to 90° C., followed by stirring for 3 hours. After completing the reaction, an inner temperature thereof was lowered to reach to a room temperature, and thereafter the mixture was treated by adding 1 mol/L sodium hydroxide and ammonium hydroxide so that a molar ratio of Na⁺ ion:NH₄⁺ ion became 1:5.3, and thus, a pH of the mixture was adjusted to 8.4. Thereafter, filtration with a polypropylene filter having a pore size of 1.0 μm was conducted to remove impurities such as dust followed by storage. Accordingly, an isoprene latex TP-2 was obtained in an amount of 1,248 g. Upon a measurement of halogen ion by ion chromatography, concentration of chloride ion was revealed to be 3 ppm. As a result of a measurement of a concentration of the chelating agent by high performance liquid chromatography, it was revealed to be 142 ppm.

The aforementioned latex had an average particle diameter of 113 nm, a Tg of 15° C., a solid matter concentration of 41.3% by weight, an equilibrium moisture content at 25° C. and 60% RH of 0.4% by weight, an ionic conductance of 5.23 mS/cm (measurement of the ionic conductance was performed using a conductivity meter CM-30S (trade name, manufactured by To a Electronics Ltd.) at 25° C.).

2. Preparation of Coating Liquids

1) Preparation of Coating liquid for Image Forming Layer

1000 g of the dispersion of the silver salt of fatty acid obtained as described above, water, the organic polyhalogen compound-1 dispersion, the organic polyhalogen compound-2 dispersion, the phthalazine compound-1 solution, the SBR latex (TP-1) solution, the isoprene latex (TP-2) solution, the reducing agent-1 dispersion, the reducing agent-2 dispersion, the hydrogen bonding compound-1 dispersion, the development accelerator-1 dispersion, the development accelerator-2 dispersion, the color-tone-adjusting agent-1 dispersion, the mercapto compound-1 aqueous solution, and the mercapto compound-2 aqueous solution were serially added. A coating liquid for the image forming layer was prepared by adding the silver halide mixture emulsion A thereto followed by thorough mixing just prior to the coating liquid was fed directly to a coating die. (Respective amounts of the above constituents are listed below.)

2) Preparation of Coating liquid for Intermediate Layer A

Preparation of Coating liquid-1 for Intermediate Layer A

1000 g of polyvinyl alcohol (trade name: PVA-205, manufactured by Kuraray Co., Ltd.), 163 g of the pigment-1 dispersion, 33 g of a 18.5% by weight aqueous solution of a blue dye compound-1 (trade name: KAYAFECT TURQUOIS RN LIQUID 150, manufactuerd by Nippon Kayaku Co., Ltd.), 27 mL of a 5% by weight aqueous solution of sodium salt of di(2-ethylhexyl) sulfosuccinate and 4200 mL of a 19% by weight solution of methyl methacrylate/ styrene/ butyl acrylate/ hydroxyethyl methacrylate/ acrylic acid copolymer (weight ratio of the copolymerization: 57/ 8/ 28/ 5/ 2) latex, 27 mL of a 5% by weight aqueous solution of aerosol OT (manufactured by American Cyanamid Co.), and 135 mL of a 20% by weight aqueous solution of ammonium secondary phthalate were mixed, and water was added thereto so that a total amount of thus obtaied mixture became 10000 g. The mixture was adjusted with sodium hydroxide to give a pH of 7.5 so as to provide a coating liquid for the intermediate layer. The coating liquid for the intermediate layer was fed to a coating die to provide 8.9 mL/m².

Preparation of Coating liquids −2 to −10 for Intermediate Layer A

Preparation of coating liquids 2 to 10 for intermediate layer A were conducted in a similar manner as in the preparation of coating liquid 1 for intermediate layer A, except that the modified polyvinyl alcol and additive of the intermediate layer A shown in Table 2 were used in place of the polyvinyl alsohol PVA-205 (described above).

Preparation of Coating Liquid for Intermediate Layer B

100 g of innert gelatin and 10 mg of benzoisothiazoline were dissolved in 840 mL of water, and 180 g of a 19% by weight solution of methyl methacrylate/ styrene/ butyl acrylate/hydroxyethyl methacrylate/ acrylic acid copolymer (weight ratio of the copolymerization: 57/ 8/ 28/ 5/ 2) latex, 46 mL of a 15% by weight methanol solution of phthalic acid, and 5.4 mL of a 5% by weight aqueous solution of sodium salt of di(2-ethylhexyl)sulfosuccinate were added thereto and mixed. The thus prepared coating liquid was mixed with 40 mL of a 4% by weight solution of chrome alum that has been thoroughly mixed by a static mixer just prior to the coating liquid was fed to a coating die so that a coating amount of the coating liquid became 26.1 mL/m².

A viscosity of the coating liquid for the intermediate layer B was measured by using a B-type viscosity meter (No. 1 roter, 60 rpm) at 40° C. and turned out to be 20 mPa·s.

Preparation of Coating liquid for Outermost Layer

100 g of innert gelatin and 10 mg of benzoisothiazoline were dissolved in 800 mL of water, and 40 g of a 10% by weight emulsion of liquid paraffin, 40 g of a 10% by weight emulsion of hexaisostearate dipentaerythrytyl, 180 g of a 19% by weight solution of methyl methacrylate/styrene/butyl acrylate/hydroxyethyl methacrylate/acrylic acid copolymer (weight ratio of the copolymerization: 57/ 8/ 28/ 5/ 2) latex, 40 mL of a 15% by weight methanol solution of phthalic acid, 5.5 mL of a 1% by weight solution of a fluorocarbon surfactant (FF-1), 5.5 mL of a 1% by weight solution of a fluorocarbon surfactant (FF-2), 28 mL of a 5% by weight aqueous solution of sodium salt of di(2-ethylhexyl)sulfosuccinate, 4 g of polymethy methacrylate fine particles (average particle diameter: 0.7 μm, distribution of volume weighted average: 30%), and 21 g of polymethy methacrylate fine particles (average particle diameter: 3.6 μm, distribution of volume weighted average: 60%) were added thereto and mixed so that a coating liquid for the outermost layer was prepared and fed to a coating die in a condition having a concentration of 8.3 mL/m².

A viscosity of the coating liquid for the outermost layer was measured by usin a B-type viscosity meter (No. 1 roter, 60 rpm) at 40° C. and turned out to be 19 mPa·s.

3. Preparation of Photothermographic Material

1) Preparation of Photothermographic materials 101-110

The image-forming layer coating liquid, the intermediate layer A coating liquid, the intermediate layer B coating liquid and the outermost layer coating liquid were simultaneously applied to the surface of the undercoated support which was opposite to the back layer side of the undercoated support in that order by a slide bead coating method to prepare a sample of a photothermographic material. At this time, the temperature of the image-forming layer coating liquid and the intermediate layer A coating liquid was adjusted at 31° C., the temperature of the intermediate layer B coating liquid was adjusted at 36° C., and the temperature of the outermost layer coating liquid was adjusted at 37° C.

The amount (g/m²) of each of the compounds in the image-forming layer is as follows

| | |
|---|---|
| Organic silver salt | 5.02 |
| Pigment (C.I. Pigment Blue 60) | 0.0324 |
| Polyhalogen compound-1 | 0.108 |
| Polyhalogen compound-2 | 0.225 |
| Phthalazine compound-1 | 0.161 |
| SBR latex (TP-1) | 2.83 |
| Isoprene latex (TP-2) | 6.60 |
| Reducing agent-1 | 0.36 |
| Reducing agent-2 | 0.36 |
| Hydrogen-bonding compound-1 | 0.522 |
| Development accelerator-1 | 0.019 |
| Development accelerator-2 | 0.016 |
| Color tone adjusting agent-1 | 0.006 |
| Mercapto compound-1 | 0.0018 |
| Mercapto compound-2 | 0.0108 |
| Silver of silver halide | 0.09 |

Coating and drying conditions are as follows.

Before coating, the electricity of the support was eliminated by blowing an ion blow to the support. The coating speed was 160 m/minute. The distance between the coating die tip and the support was within the range of 0.10 to 0.30 mm. The pressure in the decompression chamber was lower by 196 to 882 Pa than the atmospheric pressure.

In the subsequent chilling zone, the coated support was chilled with an air blow (its dry-bulb temperature was 10 to 20° C.). The support was transported to the next zone, while kept not in contact with any member. In the next helix-type contactless drying zone, the support was dried with a dry air blow (its dry-bulb temperature was 23 to 45° C., and its wet-bulb temperature was 15 to 21° C.).

After the drying, the support was conditioned at 25° C. at humidity in the range of 40 to 60% RH. Then, the support was heated so that the surface temperature was between 70 and 90° C. After the heating, the support was cooled down to reduce the surface temperature to 25° C.

The degree of matting, in terms of the Beck's smoothness, of the image-forming layer side of the thermographic material thus prepared was 550 seconds and that of the back layer side was 130 seconds. The pH of the image-forming layer side was measured and was found to be 6.0.

The chemical structures of the compounds used in the example are shown below.

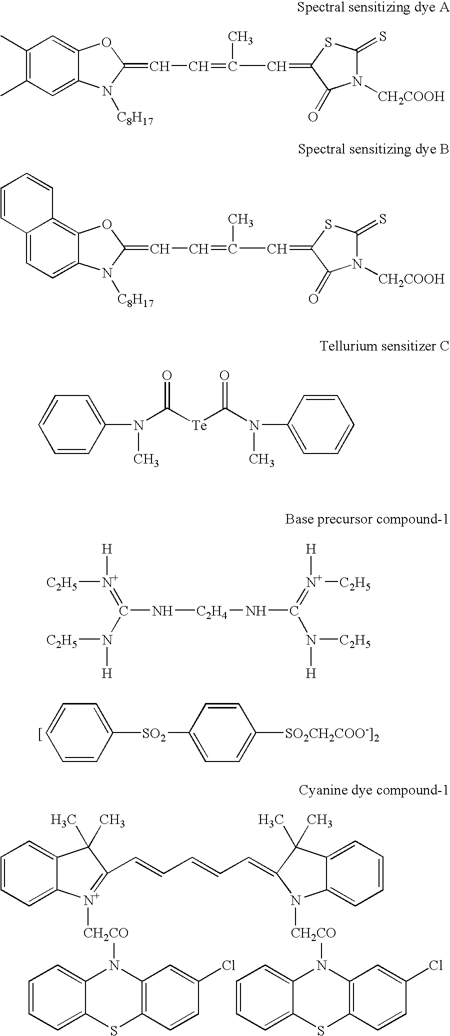

Compound 1 that can be one-electron-oxidized to provide a one-electron oxidant which releases one or more electrons

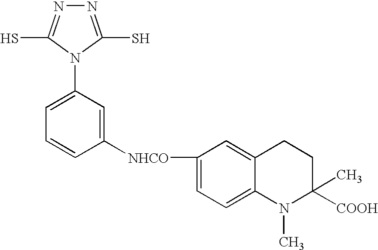

Compound 2 that can be one-electron-oxidized to provide a one-electron oxidant which releases one or more electrons

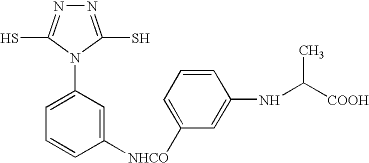

Compound 3 that can be one-electron-oxidized to provide a one-electron oxidant which releases one or more electrons 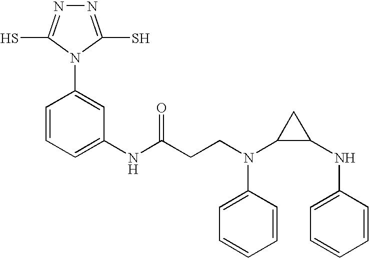 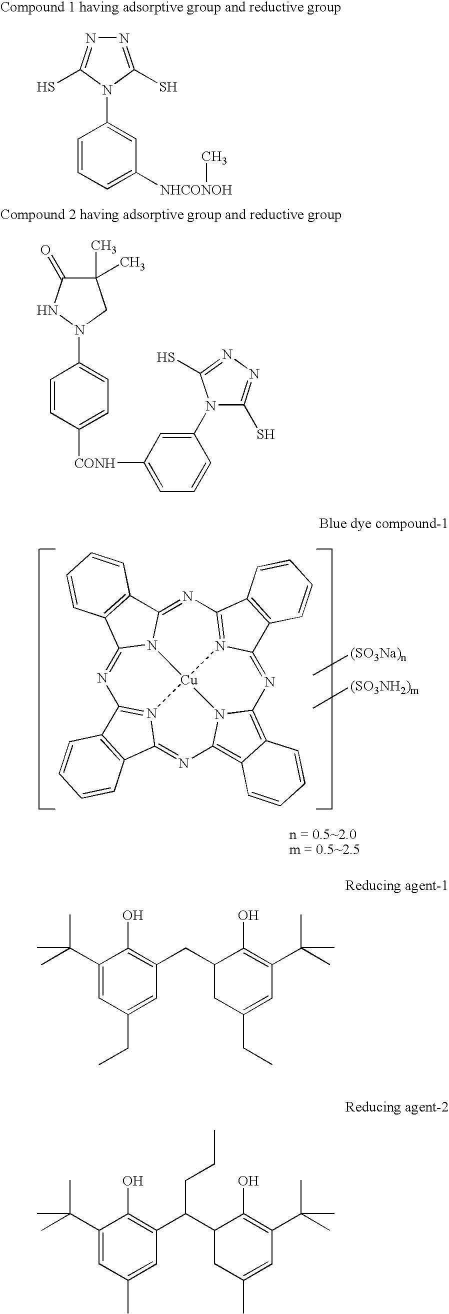 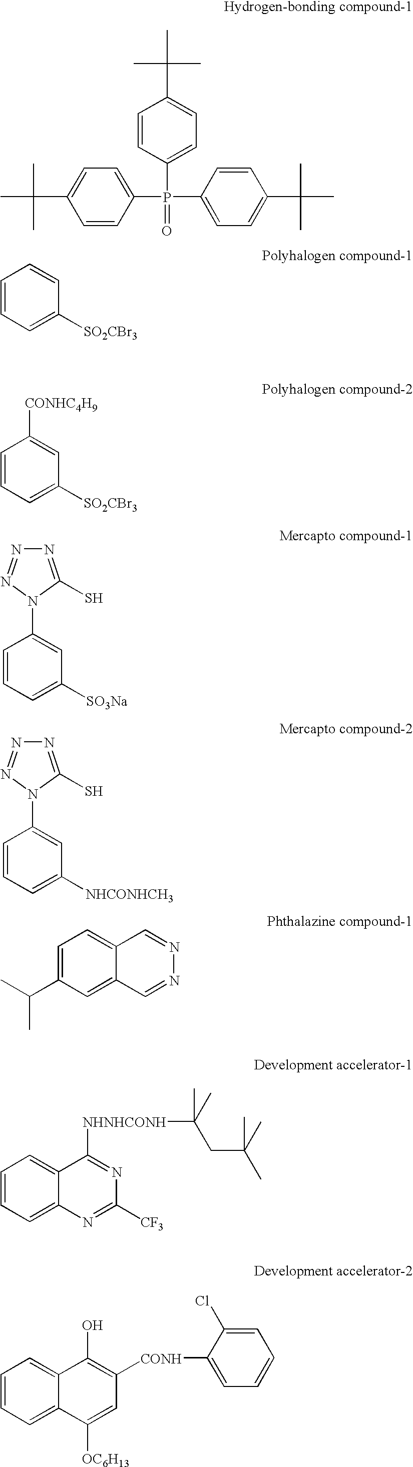 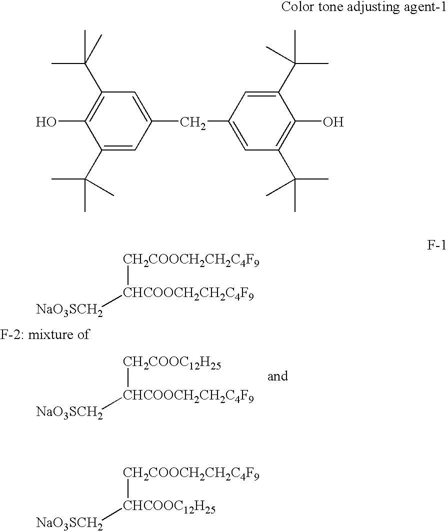
1) Preparation

Each sample thus prepared was cut into pieces of a half-cut size having a length of 43 cm and width of 35 cm, and the pieces were packaged with a packaging material mentioned below at 25° C. and 50% RH, stored at normal temperature for two weeks, and tested according to the following test methods.

Packaging Material

The packaging material used herein was a laminated film including a PET film having a thickness of 10 μm, a PE film having a thickness of 12 μm, an aluminum foil having a thickness of 9 μm, a nylon film having a thickness of 15 μm, and a 2% carbon-containing polyethylene film having a thickness of 50 μm, and having an oxygen permeability of 0.02 ml/atm·m²·25° C. day and a moisture permeability of 0.10 g/atm·m²·25° C. day.

2) Exposure and Thermal development of Photothermographic Material

Each sample was exposed to light and thermally developed with a dry laser imager (trade name: DRYPIX 7000, manufactured by Fuji Film Medical Co., Ltd.) equipped with a semiconductor laser emitting light having a wavelength of 660 nm and having a maximum output of 50 mW (IIIB) and with three panel heaters respectively kept at 107° C., 121° C., and 121° C.) to form an image. The total developing time was 14 seconds. The optical density of the image was measured with a densitometer.

3) Evaluated Properties

Uniformity of Image

Method of Evaluating Orange Peel-Like Non-uniformity

Visual observation for uniformity of image was performed, and one which ranks in a practically acceptable level was evaluated as “A”, while one which ranks in practically unacceptable level was evaluated as “B.”

Photographic Properties

Fogging

The concentration of unexposed portions was used for fogging.

Sensitivity

The sensitivity is the inverse of the light exposure necessary for the value of “fogging+concentration 1.0” and expressed as a value relative to the sensitivity of Sample 101 normalized as 100.

Suitability for Continuous Processing

A hundred pieces of each photothermographic material were continuously developed using a dry laser imager DRYPIX 7000 (trade name, manufactured by Fuji Film Medical Co., Ltd.) such that a density of 1.2 was achieved, and the first piece and the 100th piece were visually observed for a change in color tone. Commercially acceptable levels of the change in color tone were expressed by the mark “A”, while levels that did not reach the commercial level were expressed by the mark “B.”

4) Results of Evaluation

The results are shown in Table 2.

The samples according to the invention showed favorable results with respect to uniformity of image and suitability for continuous processing, while possessing similar photographic properties to those of the photothermographic material using unmodified PVA.

TABLE 2

| | | | | Additive in Intermediate | | Photographic | | | | |
|---|---|---|---|---|---|---|---|---|---|---|
| | Coating | Modified PVA | | Layer A | | Properties | | Orange | Suitability for | |
| Sample | liquid | | Added | | Added | | Sensiti- | Peel-Like | Continuous | |
| (No.) | (No.) | PVA | amount (g/m²) | Additive | amount (g/m²) | Fogging | vity | Non-uniformity | Processing | Remarks |
| 101 | 1 | PVA-205 | 0.9 | none | none | 0.14 | 100 | B | B | Comparative |
| | | | | | | | | | | example |
| 102 | 2 | PVA-1 | 0.9 | none | none | 0.14 | 100 | A | A | Present Invention |
| 103 | 3 | PVA-2 | 0.9 | none | none | 0.14 | 100 | A | A | Present Invention |
| 104 | 4 | PVA-3 | 0.9 | none | none | 0.14 | 100 | A | A | Present Invention |
| 105 | 5 | PVA-4 | 0.9 | PAE | 0.009 | 0.14 | 100 | A | A | Present Invention |
| 106 | 6 | PVA-5 | 0.9 | PAE | 0.009 | 0.14 | 100 | A | A | Present Invention |
| 107 | 7 | PVA-6 | 0.9 | PAE | 0.009 | 0.14 | 100 | A | A | Present Invention |
| 108 | 8 | PVA-7 | 0.9 | none | none | 0.14 | 100 | A | A | Present invention |
| 109 | 9 | PVA-8 | 0.9 | none | none | 0.14 | 100 | A | A | Present Invention |
| 110 | 10 | PVA-9 | 0.9 | none | none | 0.14 | 100 | A | A | Present Invention |

PVA-1: PVA having a saponification degree of 90.0 mol %: polymerization degree of 1,200; and ethylene content of 7.2 mol %
PVA-2: PVA having a saponification degree of 85.0 mol %: polymerization degree of 500; and ethylene content of 7.2 mol %
PVA-3: PVA having a saponification degree of 94.0 mol %: polymerization degree of 1,700; and ethylene content of 7.2 mol %
PVA-4: PVA having a saponification degree of 87.5 mol %: polymerization degree of 1,750; and itaconic acid content of 7.2 mol %
PVA-5: PVA having a saponification degree of 83.0 mol %: polymerization degree of 1,700; and itaconic acid content of 7.2 mol %
PVA-6: PVA having a saponification degree of 71.0 mol %: polymerization degree of 550; and ethylene content of 7.2 mol %
PVA-7: PVA having a saponification degree of 98.5 mol %: polymerization degree of 1,050; and primary amino group content of 7.2 mol %
PVA-8: PVA having a saponification degree of 97.0 mol %: polymerization degree of 1,000; and aniline group content of 7.2 mol %
PVA-9: PVA having a saponification degree of 93.5 mol %: polymerization degree of 1,250; and secondary amino group content of 7.2 mol %
PAE: Polyamide epichlorohydrin (trade name: WS-525, manufactured by Japan PMC Co., Ltd.)

### Example 2

1. Preparation of Coating liquid for Latex-containing Intermediate Layer

A coating liquid for latex-containing intermediate layer was preprared in the similar manner as in Example 1, except that 3,800 g of isoprene latex TP-2 was used in place of the PVA-205 and the methyl methacrylate/ styrene/ butyl acrylate/ hydroxyethyl methacrylate/ acrylic acid copolymer.

2. Preparation of Photothermographic Material

Samples 201 to 210 were prepared in the similar manner as in Example 1, except that the coating liquid for latex-containing intermediate layer was coated between the image forming layer and the intermediate layer A so that the coated amount thereof became 8.9 ml/m². The coating liquid for image forming layer, the coating liquid for latex-containing intermediate layer, the coating liquid for intermediate layer A, the coating liquid for intermediate layer B, and the coating liquid for outermost layer were coated on a substrate in this order by simultaneous multi-layer application using a slide bead coating method.

3. Results of Evaluation

Samples 201 to 210 were evaluated in the similar manner as in Example 1, and results thereof are shown in the following Table 3. It is understood that, as is similar to Example 1, samples of the present invention in Example 2 provides photographic properties equivalent to those of a photothermographic material that uses a non-modified PVA, and favorable image uniformity and suitability to continuous processing.

TABLE 3

| | | | | Additive in Intermediate | | Photographic | | | | |
|---|---|---|---|---|---|---|---|---|---|---|
| | Coating | (Modified) PVA | | Layer A | | Properties | | Orange | Suitability for | |
| Sample | liquid | | Added | | Added | Fog- | Sensi- | Peel-Like | Continuous | |
| (No.) | (No.) | PVA | amount (g/m²) | Additive | amount (g/m²) | ging | tivity | Non-uniformity | Processing | Remarks |
| 201 | 1 | Non-modified | 0.9 | none | none | 0.14 | 100 | B | B | Comparative |
| | | PVA | | | | | | | | example |
| 202 | 2 | PVA-1 | 0.9 | none | none | 0.14 | 100 | A | A | Present Invention |
| 203 | 3 | PVA-2 | 0.9 | none | none | 0.14 | 100 | A | A | Present Invention |
| 204 | 4 | PVA-3 | 0.9 | none | none | 0.14 | 100 | A | A | Present Invention |
| 205 | 5 | PVA-4 | 0.9 | PAE | 0.009 | 0.14 | 100 | A | A | Present Invention |
| 206 | 6 | PVA-5 | 0.9 | PAE | 0.009 | 0.14 | 100 | A | A | Present Invention |
| 207 | 7 | PVA-6 | 0.9 | PAE | 0.009 | 0.14 | 100 | A | A | Present Invention |
| 208 | 8 | PVA-7 | 0.9 | none | none | 0.14 | 100 | A | A | Present Invention |
| 209 | 9 | PVA-8 | 0.9 | none | none | 0.14 | 100 | A | A | Present Invention |
| 210 | 10 | PVA-9 | 0.9 | none | none | 0.14 | 100 | A | A | Present Invention |

### Example 3

Samples of Example 3 were preprared and evaluated in the same manner as in Example 1, except that PVA-1 was used in place of the gelatin used in the outermost layer. Samples of Example 3 provided excellent photographic properties, image uniformity and suitability to continuous processing as are similar to those of Example 1.

### Example 4

Samples of Example 4 were preprared and evaluated in the same manner as in Example 1, except that 1.7 g/m² of PVA-1 was used in place of 1.7 g/m² of the isoprene among 6.6 g/m² thereof used in the outermost layer. Samples of Example 4 provided excellent photographic properties, image uniformity and suitability to continuous processing as are similar to those of Example 1.

What is claimed is:

1. A photothermographic material comprising, on a surface of a substrate, an image forming layer and a non-photosensitive layer, wherein:
the image forming layer comprises a photosensitive silver halide, a non-photosensitive organic silver salt, a reducing agent and a binder; and
at least one of the image forming layer and the non-photosensitive layer comprises at least one selected from:
modified polyvinyl alcohol A, which is a polyvinyl alcohol comprising an α-olefin having 1 to 4 carbon atoms as a copolymerized constituent thereof;
modified polyvinyl alcohol B, which is a polyvinyl alcohol comprising, as a copolymerized constituent thereof, an ethylenic unsaturated carboxylic acid; and
modified polyvinyl alcohol C, which is a polyvinyl alcohol comprising, as a copolymerized constituent thereof, an ethylenic unsaturated monomer having a primary amino group or a secondary amino group.

2. The photothermographic material of claim 1, wherein the image forming layer comprises at least one of the modified polyvinyl alcohols A to C.

3. The photothermographic material of claim 1, wherein the non-photosensitive layer comprises at least one of the modified polyvinyl alcohols A to C.

4. The photothermographic material of claim 3, wherein the non-photosensitive layer is provided over a side of the substrate on which the image forming layer is provided.

5. The photothermographic material of claim 4, wherein a non-photosensitive outermost layer is provided over a side of the substrate on which the image forming layer is provided, and a non-photosensitive intermediate layer comprising at least one of the modified polyvinyl alcohols A to C is provided between the image forming layer and the non-photosensitive outermost layer.

6. The photothermographic material of claim 3, wherein the non-photosensitive layer comprising at least one of the modified polyvinyl alcohols A to C is provided over a side of the substrate which is opposite to another side on which the image forming layer is provided.

7. The photothermographic material of claim 1, wherein the binder comprises a polymer latex.

8. The photothermographic material of claim 3, wherein the non-photosensitive layer comprises a polymer latex.

9. The photothermographic material of claim 7, wherein the non-photosensitive layer comprises a polymer latex.

10. The photothermographic material of claim 7, wherein the polymer latex is a polymer comprising the monomer constituent represented by the following Formula (M) in an amount of 10 to 70% by mass:
CH₂═CR⁰¹—CR⁰²═CH₂ Formula (M)
wherein R⁰¹ and R⁰² respectively represent a hydrogen atom, an alkyl group having 1 to 6 carbon atoms, a halogen atom, or a cyano group.

11. The photothermographic material of claim 8, wherein the polymer latex is a polymer comprising the monomer constituent represented by the following Formula (M) in an amount of 10 to 70% by mass:
CH₂═CR⁰¹—CR⁰²═CH₂ Formula (M)
wherein R⁰¹ and R⁰² respectively represent a hydrogen atom, an alkyl group having 1 to 6 carbon atoms, a halogen atom, or a cyano group.

12. The photothermographic material of claim 9, wherein the polymer latex is a polymer comprising the monomer constituent represented by the following Formula (M) in an amount of 10 to 70% by mass:
CH₂═CR⁰¹—CR⁰²═CH₂ Formula (M)
wherein R⁰¹ and R⁰² respectively represent a hydrogen atom, an alkyl group having 1 to 6 carbon atoms, a halogen atom, or a cyano group.

13. The photothermographic material of claim 10, wherein both of R⁰¹ and R⁰² in Formula (M) represent a hydrogen atom, or one of R⁰¹ and R⁰² represents a hydrogen atom while the other represents a methyl group.

14. The photothermographic material of claim 11, wherein both of R⁰¹ and R⁰² in Formula (M) represent a hydrogen atom, or one of R⁰¹ and R⁰² represents a hydrogen atom while the other represents a methyl group.

15. The photothermographic material of claim 12, wherein both of R⁰¹ and R⁰² in Formula (M) represent a hydrogen atom, or one of R⁰¹ and R⁰² represents a hydrogen atom while the other represents a methyl group.

16. The photothermographic material of claim 5, wherein a non-photosensitive intermediate layer B is provided between the non-photosensitive intermediate layer and the non-photosensitive outermost layer, and at least one of the non-photosensitive outermost layer and the non-photosensitive intermediate layer B comprises a binder which comprises a hydrophilic polymer having 50% by mass or more of a protein which is derived from an animal.

17. The photothermographic material of claim 16, wherein the non-photosensitive intermediate layer B comprises the binder which comprises the hydrophilic polymer, and the non-photosensitive outermost layer comprises a binder having 50% by mass or more of a hydrophobic polymer.

18. The photothermographic material of claim 16, wherein the non-photosensitive outermost layer comprises the binder which comprises the hydrophilic polymer.

19. The photothermographic material of claim 16, wherein the hydrophilic polymer is gelatin.
